(19) United States
(12) Patent Application Publication
(10) Pub. No.: US 2007/0018919 A1
(43) Pub. Date: Jan. 25, 2007

(54) Portable microdisplay system

(76) Inventors: Matthew Zavracky, Plympton, MA (US); Frederick P. Herrmann, Ann Arbor, MI (US); Wen-Foo Chern, Wayland, MA (US); Alan Richard, Wrentham, MA (US); Ronald P. Gale, Sharon, MA (US); Jason Lo, Westboro, MA (US); David Ellertson, Stoughton, MA (US); Kuojinng Tsai, West Warwick, RI (US); John C.C. Fan, Brookline, MA (US); Bor-Yeu Tsaur, Lexington, MA (US); Stephen A. Pombo, Campbell, CA (US); Rodney Bumgardner, Los Gatos, CA (US); Duy-Phach Vu, Taunton, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/475,567

(22) Filed: Jun. 26, 2006

Related U.S. Application Data
(62) Division of application No. 09/460,960, filed on Dec. 14, 1999, now abandoned.
(60) Provisional application No. 60/112,147, filed on Dec. 14, 1998.
(60) Provisional application No. 60/121,899, filed on Feb. 26, 1999.

(51) Int. Cl. G09G 3/36

(52) U.S. Cl. 345/87

(57) ABSTRACT

An active matrix color crystal display has an active matrix circuit, a counterelectrode panel and an interposed layer of liquid crystal. The active matrix display is located in a portable microdisplay system. The image is written to the the display therein causing the liquid crystal to move to a specific image position. A light source is flashed to illuminate the display. The pixel electrodes are set to a specific value to cause the liquid crystal to move towards a desired position. The process of writing, flashing, and setting the electrode intensity value to reorient the liquid crystal to produce an image is repeated. Portable system can include a digital camera, cellular telephone, camcorder, heads up display, instant print camera, pager,

### RELATED APPLICATIONS

This application is a divisional application of U.S. application Ser. No. 09/460,960, filed on Dec. 14, 1999, which claims the benefit of U.S. application Ser. No. 60/112,147 filed on Dec. 14, 1998 and U.S. application Ser. No.60/121,899 filed on Feb. 26, 1999. The entire contents of all of these applications are incorporated herein by reference.

### BACKGROUND OF THE INVENTION

Flat-panel displays are being developed which utilize liquid crystals or electroluminescent materials to produce high quality images. These displays are expected to supplant cathode ray tube (CRT) technology and provide a more highly defined television picture or computer monitor image. The most promising route to large scale high quality liquid crystal displays (LCDs), for example, is the active-matrix approach in which thin-film transistors (TFTs) are co-located with LCD pixels. The primary advantage of the active matrix approach using TFTs is the elimination of cross-talk between pixels, and the excellent gray scale that can be attained with TFT-compatible LCDs.

Color liquid crystal flat panel displays can be made in several different ways including with color filters or sequentially flashing lights. Both style displays are found in transmissive or reflective models.

Transmissive color filter liquid crystal flat panel displays generally include five different layers: a white light source, a first polarizing filter that is mounted on one side of a circuit panel on which the TFTs are arrayed to form pixels, a filter plate containing at least three primary colors arranged into pixels, and finally a second polarizing filter. A volume between the circuit panel and the filter plate is filled with a liquid crystal material. This material will allow transmission of light in the material when an electric field is applied across the material between the circuit panel and a ground affixed to the filter plate. Thus, when a particular pixel of the display is turned on by the TFTs, the liquid crystal material rotates polarized light being transmitted through the material so that the light will pass through the second polarizing filter.

In sequential color displays, the display panel is triple scanned, once for each primary color with the associated color light directed at the display panel. For example, to produce color frames at 20 Hz, the active matrix must be driven at a frequency of 60 Hz. In order to reduce flicker, it is desirable to drive the active matrix at 180 Hz to produce a 60 Hz color image. At over 60 Hz, visible flicker is reduced.

Owing to the limitations of amorphous silicon, other alternative materials include polycrystalline silicon, or laser recrystallized silicon. These materials are limited as they use silicon that is already on glass, which generally restricts further circuit processing to low temperatures.

Integrated circuits for displays, such as the above-referred color sequential display, are becoming more and more complex. For example, the color sequential display is designed for displaying High Definition Television (HDTV) formats requiring a 1280-by-1024 pixel array with a pixel pitch, or the distance between lines connecting adjacent columns or rows of pixel electrodes, being in the range of 15-55 microns, and fabricated on a single five-inch wafer.

### SUMMARY OF THE INVENTION

This invention relates to a microdisplay and more specifically to a small area high resolution liquid crystal display and methods for making such displays. The display has an array of at least 72,000 pixel electrodes and an active area of less than 200 mm², for example.

In a preferred method of displaying an image, an image is written to a liquid crystal display having a plurality of pixel electrodes therein causing the liquid crystal to move to a specific image position. A light source is flashed to illuminate the display. The pixel electrodes are set to a specific electric field intensity to cause the liquid crystal to move towards a desired orientation or position before the next image is written. The process of writing, flashing and setting produces a desired image.

In a preferred method, the image is a color image and the writing of the image is associated with two or more color that are flashed after the writing steps are repeated for each of the plurality of colors. The voltage of the counterelectrode is switched after each flashing of the light source and prior to the next writing of the image. The liquid crystal display is an active matrix display having at least 75,000 pixel electrodes and having an active area of less than 160 mm².

In preferred embodiments, an active matrix color sequential liquid crystal display has an active matrix circuit, a counterelectrode plane or layer, and an interposed layer of liquid crystal. The active matrix circuit has an array of transistor circuits formed in a first plane. Each transistor circuit is connected to a pixel electrode in an array of pixel electrodes having an area of 200 mm² or less and preferably under 100 mm². The counterelectrode panel extends in a second plane that is parallel to the first plane and receives an applied voltage. The liquid crystal layer is interposed in a cavity between the two planes. The cavity has a depth along an axis perpendicular to the first and second planes of less than 3 microns.

In a preferred embodiment, an oxide layer extends between the pixel electrode array and a layer of liquid crystal material. The oxide has a first thickness in a peripheral region around the array of pixel electrodes and a thinner second thickness in a pixel electrode region extending over the array of pixel electrodes. The thick peripheral region (about 0.5 microns in a preferred embodiment) serves to better isolate the driver electrodes integrated into the display circuit. The thinner oxide region (about 0.3 microns) serves to reduce the voltage drop across the oxide during display operations. This serves to increase the applied voltage on the liquid crystal without the need to draw more power from the power source such as a battery.

One preferred method of controlling the liquid crystal is to invert the input video signal to eliminate DC voltage buildup on the liquid crystal material. While column inversion, where alternating columns receive video and inverted video, is a common mode, it is recognized that row, pixel or frame inversion can be preferred in some nodes. Another preferred method of controlling the liquid crystal in the display is to switch the voltage applied to the counterelectrode panel at the beginning of the subframe. In addition to eliminating non-symmetrical voltages, the technique of switching the voltage to the counterelectrode panel after every subframe improves contrast.

In addition to the switching of the voltage to the counterelectrode, there are several other techniques that can be used in conjunction with or separately from the switching of the voltage to improve the quality of the image on the display. It has been recognized that the temperature of the microdisplay and in particular the liquid crystal effects the response of the liquid crystal and the brightness and the color uniformity of the image on the display.

An alternative method and one which can be used independently or in conjunction with the switching of the voltage of the counterelectrode is to initialize the pixels V_{PIXEL} to V_{COM} after flashing the backlight. With the pixel electrodes set to V_{COM}, the liquid crystal begins to relax to the clear state, if the liquid crystal associated with the pixel was in some other state. The liquid crystal associated with each pixel is relaxing, rotating to the clear state, until that pixel is written to and receives the signal or voltage associated with that image. In that the pixels are written in sequence, there is a greater time from writing until flashing the light source for the first pixels then the last pixels. The first pixels will have the majority of the writing period to get to their desired position after receiving the video signal and the initializing of the pixel to V_{COM} will have minimum effect. However, the pixels which receive their signal last and which have been initalized to clear and have the assocaited liquid crystal rotating towards clear if not already there, will be clear or near clear prior to receiving their signal. The liquid crystal in this preferred embodiment is oriented such that it takes less time to drive black than relax white. Therefore, with the last pixels being at or near clear, the response time is quicker driving to black than if the pixels were black and relaxing to clear. The initialization of the display so that the liquid crystal is rotating towards the state which takes longest to reach, the clear state in a preferred embodiment, the individual pixel elements upon being set are closer to the settle position upon the flash of the light source.

The characteristics of the liquid crystal material are effected by the temperature of the liquid crystal. For example, the twist time of twisted-nematic liquid crystal material is shorter when the liquid crystal material is warm. By knowing the temperature of the liquid crystal, the duration and timing of the flash of the backlight can be set to achieve the desired brightness and minimizing power consumption.

The liquid crystal can be heated by several alternative embodiments. In one preferred embodiment, the display is placed in a heat mode wherein multiple rows are turned on and a voltage drop occurs across the row lines, creating heat.

The measuring of the temperature of the liquid crystal requires additional analog circuitry which adds complexity to the circuit of the display. It is recognized that it is the operational characteristics of the liquid crystal, not the actual temperature, that is ultimately desired. In one preferred embodiment, an electrical measurement of the liquid crystal capacitance is performed instead of the measurement of temperature in order to determine when heating is required. When the heater is on and the duration that the heater is on does not need to be based on the temperature and can be actuated in response to a liquid crystal sensor that responds to optical, electrical or other property of the liquid crystal.

In one preferred embodiment, a sensor is incorporated to determine if the liquid crystal is approaching the characteristic clearing temperature of the liquid crystal. The clearing temperature sensor is located just off the active display area. The capacitance of a white (clear) pixel and a black pixel converge as the liquid crystal approaches its characteristic clearing temperature.

One of the traits of liquid crystal that is desired is the long time constant which allows the image to be maintained without having to refresh in certain instances. While a long time constant is generally a benefit, it can be a detriment in instances where the display is powered down and powered up a short time later. Upon powering up the system, a portion of the previous image may remain.

In a preferred embodiment, an analog comparator samples the voltage of the main power in real time. When the voltage drops below the level to run the circuit plus some margin, such as 90 percent, the display is powered down. In powering down the display, a reset signal (PDR*) is asserted low. On receipt of the PDR* signal, the display circuitry will place VDD on all the column lines, and activate all the row lines. The other end of the storage capacitor for each pixel is tied to the previous row line. This in effect discharges the storage capacitor to zero (0) volts. The normal timing continues for two or more cycles, therein sequentially activating all the even and odd rows. This drives zero (0) volts on the column lines into every pixel.

Because the storage capacitor is several times larger than the pixel capacitor, the voltage on the storage capacitor will then discharge the pixel capacitor to zero (0) volts. At this point the display can be de-energized without any residual charge left on either the storage or pixel capacitor.

The increasing capability of microdisplays at the same time as the decrease in size of the microdisplay has allowed for devices that were not possible prior to the invention of microdisplays or allow devices with increased capability. These devices included digital cameras, digital printers and improved camcorder viewfinders.

In a preferred embodiment, the microdisplay is used within a digital camera. The microdisplay is used to both display the image to be taken and to display images stored within memory within the digital camera.

### BRIEF DESCRIPTION OF THE DRAWINGS

The above and other objects and features of the invention will be better understood and appreciated by those skilled in the art in view of the description of the preferred embodiments given below in conjunction with the accompanying drawings, in which:

FIG. 1 is a perspective view of a single wafer having a plurality of display devices formed thereon in accordance with the invention;

FIG. 2 is a schematic illustration of a die for an integrated active matrix panel display which includes optional control signal circuitry therein;

FIG. 3 illustrates a timing diagram for the display control circuit illustrated in FIG. 2;

FIG. 4 is a schematic of the process of manufacturing and assembling the microdisplay;

FIGS. 5A-5D are a schematic of the process of making the circuit on the TFT layer;

FIG. 6 is a cross-sectional view of an ITO (Indium Tin Oxide) layer;

FIG. 7A is a cross-sectional view of a TFT layer with a pooled buried oxide layer;

FIG. 7B is a schematic of a step in forming an alternative TFT layer;

FIG. 7C is a cross-sectional view of an alternative TFT layer;

FIG. 8 is an exploded view of the ITO layer and the TFT layer prior to assembly;

FIG. 9 is an enlarged sectional view of the display in its housing;

FIG. 10 is a schematic illustration of a die for an alternative integrated active matrix panel display;

FIG. 11 is a schematic illustration of a die for an alternative (LVV) integrated active matrix panel display;

FIG. 12A is an exploded view of the backlight relative to the display;

FIG. 12B is a rear perspective view of the backlight;

FIG. 12C is a front perspective view of the backlight with a diffuser;

FIG. 13A is a perspective view of the assembled display module;

FIG. 13B is an exploded view of the assembled display module;

FIG. 14A is a side view of a lens suitable for magnifying a microdisplay in accordance with the invention;

FIG. 14B is a cross sectional view of the assembled display module;

FIG. 14C is a side view of a multi-element lens providing an increased field of view;

FIG. 15 illustrates a single lens positioned adjacent to the kinoform;

FIG. 16A is a cross sectional view of a backlight system with a detector;

FIG. 16B is a schematic of a control circuit for the LED;

FIG. 17 is a graphical representation of the time to turn the liquid crystal clear to black and black to clear;

FIG. 18A is a graphical representation of the voltage and the transitioning of the liquid crystal for a pixel that is desired to be red;

FIG. 18B is a graphical representation of the voltage and the transitioning of the liquid crystal for the first pixel and the last pixel for an intermediate color such as yellow;

FIG. 19A illustrates an alternative preferred embodiment of the display control circuit in accordance with the invention;

FIG. 19B illustrates a timing diagram for the display control circuit illustrated in FIG. 19A;

FIG. 20A illustrates a pixel element of the display control circuit shown in FIG. 19A;

FIG. 20B illustrates a portion of the display control circuit shown in FIG. 19A;

FIG. 21 is a graphical representation of a black pixel being reset to white and white pixel being reset to black by the switching the voltage to the counterelectrode;

FIG. 22 is a graphical representation of the voltage and the transitioning of the liquid crystal for the first pixel and the last pixel for an intermediate color such as yellow for the display control circuit illustrated in FIG. 19A;

FIG. 23A illustrates a timing diagram for a color sequential display with initialization;

FIG. 23B illustrates a circuit to initialize all columns to the same voltage;

FIG. 23C illustrates a timing diagram for a color sequential display with LVV switching the voltage of the counterelectrode and initialization of the pixels to clear;

FIG. 24 is a graphical representation of voltage of the pixel electrode as power is turned off and back on in the prior art;

FIG. 25 illustrates a preferred embodiment of display control circuits in accordance with the invention;

FIG. 26 is a graphical representation of the control signal as power is turned off in accordance with the invention;

FIG. 27A illustrates an alternative preferred embodiment of the display with a heat gate;

FIG. 27B illustrates a portion of the display shown in FIG. 27A;

FIG. 27C illustrates an alternative embodiment of a portion of the display shown in FIG. 27A;

FIG. 27D illustrates an alternative heat driving embodiment;

FIG. 27E illustrates an alternative heating embodiment for a display with two select scanners;

FIG. 27F illustrates a liquid crystal response time sensor array located just outside the active display;

FIG. 27G is an enlarged view of the liquid crystal response time sensor array;

FIG. 28A is a schematic of a display control circuit which receives an analog signal;

FIGS. 28B and 28C are schematics of components of the display control circuit of FIG. 28A;

FIG. 29A illustrates a prior art signal path in a display;

FIG. 29B is a timing diagram showing skew between EXCLK and TCG;

FIG. 29C illustrates a delay-locked loop circuit;

FIG. 29D illustrates a phase-locked circuit;

FIG. 30 is an illustration of a digital mechanism to detect the signal located in the program logic chip;

FIG. 31 is a timing diagram of the inputs and outputs of the circuit of FIG. 30;

FIG. 32 illustrates a timing control circuit similar to FIG. 28A with a PLL limiting;

FIG. 33 illustrates an alternative preferred embodiment of the display control circuit;

FIG. 34A is a timing diagram with a 3:1 ratio of subframes to fields;

FIG. 34B is a timing diagram with a 4:1 ratio of subframes to fields;

FIG. 34C is a timing diagram with a 10:3 ratio of subframes to fields;

FIG. 35A is a schematic illustration of an integrated circuit of the microdisplay which receives a digital video signal;

FIG. 35B is a schematic illustration of a linear feedback shift register (LFSR) state machine for the digital signal according to the invention;

FIG. 36 is a schematic of a data link;

FIG. 37A illustrates the data link between a video card and a display driver board;

FIG. 37B is a schematic of a digital driver;

FIG. 38A illustrates a liquid crystal response curve;

FIG. 38B is a schematic of a display control circuit with a digital table;

FIG. 39A illustrates a timing diagram for the display for a monochrome display;

FIGS. 39B1 and 39B2 illustrate an alternative preferred embodiment of the display control circuit in accordance with the invention;

FIG. 39C illustrates horizontal scaling by interpolation;

FIG. 39D illustrates vertical scaling by interpolation;

FIG. 39E illustrates a pixel pairing scheme;

FIG. 40A is a front view of a digital camera;

FIG. 40B is a rear view of the digital camera of FIG. 40A;

FIG. 40C is a left side view of the digital camera of FIG. 40A;

FIG. 40D is a right side view of the digital camera of FIG. 40A;

FIG. 41 is an exploded view of the digital camera of FIGS. 40A-40D;

FIG. 42 illustrates a display control circuit for a camera;

FIG. 43 is a perspective view of a camcorder with a portion broken out;

FIG. 44 illustrates a display control circuit for a camcorder;

FIG. 45 is a schematic for a head mounted display system for use in a vehicle;

FIG. 46 is a schematic of a control system for a digital printer;

FIG. 47 illustrates a sectional view of the digital printer;

FIG. 48 is a schematic of circuitry of an instant digital camera;

FIG. 49A is a front perspective view of a cellular telephone with a microdisplay;

FIG. 49B is a front view of the cellular telephone with a microdisplay;

FIG. 49C is a rear view of the cellular telephone with a microdisplay;

FIG. 50 is a sectional view of a reflective display; and

FIG. 51 is a schematic of time a silicon on quartz process of manufacturing and the microdisplay.

### DETAILED DESCRIPTION OF THE INVENTION

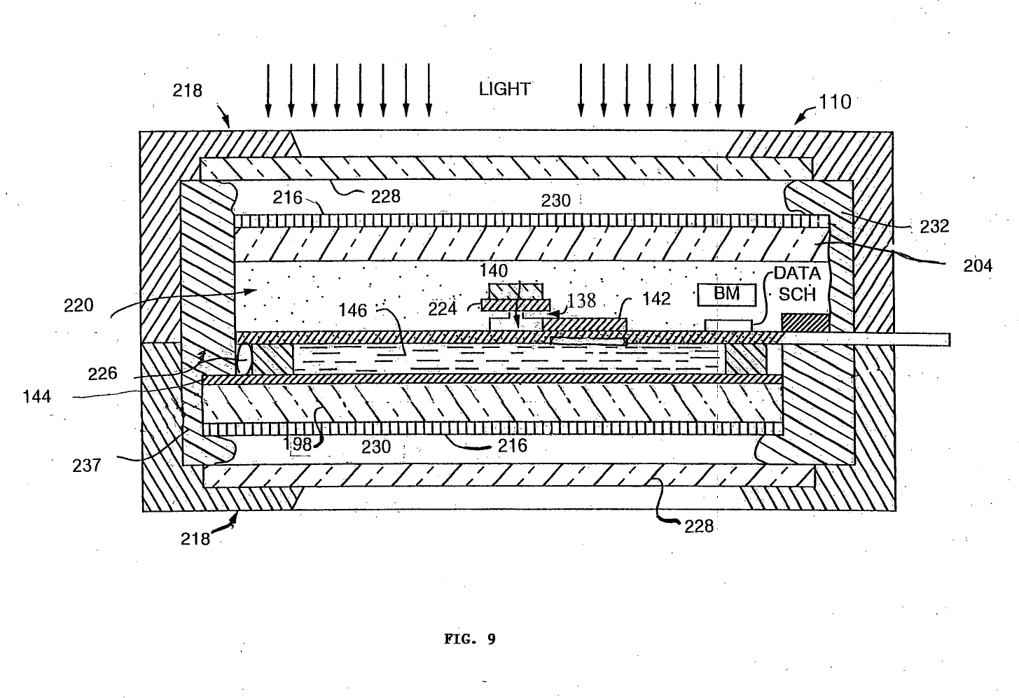

Referring to the drawings, where like numerals indicate like elements, there is illustrated a display in accordance with the present invention, generally referred to as 110 in FIG. 9, for example.

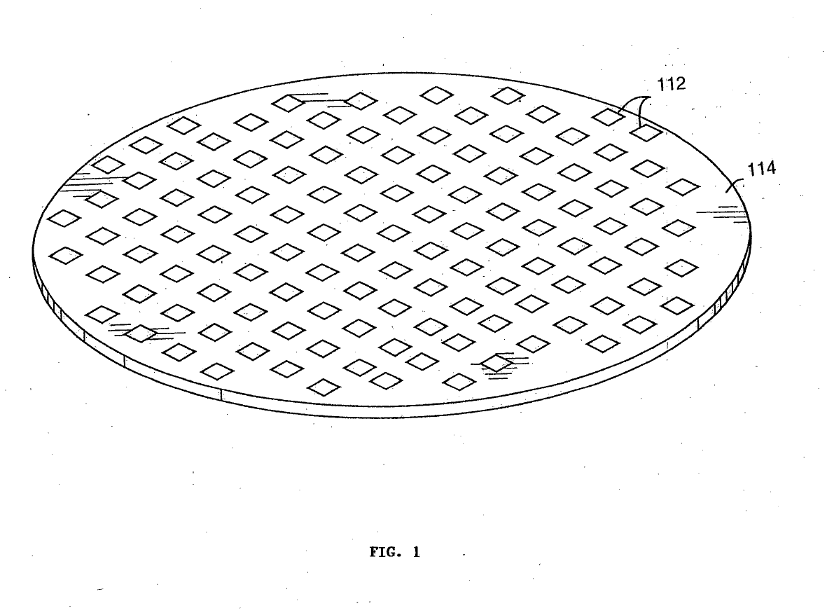

A preferred embodiment of the invention utilizes a process of making a plurality of flat panel displays 110 in which a large number of active matrix arrays 112 are fabricated on a single wafer 114 as illustrated in connection with FIG. 1.

The number of displays fabricated on a single wafer depends upon the size of the wafer and the size of each display. In a preferred embodiment, the wafer has a five inch diameter or larger. The size of each display depends on the resolution and pixel electrode size. In a display having a resolution of approximately 76,800 pixels (e.g. a 320×240 array), commonly referred to as QVGA, with a 0.24 inch diagonal display and the pixel electrodes having a width of 15 microns, the active display area is 4.8 mm×3.6 mm. The display die has dimension of 8.6 mm×60 mm. A total display dimension, size of display holder 290 of FIG. 13B, of 15.42 mm×9.86 mm Greater than 150 separate displays of this size can be fabricated on a single five inch wafer or greater than 200 display, on a single six inch wafer.

Another preferred embodiment of the display has a resolution of approximately 307,200 pixels (e.g. a 640×480 array), commonly referred to as VGA, with a 0.38 inch diagonal display. The VGA display has pixel electrodes with a width of 12 microns. The active display area is 7.68 mm×5.76 mm. The display die has dimension of 11.8 mm×8.2 mm. The total display dimension of 16.97 mm×11.58 mm 100 separate displays of this size can be fabricated on a single five inch wafer.

By fabricating a large number of small high resolution displays on a single wafer, the manufacturing yield can be substantially increased and the cost per display can be substantially reduced.

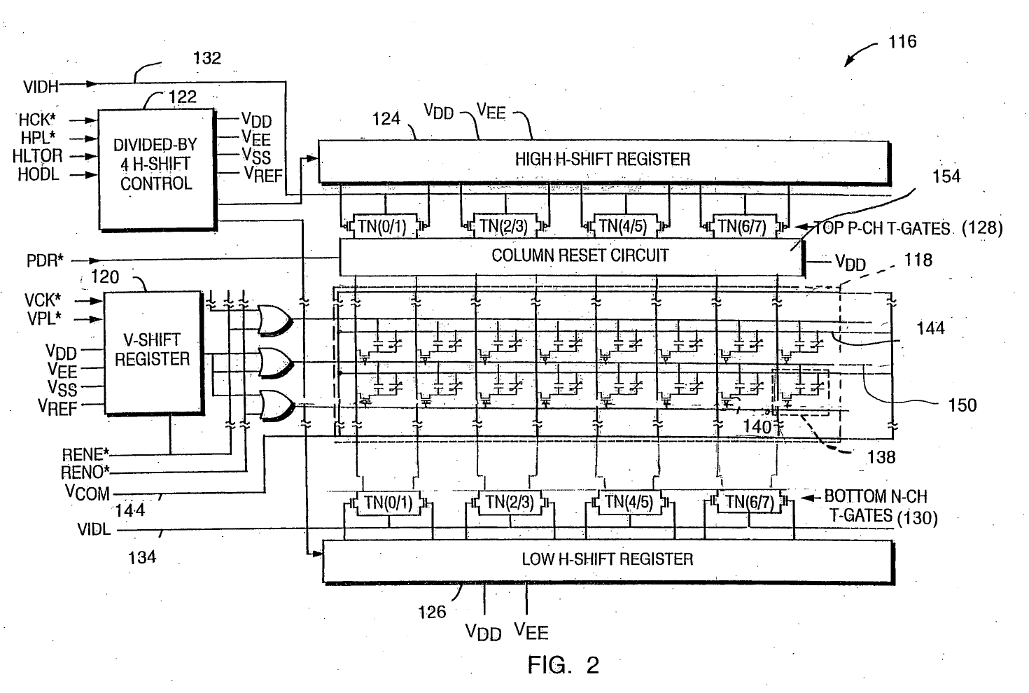

An integrated circuit active matrix display die 116 is shown schematically in FIG. 2. The integrated circuit display die 116 has been diced from a single wafer 114 along with a selected number of replicated circuits. Incorporated into the integrated circuit display die 116 are a display matrix circuit 118, a vertical shift register 120, a horizontal shift control 122, a pair of horizontal shift registers 124 and 126, and a plurality of transmission gates 128 and 130.

A video signal high line 132 and a video signal low line 134 carry analog video signals from a digital to analog amplifier to the transmission gates 128 and 130 located above and below the display matrix circuit 118. In a preferred embodiment, the transmission gates above the display matrix circuit are p-channel transmission gates 128 and are connected to the video high (VIDH) line 134. The transmission gates 130, which are located below the display matrix circuit 118 in a preferred embodiment are n-channel transmission gates 130 and are connected to the video low (VIDL) line 134.

The transmission gates 128 and 130 are controlled by the horizontal shift registers 124 and 126. The p-channel transmission gate 128 is controlled by the high horizontal shift register 124 and the n-channel transmission gate 130 by the low horizontal shift register 126, as in the embodiment shown in FIG. 2. The horizontal shift registers 124 and 126 are controlled by the horizontal shift control 122. The horizontal shift registers 124 and 126 select the column to which that bit or segment of the video signal is sent as further explained below.

The display matrix circuit 118 has a plurality of pixel elements 138. For example, in a QVGA display there would be 76,800 (320×240) active pixel elements. There may be additional pixel elements which would not be considered active, as explained below. Each pixel element 138 has a transistor 140 and a pixel electrode 142. The pixel electrode 142 works in conjunction with a counterelectrode 144 and an interposed layer of liquid crystal 146, as best seen in FIG. 9, to form a pixel capacitor 148 for creating an image.

In addition to selecting the column which receives the signal by use of the horizontal shift registers 124 and 126 as described above, the row needs to be selected. The vertical shift register 120 selects the row. The row line 150 from the vertical shift register 120 is connected to the gate of each of the transistors 140 to turns on the pixels of the row. With the pixels turned on for one row, and a column 152 selected by one of the horizontal shift registers 124 and 126, a single pixel is selected and the video signal drives the liquid crystal or allows the liquid crystal of the pixel element to relax.

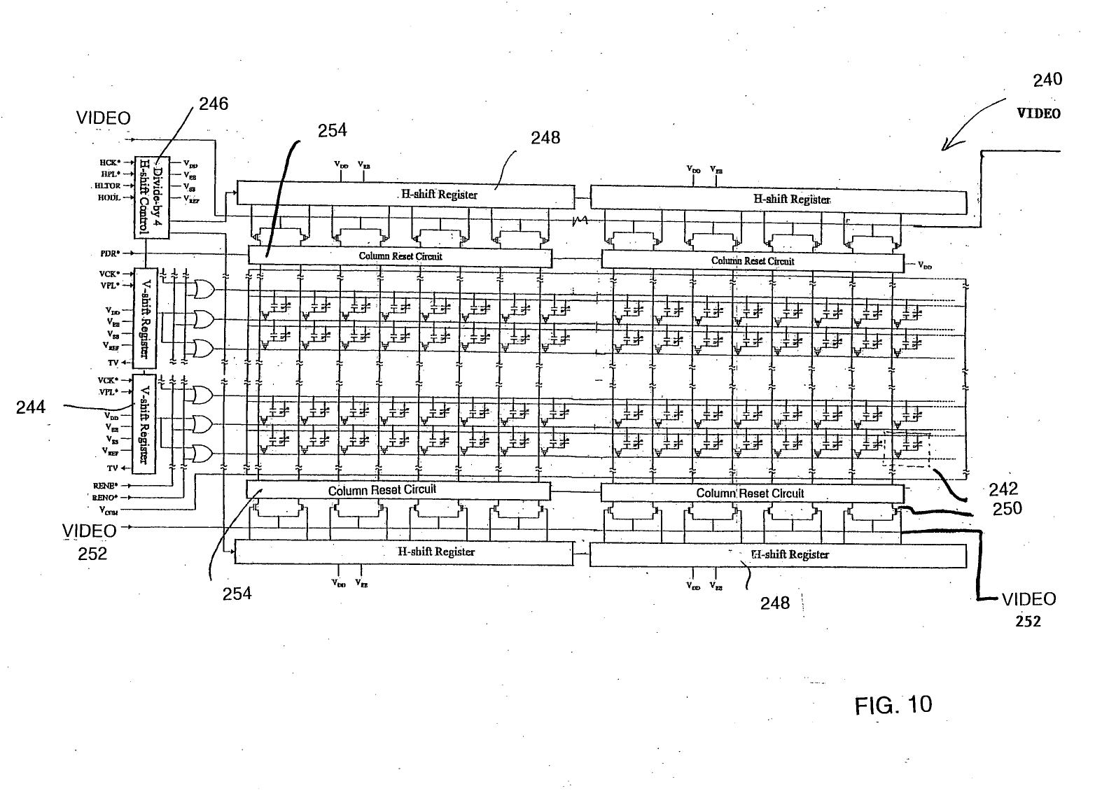

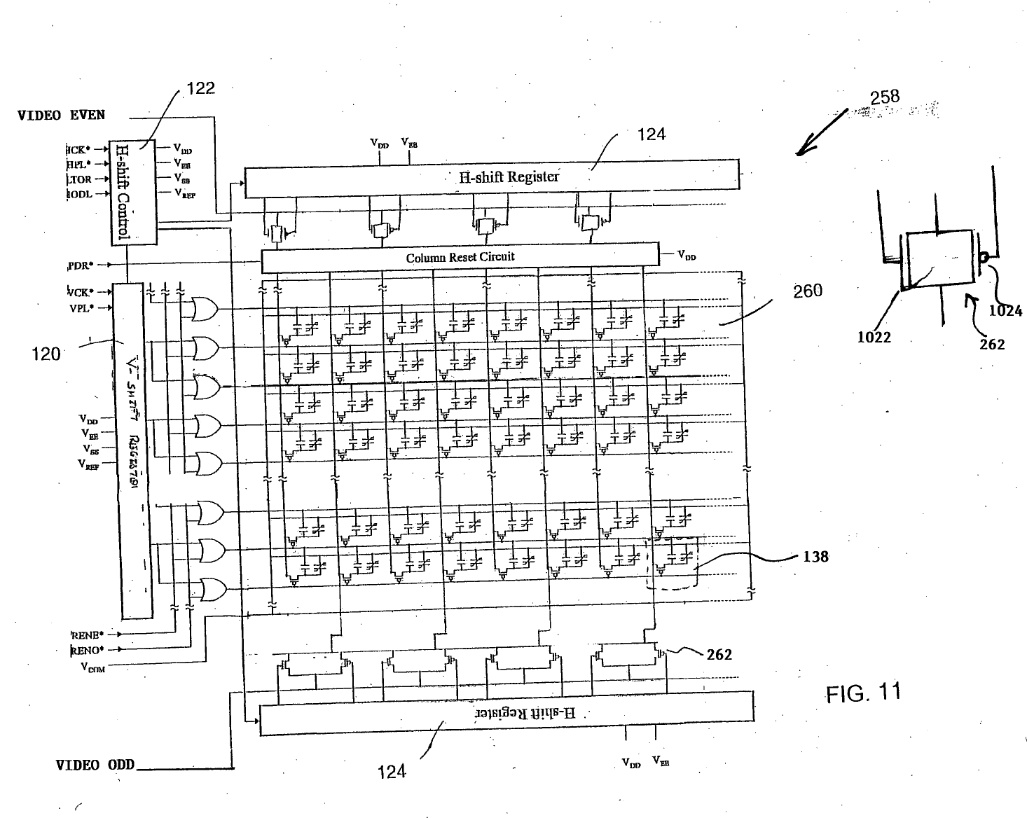

The microdisplay 110 has the image scanned in row by row in a progressive fashion. In a preferred embodiment of the QVGA, the image is scanned or the pixel electrode voltage is set pixel element by pixel element. Two pixel elements can be set at one time, with an odd or even receiving a VIDH signal 132 using high horizontal shift register 124 and the other row (i.e. the even or odd) receiving a VIDL signal 134 using low horizontal shift register 126, as explained below with respect to FIG. 11. It is recognized that other configurations such as shown in FIG. 10, can be used where the display is broken into segments and are supplied simultaneously. It is also recognized that multiple pixel electrodes can be scanned in the same clock cycle, if the display uses multiple VIDH and VIDL inputs.

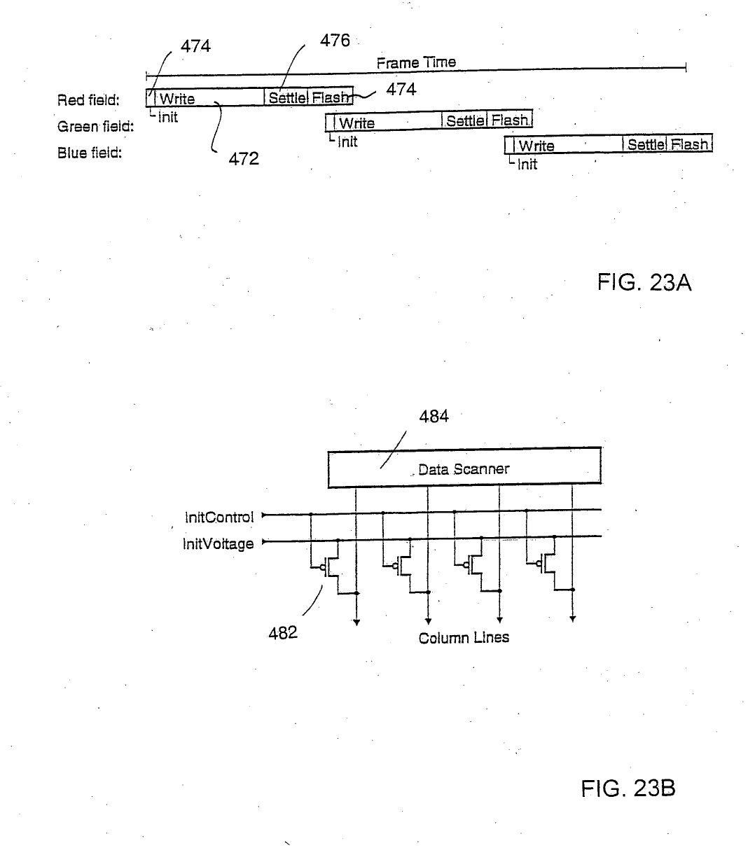

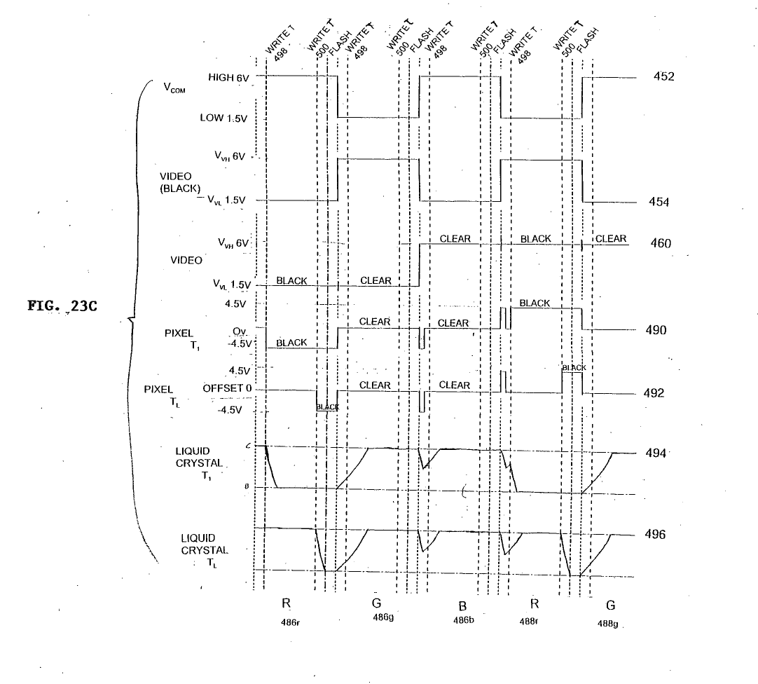

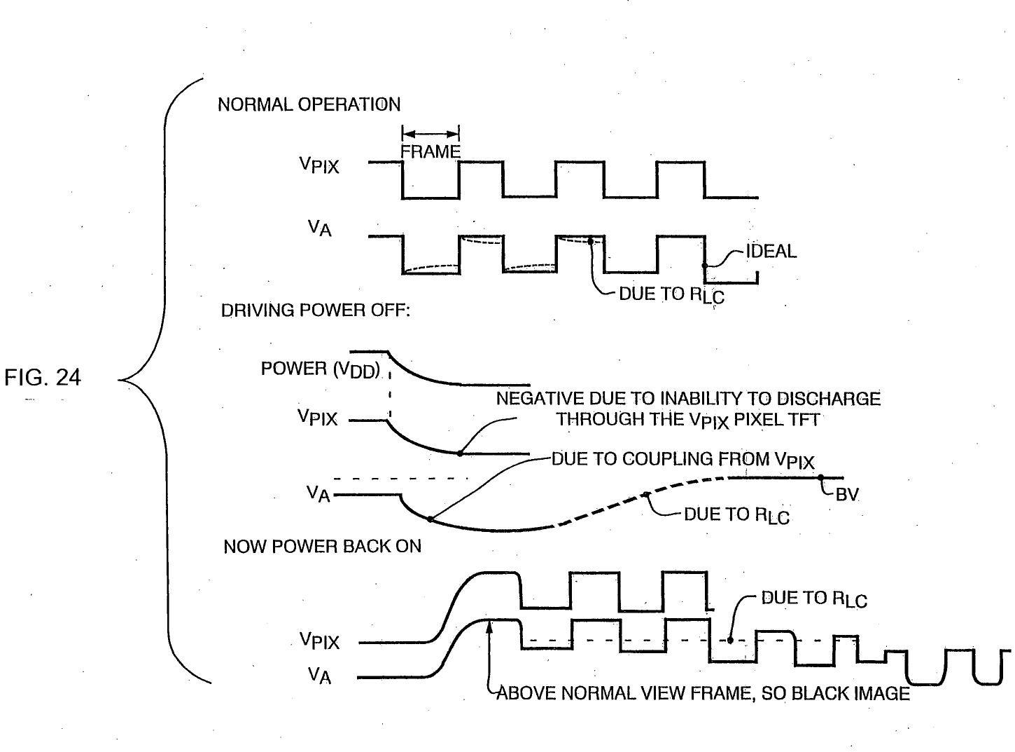

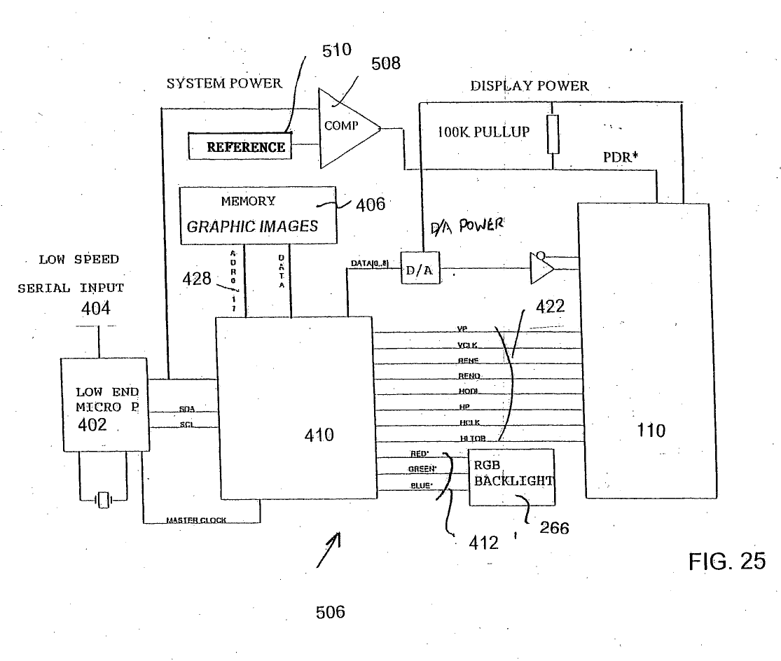

The display matrix circuit 118 has a column reset circuit 154. The column reset circuit 154 is used for both power down reset, as explained below with respect to the FIGS. 24 and 25 and initialization as explained below with respect to FIGS. 23A and 23B. In initialization, the column reset circuit 154 sets the voltage to each pixel electrode 142 to the voltage which results in the liquid crystal relaxing to the clear state. The column reset circuit 154 is used before each subframe or frame as explained below.

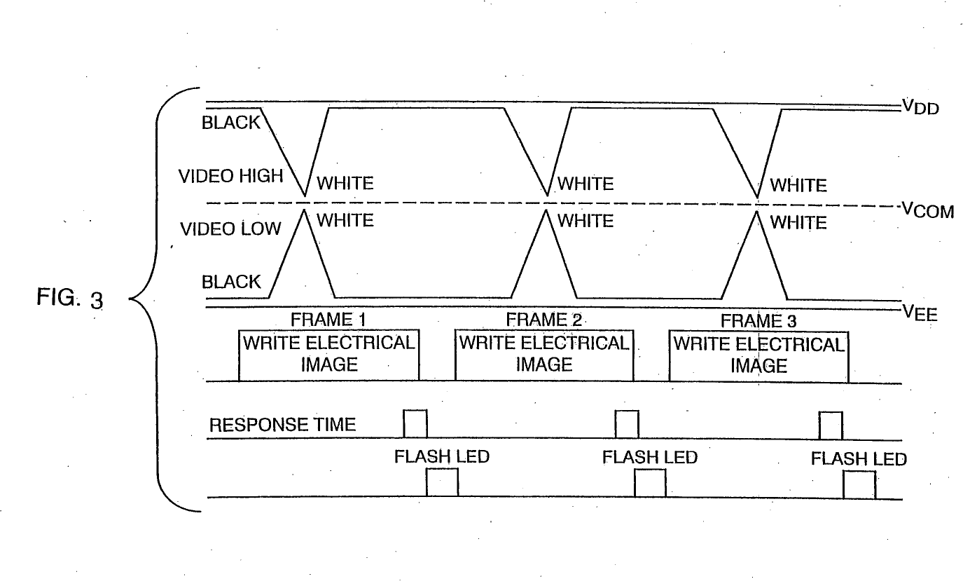

FIG. 3 illustrates a timing diagram for a microdisplay using column inversion. The video signal is sent to the IC display die 116 both as actual video and inverted video. The p-channel transmission gates 128, as seen in FIG. 2, receive actual video and the pixels supplied by these gates are driven between the common voltage (V_{COM}), the voltage applied to the counterelectrode, and the supply voltage source (V_{DD}). The n-channel transmission gates 130 receive the inverted video and the pixels supplied by these gates are driven between V_{COM} and the supply voltage sink (V_{EE}). In one subframe, one column receives video and the adjacent columns receive inverted video. In the next subframe, the columns receiving the video and inverted video are switched. After the entire frame is scanned into the display and there is a delay to allow the liquid crystal to twist, the backlight is flashed to present the image. The delay to allow the liquid crystal to twist is further explained below. In a preferred embodiment, V_{DD} is approximately 11 volts, V_{EE} is approximately 2 volts and V_{COM} is approximately 7.0 volts. There is a slight voltage difference between the voltage signal center voltaged (VVC) and V_{COM} to accommodate an offset voltage in the liquid crystal. The technique of alternating the video on each column is called column inversion and helps prevent a DC voltage from building up on the liquid crystal material and additionally prevents cross talk. In addition to column inversion, other similar inversion techniques are row inversion, frame inversion and pixel inversion.

Other timing diagrams are discussed below which feed the video and flash the backlight in a different manner to present the image.

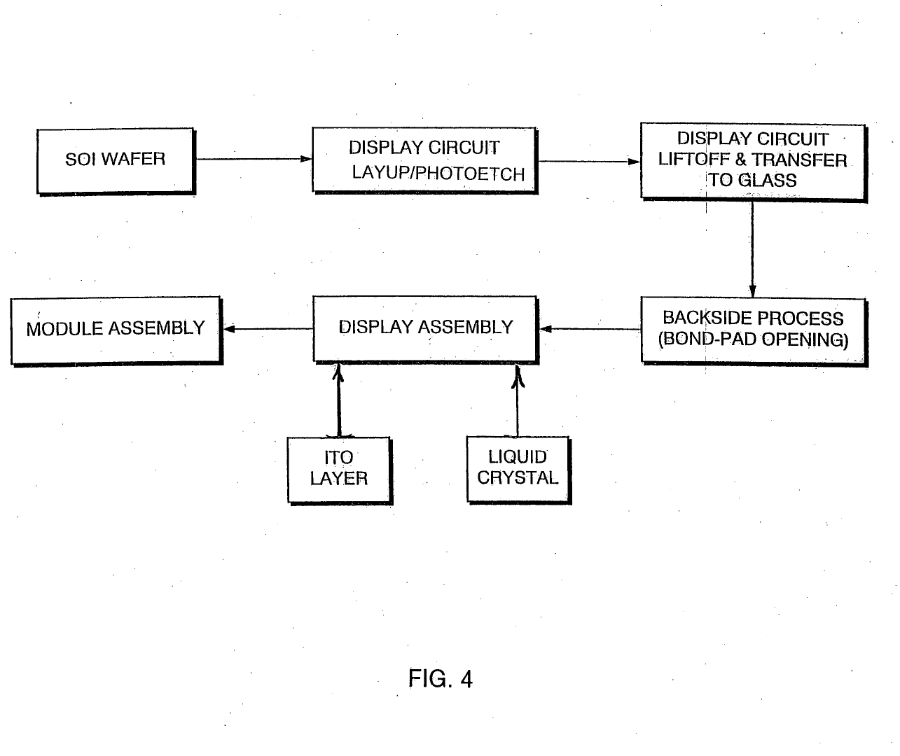

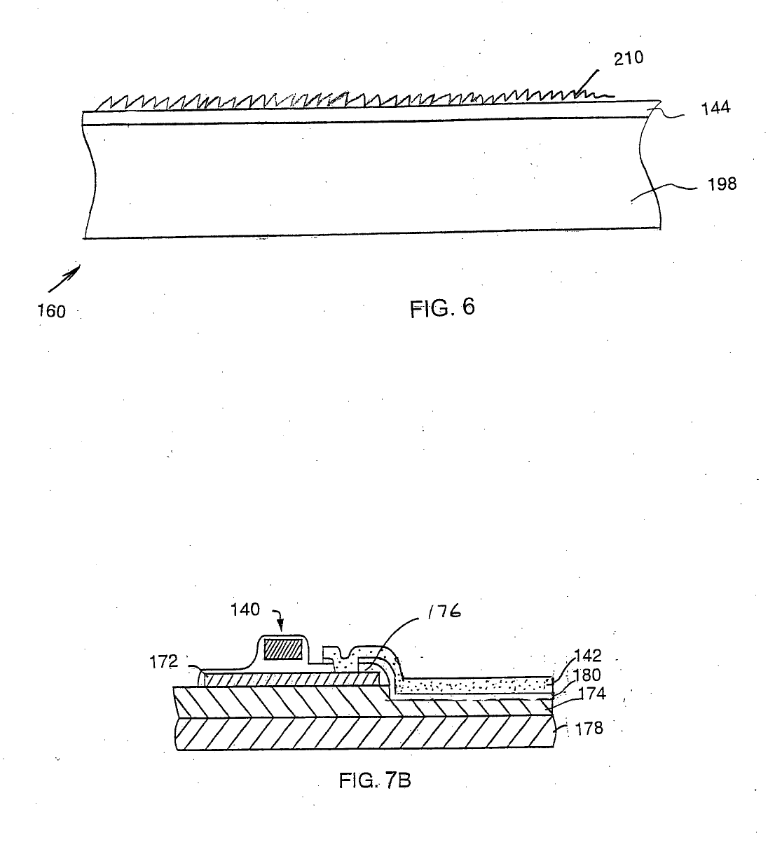

The flat panel display, also referred to as a microdisplay 110, is assembled in several major assemblies wherein in each assembly may have several steps. Referring to FIG. 4, the wafer 114 is a SOI (Silicon on Insulator) wafer on which the integrated circuit display die 116 is laid. The display circuit 116 transferred to a glass sheet 158 and is lifted off the wafer 114. The backside of the display circuit 116 is processed. In addition to the display circuit 116, an ITO (Indium Tin Oxide) wafer 160, as seen in FIG. 6, having the counterelectrode 144 is manufactured. The display circuit 116, the ITO wafer 160 and the liquid crystal 146 are assembled in a display assembly 162. The display assembly 162 is assembled into a module assembly 164.

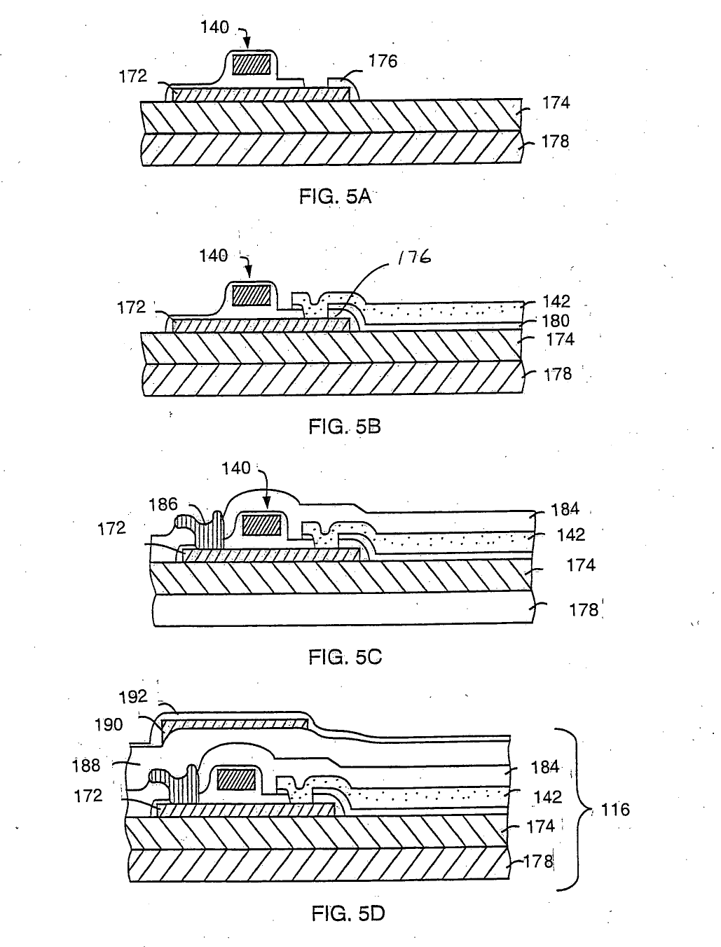

The forming of the IC display die 116 is illustrated in FIGS. 5A-5D. One of the transistors 140 of the display matrix circuit 118 is shown being formed with a thin film single crystal silicon layer 172 over an insulating substrate 174 as seen in FIG. 5A. The silicon layer 172 over the insulating substrate 174 can be formed by recrystallization of the silicon layer or by using a bonded wafer process in which a first silicon wafer is bonded to a second silicon wafer with an insulating oxide layer. The second wafer is thinned to form a silicon-on-insulator structure suitable for display circuit fabrication and transfer to an optically transparent substrate. Additional details on fabrication of the display is described in U.S. patent application Ser. No. 08/215,555 filed Mar. 21, 1994 and titled “Methods of Fabricating Active Matrix Pixel Electrodes” which issued as U.S. Pat. No. 5,705,424 on Jan. 6, 1998, and U.S. patent application Ser. No. 08/966,985 filed Nov. 10, 1998 and titled “Color Sequential Reflective Microdisplay,” the contents of which are incorporated herein in their entirety by reference. A thermal oxide 176 also overlies a portion of the single crystal silicon layer 172. The insulating substrate 174 is carried by a Silicon (Si) wafer 178.

A layer of Si₃N₄ 180 is formed as an anti-reflection layer over the insulating substrate 174 and the thermal oxide 176 as illustrated in FIG. 5B. The pixel electrode 142, a poly-silicon electrode, is formed over the Si₃N₄ layer 180 and is in contact with the thin film single crystal silicon layer 172.

Referring to FIG. 5C, a Boron Phosphorus Silica Glass (BPSG) layer 184 is formed over the circuit. A portion is etched away and an aluminum terminal 186 is added. Referring to FIG. 5D, a layer of Phosphorus Silica Glass (PSG) 188 of SiO₂ is formed over the BPSG 134 and the aluminum terminal 186. A titanium (Ti) black matrix 190 is located over the transistor as a light shield. A silica passivation 192 is formed over the entire wafer. The wafer is ready for the next assembly process.

In a separate process, the ITO wafer 160 having a counterelectrode 144 is formed. FIG. 6 illustrates the ITO wafer having a layer of glass 198, and the counterelectrode 144 (an ITO layer).

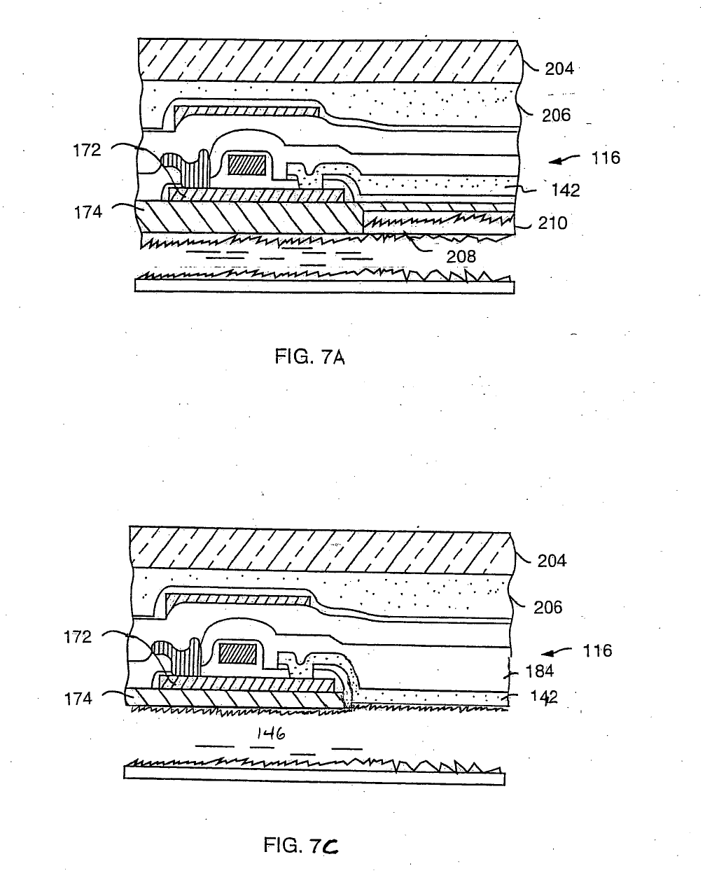

With the circuitry formed and the ITO wafer 160 formed, the two are ready to be joined together. The circuitry device 116 is then transferred to an optically transparent substrate 204 as shown in FIG. 7A. A transparent adhesive 206 as described in greater detail in U.S. Pat. No. 5,256,562, the contents of which are incorporated herein by reference, is used to secure the circuit to the substrate 204. The layer, Si Wafer 178, seen in FIGS. 5A-5D, to which the insulating substrate 174 was initially attached, is removed.

The insulating substrate 174, also referred to as a buried oxide layer, is etched in the location over the pixel arrays 142 as illustrated in FIG. 7A. The buried oxide layer not located over the pixel arrays is left, therein creating a series of pools 208. In a preferred embodiment, the buried oxide layer is 0.5 μm and thinned by 0.2 μm to 0.3 μm in the pool areas over the pixel arrays. By only thinning the pixel arrays, the applied voltage to the liquid crystal is increased without compromising the back-gate effect to the transistors (TFTs).

An alternative integrated circuit display die 116 is shown in FIGS. 7B and 7C. Referring to FIG. 7B, the insulating substrate 174 is etched, a layer of Si₃N₄ 180 is formed over the insulating substrate 174 and the thermal oxide 176. The pixel electrode 142, a poly-silicon electrode, is formed over the Si₃N₄ layer and is in contact with the thin film single crystal silicon layer 172. The rest of the wafer is formed in the method described above.

After, the circuitry device 116 is transferred to an optically transparent substrate 204 as seen in FIG. 7C. The insulating substrate 174, also referred to as a buried oxide layer, is etched. The buried oxide is thinned until the Si₃N₄ layer 180, as seen in FIG. 7B, is reached. The Si₃N₄ layer 180 is removed by wet etch phosphoric acid process. The pixel electrode 142 is in contact with the liquid crystal 146.

It is recognized that the insulating substrate 174 can be etched in the location where the pixel electrodes 142 are to be located to the silicon wafer 178. The Si₃N₄ layer is located on the silicon wager 178. The buried oxide does not need to be thinned after the circuit device 116 is transferred to the optically transparent substrate 204. The Si₃N₄ layer 180 is removed as described above.

It is also recognized that the series of pools 208, such as shown in FIG. 7A, can be thinned to the Si₃N₄ layer 180. The Si₃N₄ layer 180 with a wet etch phosphoric acid process.

An alignment layer 210 of SiOₓ is deposited on the buried oxide and the counterelectrode illustrated in FIGS. 6 and 7A. The alignment layers 210 align the liquid crystal as described below.

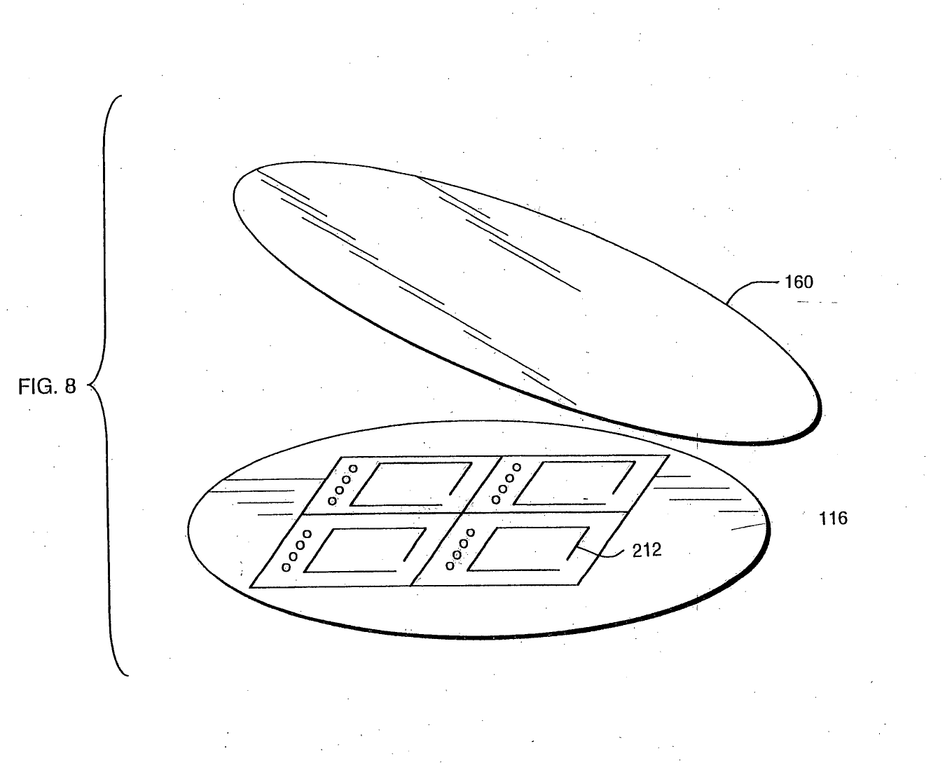

A frame adhesive 212 is placed around each display area as illustrated in FIG. 8. In addition, a silver paste is located in one spot on each display, so that the counter electrode is connected to the circuit when joined. A fill hole is left for filling the liquid crystal, as described below. The frame adhesive has a plurality of spacer balls. The spacer balls are 3-4 μm in diameter. The TFT glass and the counterelectrode glass are pressed together. The spacer balls ensure that the layers are spaced 1.8 μm apart when the bonding pressure is asserted. There are no spacers in the active matrix area. The combined wafers are then cured. While in a preferred embodiment spacer balls are used, it is recognized a spacerless display can also be made using other spacer technology such as posts.

After curing, the two sheets of glass, the TFT glass 204 and the counterelectrode glass 198, are scribed and broken. The two glass layers are scribed and broken on two opposite ends and staggered such that the TFT glass 204 appears shifted to the right relative to the counterelectrode glass 198 in FIG. 9.

The individual displays are placed in a holding tray and dipped into liquid crystal to fill the space between the buried layer and the counterelectrode. The liquid crystal 146 is located between the alignment layers 210. The fill hole is then filled. That is the final step of the display assembly.

The module assembly consists of attaching a flex cable 214, a pair of polarizers 216 and mounting them into a module 218. Referring to FIG. 9, a sectional view of a display 110 is shown. For clarity, the elements of the display are not shown to scale, only one pixel element is shown and certain elements have not been shown. The display 110 has an active matrix portion 220 including the pixel element 138 spaced from the counterelectrode 144 by the interposed liquid crystal material layer 146. Each pixel element 138 has a transistor 140 and a pixel electrode 142. The active matrix portion 220 can have aluminum light shields 224 to protect the transistor (TFT) 140 if the active matrix is used for projection requiring high luminance light. The counterelectrode 144 is connected to the rest of the circuit by solder bumps 226. The matrix 220 is bounded by a pair of glass substrates 198 and 204. An additional pair of glass plates 228 are located outboard of the active matrix portion 220. The glass plates 228 are spaced from the polarizer 216. The space defines an insulation layer 230. The module 218 of the display 110 is a two-piece case which contains the active matrix portion 220, the glass plates 228 and the polarizers 216. A room temperature vulcanization (RTV) rubber 232 helps maintain the elements in the proper position in the case.

Each of the glass substrates 198 and 204 has one of the polarizers 216 on the side opposite the layer of liquid crystal 146.

In order to get the liquid crystal to respond more quickly, the distance between the counterelectrode and the oxide layer is 2.0 μm at the pools 208. The narrow distance between the two elements results in less liquid crystal that has to twist to allow light to pass. However, the narrowing of the distance results in additional problems including the viscosity of some liquid crystals making it difficult to fill the display. Therefore, the selection of the proper liquid crystal requires an evaluation of the liquid crystal properties.

There are many characteristics that must be taken into account in selecting the desirable liquid crystal. Some characteristics include the operational temperature range, the birefringence (delta n=nₑ−nₒ), the operational voltage, viscosity and resistivity of the liquid crystal. With respect to viscosity, flow viscosity and rotational viscosity are two areas that are examined. The preferred ranges are a flow viscosity of less than 40 centipoises (cp) and a rotational viscosity less than 200 cp in the temperature range of 0° C. to 70° C.

Another characteristic that is examined in selecting a liquid crystal is delta n. The value of delta n depends on the cell gap and the liquid crystal pretilt angle at the two surfaces. The pretilt angle at the two surfaces is influenced by the alignment layer of SiOₓ deposited on the buried oxide and the counterelectrode. For a 2 μm gap a delta n of greater than 0.18 is preferred and a delta n of 0.285 is desired. For a large gap a different delta n is required. For a gap of 5 μm a delta n in the range of 0.08 to 0.14 is desired.

In addition to viscosity and delta n (Δn), the liquid crystal's threshold voltage and the voltage holding rate are criteria to be examined when selecting a liquid crystal. In a preferred embodiment, the threshold voltage is less than 1.8 volts, and preferably approximately 1.2 volts. The voltage holding ratio is preferably greater than 99%.

Other characteristics that are desired are easy alignment and stability to UV and high optical intensity. If required, the delta n can be compromised in order to achieve a lower viscosity and lower operation voltage.

In a preferred embodiment, the liquid crystal chosen was a SFM (superfluoriated material). In preferred embodiments, the liquid crystal selected was one of TL203 and MLC-9100-000 marketed by Merck.

Liquid crystal is formed of a chemical chain which extends from the two surfaces. The alignment layers 210 of SiOₓ as seen in FIG. 7A, are deposited on the buried oxide 174 and the counterelectrode 144, or the pixel electrode 142 and the counter electrode 144 in FIG. 7C1 are oriented in a preferred embodiment at 90° to each other. The alignment layers 210 give the liquid crystal 146 a pre-alignment. The alignment layers 210 have thickness of approximately 500 Angstrom.

The chain of liquid crystal twists and untwists depending on the voltage to the associated pixel electrode. This twisting in relation to the polarization plates results in the liquid crystal going between a white or clear state and a dark state.

While depending on the relation of the liquid crystal and the polarization plates, the liquid crystal can either look clear or dark in the relaxed position and conversely dark or clear in the driven state. In a preferred embodiment, the liquid crystal looks clear in the relaxed position and dark in the driven state.

As indicated above, the microdisplay 110 can have an active matrix array of different numbers of pixels. FIG. 10 shows schematically an alternative circuit active matrix display die 240 for (640×480) pixel display. In contrast to the embodiment shown in FIG. 2, the display is split into quadrants which feed simultaneously and independently. The integrated circuit display die 240 has a display matrix circuit 242, a pair of vertical shift registers 244, a horizontal shift control 246, a quadruplet of horizontal shift registers 248, and a plurality of transmission gates 250.

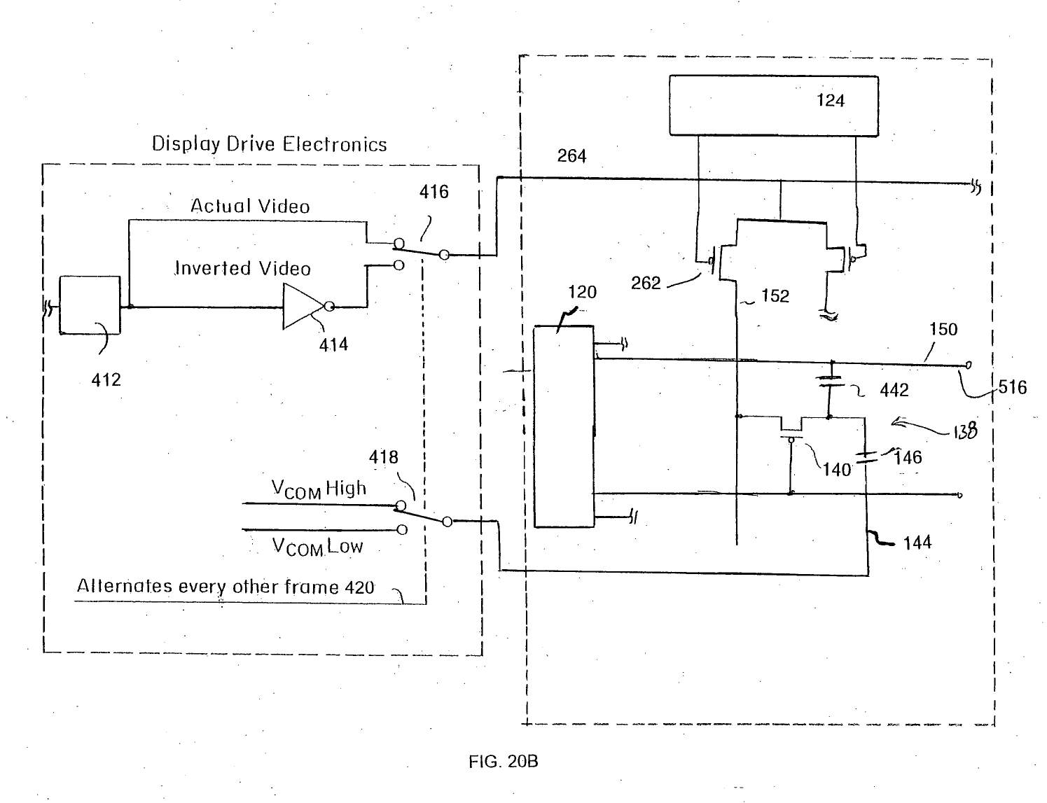

The analog video signals from a digital to analog amplifier are carried on a quadruplet of video signal lines 252 to the transmission gates 250 located above and below the display matrix circuit 224. The integrated circuit display die 240 has a column reset circuit 254, similar to the column reset circuit 154 discussed above. The display matrix circuit 242 has elements similar to those discussed above with respect to FIG. 2 and shown in more detail in FIG. 20A.

It is recognized that in both smaller and larger arrays, such as 480×320 and 1280×1024, it may be desirable to split the display in sectors and drive individual sectors independently. Another description of a display with a multiple channel driver is described in U.S. patent application Ser. No. 08/942,272 filed on Sep. 30, 1997 and titled “Color Display System for a Camera,” the entire contents being incorporated herein by reference.

FIG. 11 shows an integrated circuit display die 258 for a microdisplay for low voltage video in which video is fed to the even columns of the display from one side, above in FIG. 11, and the video for the odd columns is fed from the other side. Incorporated into the integrated circuit display die 258 are a display matrix circuit 260, a vertical shift register 120, a horizontal shift control 122, a pair of horizontal shift register 124 and 126, and a plurality of transmission gates 262. The transmission gates 262 may be implemented with a complimentary pair of N-channel 1020 and P-channel 1022 transistors.

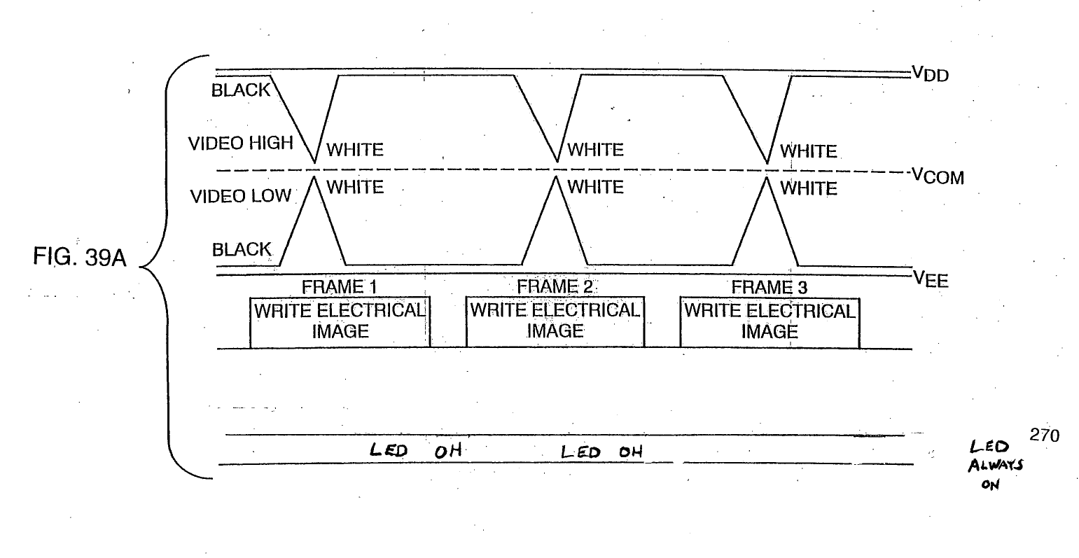

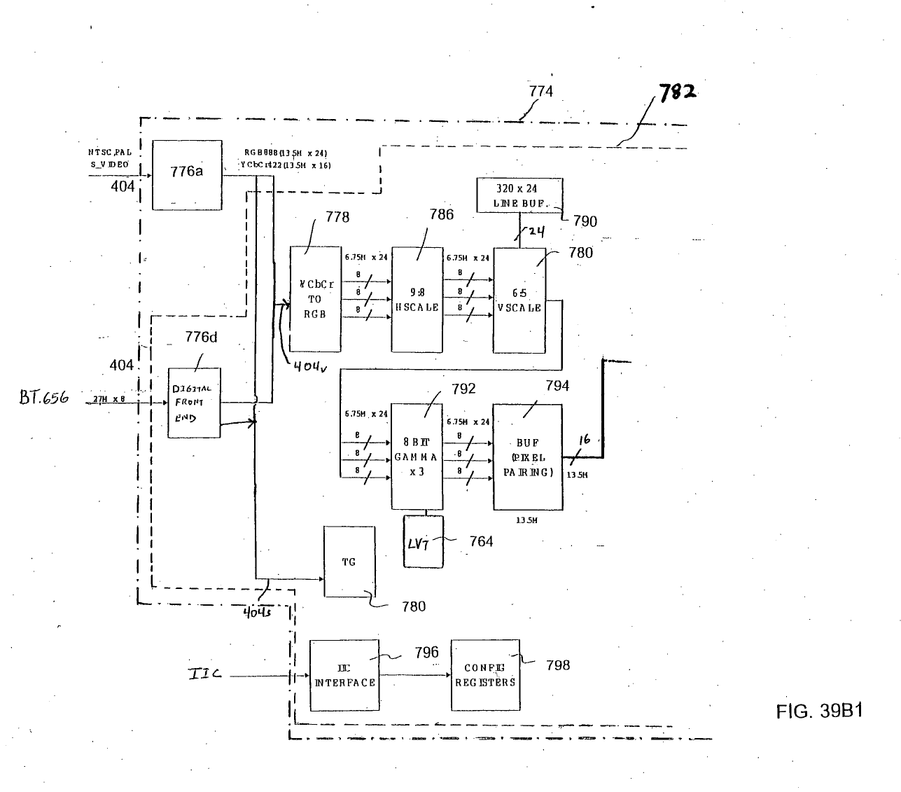

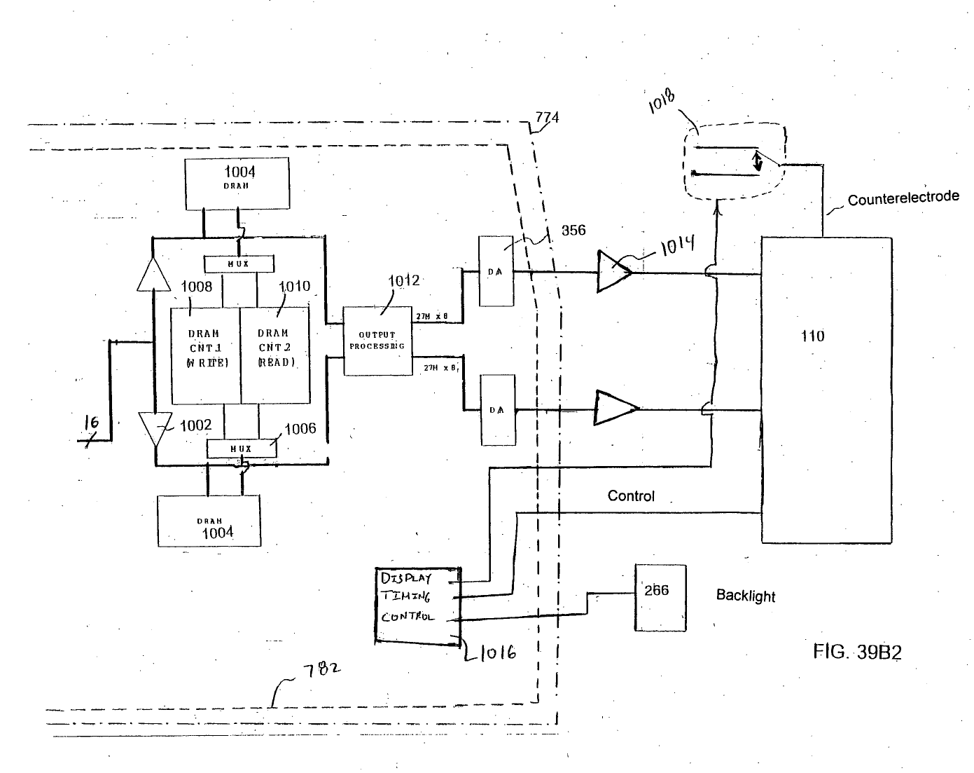

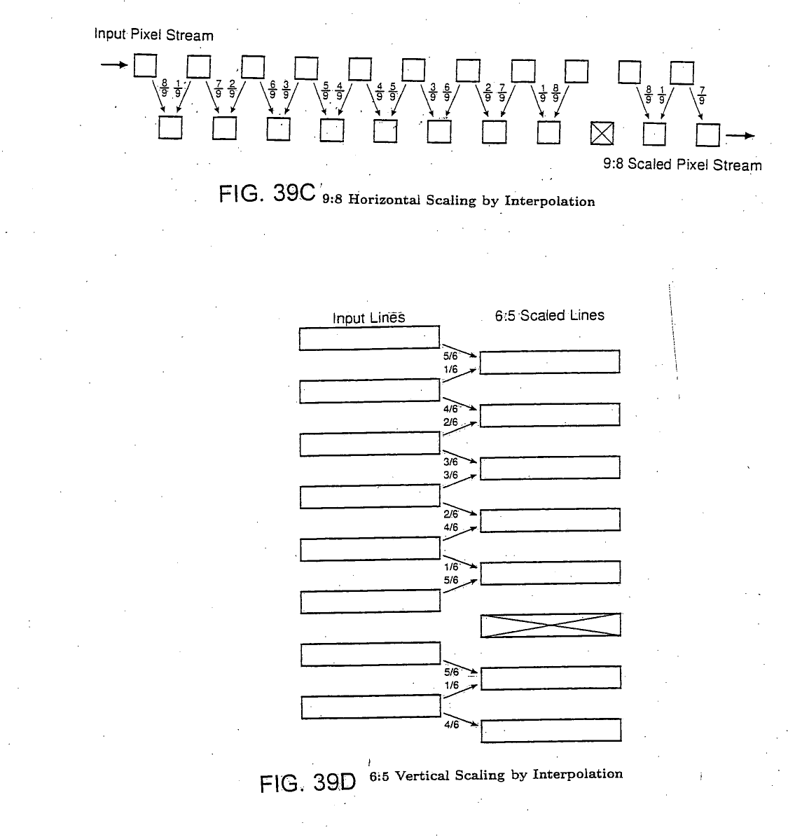

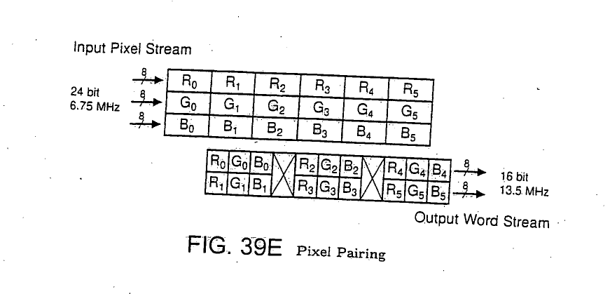

A pair of video signal lines 264 carries analog video signals from a pair of digital to analog amplifiers 356, as discussed in further detail with respect to FIG. 39B, to the transmission gates 262. The transmission gates 262 are controlled by the horizontal shift registers 124 and 126. The horizontal shift registers 124 and 126 are controlled by the horizontal shift control 122. The horizontal shift registers select the two columns to which that bits or segment of the video signal are sent by the inputted video signal. In contrast to the integrated circuit display dies shown in FIGS. 2 and 10, the two pixels, one in an even column and one in an odd column, are written simultaneously.

The display matrix circuit 260 has a plurality of pixel elements 128 similar to the previous embodiments. Each pixel element 138 has the transistor 140 and the pixel electrode 142. The pixel electrode 142 works in conjunction with the counterelectrode 144 and the interposed layer of liquid crystal 146, as best seen in FIG. 20A, to form the pixel capacitor 148 for creating an image.

In addition to selecting the column which receives the signal by use of the horizontal shift register 124, the row needs to be selected. The vertical shift register 120 selects the row. The row line 150 from the vertical shift register 120 is connected to the gate of each of the transistors 140 to turn on the pixels of the row. With the pixels turned on for one row, and two columns 152 selected, each by a respective horizontal shift register 124 or 126, the two pixels are selected and the video signal drives the liquid crystal or allows the liquid crystal of the pixel element to relax.

In contrast to the integrated circuit display die 116 of FIG. 2, while there still two horizontal shift registers and two video signal lines, each video signal line receives both a video signal and an inverted video signal. The signal is switched each frame or subframe and is referred to as frame inversion. In addition, the voltage to the counterelectrode (V_{COM}) is switched every frame or subframe as explained below. The integrated circuit display die also has a column reset circuit 154. In low voltage video (LVV), which will be described in greater detail below, the voltage of the counterelectrode is switched and initialization occurs at the beginning of the subframe. While the integrated circuit display die 258 which writes to two pixels at the same time is discussed with LVV, neither requires the other.

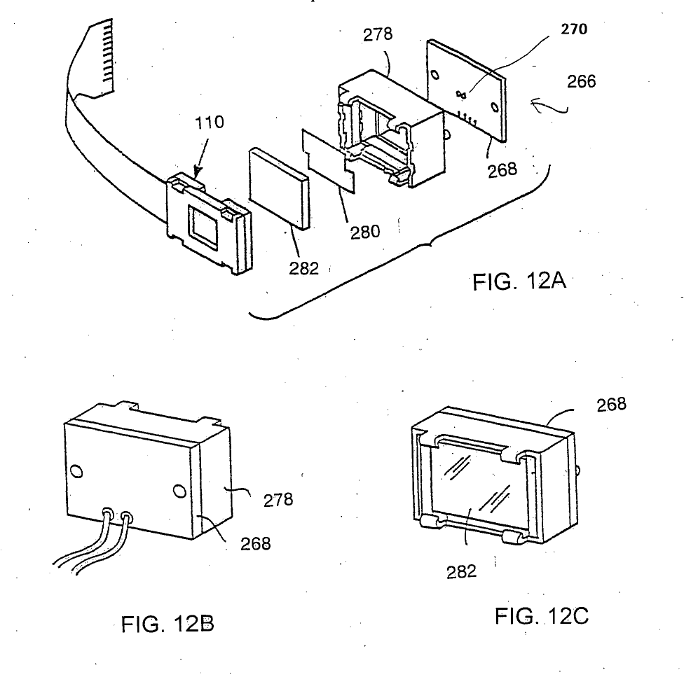

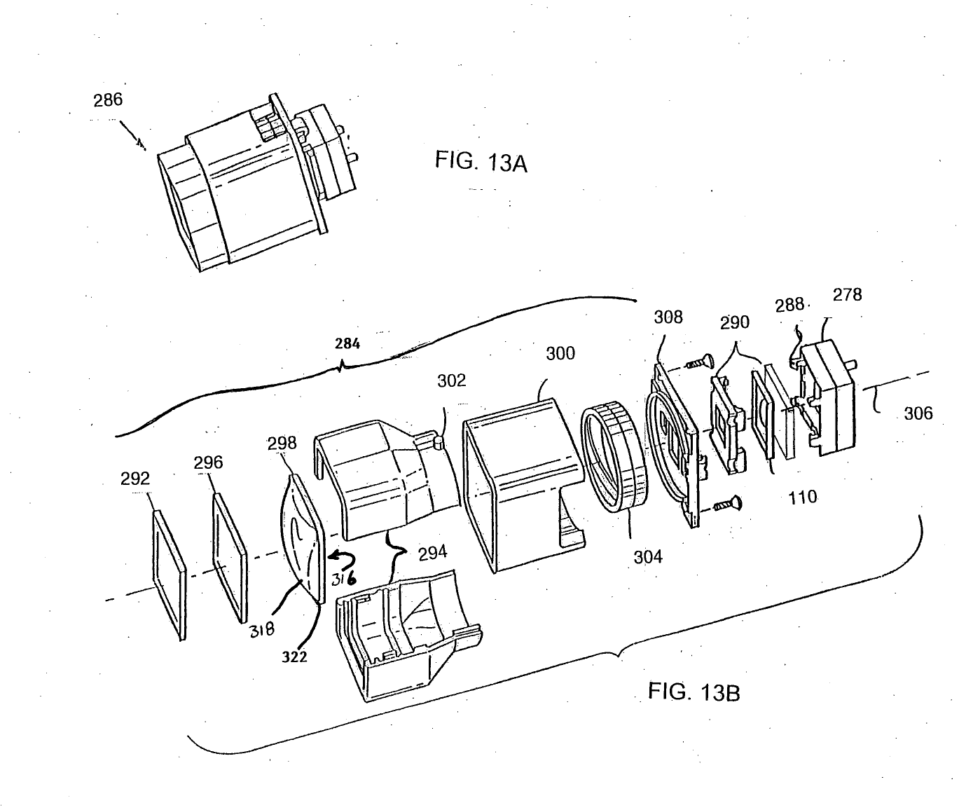

The image on the microdisplay 110 is viewed in a preferred embodiment by shining a light through the liquid crystal 146 or backlighting the liquid crystal 146. FIGS. 12A, 12B, and 12C show a backlight system 266.

An exploded view of a preferred embodiment of the backlight system 266 relative to the display 110 is shown in FIG. 12A. A plurality of LEDs 270 backlight are mounted on circuit board 268. Preferably, three LEDs are used to provide three colors. The circuit board 268 with the LEDs 270 is held by a backlight housing 278. Between the backlight housing 278 and the display 110, a brightness enhancement film 280, such as the “BEF” film available from 3M Corporation can optionally be used along with a diffuser 282. As seen in FIGS. 12B and 12C, the circuit board 268 mounted on a first side of housing 278 and the backlight active area is defined by the diffuser 282 on a second side of the housing 270.

The microdisplay 100 and the backlight system 266 are coupled with a lens system 284. FIG. 13A is a perspective view of the assembled display module 286. The exploded view of FIG. 13B shows the elements of the system 286 in detail. The backlight reflector is positioned in backlight housing 278 which can be adhered directly onto the display 110 with an epoxy adhesive or with a plurality of clips 288. The display is held by a display holder 290 which can also serve to define the visual border for the active area of the display as seen by the user through a transparent window 292. The transparent window 292 which is generally considered part of the lens system 284, is carried by an optics holder 294. The optics holder 294 in addition retains a color correction element 296, and a lens 298. An optional second lens may be located in the optics holder 294.

The optics holder 294 is slideably located in a housing element 300. A pin 302 carried by the optics holder 294 couples the holder 294 to a ring 304, such that rotation of the ring 304 translates the optics holder 294 along an optical axis 306. A holding panel 308, which retains the ring 304 to the housing element 300 also secures the display holder 290, which is referred to as a module 218 in FIG. 9. The assembled display module 286 as illustrated in FIGS. 13A and 13B has a volume of less than 15 cm³.

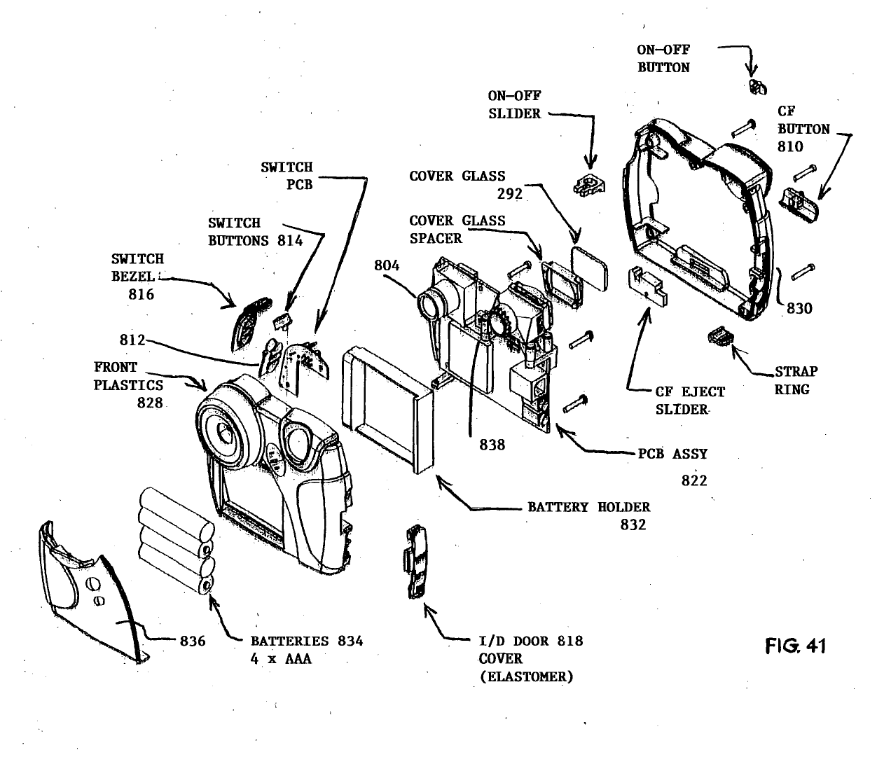

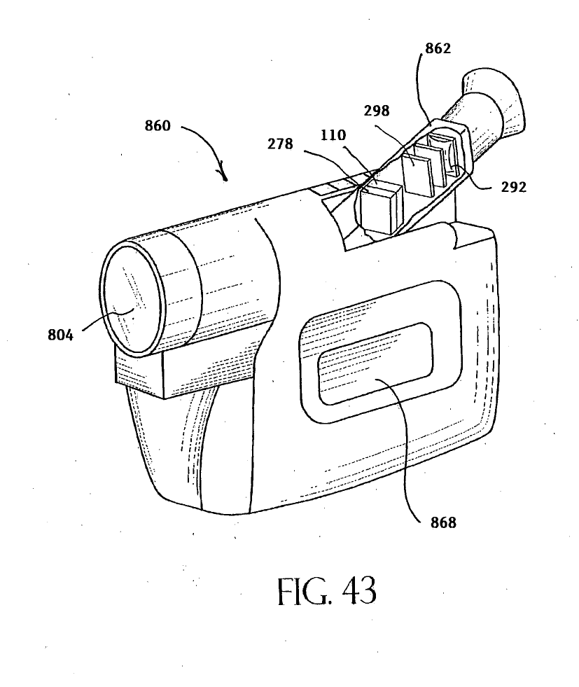

The assembled display module 286 fits snugly within an external housing such as a viewfinder housing 862, such as that shown in FIG. 43, or within the other device housings as described herein, such as in FIG. 41. These small high resolution displays require magnification such that when held in a user's hand within the range of 0.5 inches to 10 inches of the user's eye, a clear image is provided.

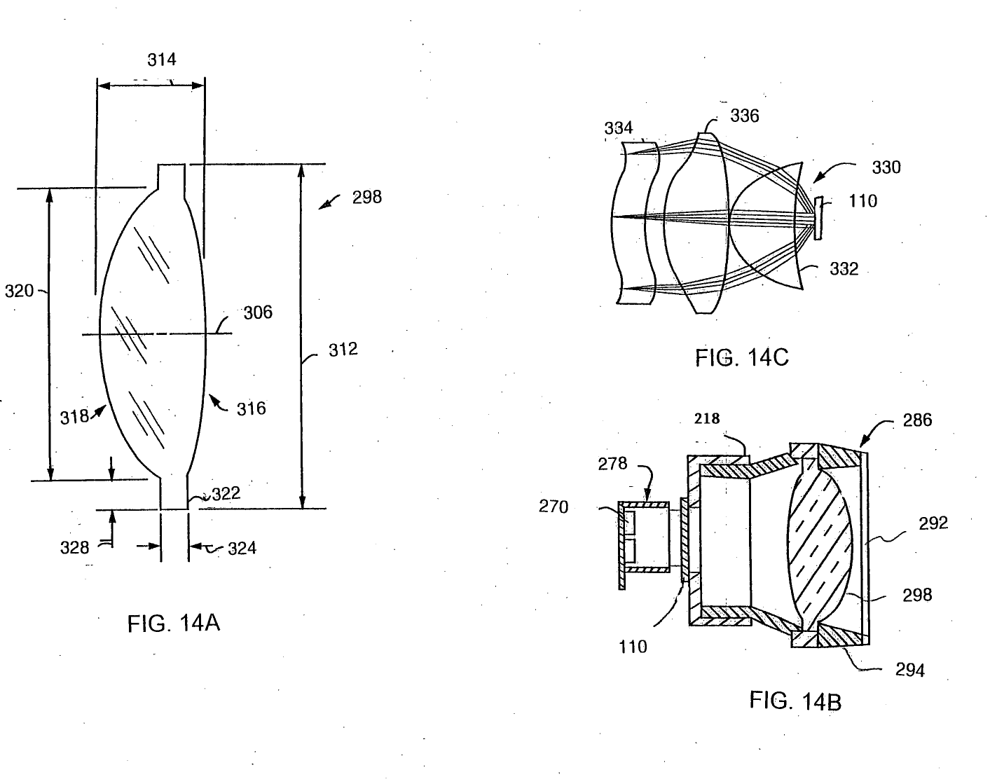

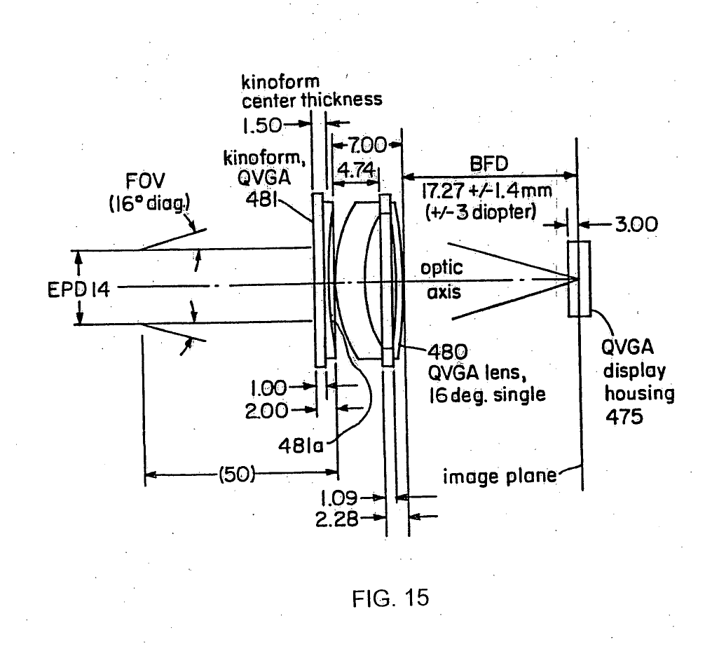

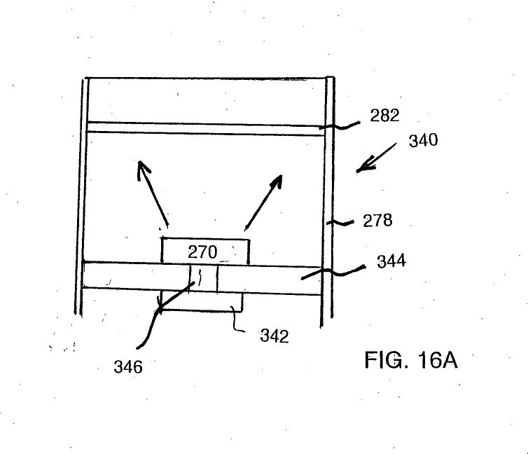

Referring to FIG. 14A, the lens 298 for magnifying the image of the microdisplay 110 and carried in the optics holder 294 of FIGS. 13A and 13B is shown. For a QVGA (Quarter VGA 320×240) display with a 0.24 inches diagonal microdisplay, in a preferred embodiment the lens 298 has an outer diameter 312 of about 30.4 mm and a thickness 314 at the optical axis 206 of about 8 mm. The lens 298 has an inner surface 316 that receives light from the display and has a curved diameter of about 21.6 mm, and viewing surface 318 has a diameter 320 of about 22.4. A peripheral edge 322 of the lens 298 is used to hold the lens 298 in the optics holder 294 and has a thickness 324 of about 2 mm and a radius 328 of about 4 mm. While in a preferred embodiment, the lens 298 is made of acrylic, it is recognized that the lens 298 could be made of polymer material or glass. This particular example of such a lens has a 16 degree field of view and an ERD (eye relief distance) of 50 mm.

FIG. 14B is a cross sectional view of an alternative assembled display module 286 with lens 298. The lens 298, along with the transparent window 292 and the color correction element 296, not shown in FIG. 14B, is retained by the optics holder 294.

The backlight housing 278 has three LEDs 270. The microdisplay 110 is within the module 218 interposed between the holding element 300 and the backlight housing 278.

Another preferred embodiment of a 1.25 inch diameter lens system 330 with a larger field of view is illustrated in FIG. 14C. Three lens elements 332, 334 and 336 enlarge the image on the display 110.

The color correction element 296 can be a transparent molded plastic kinoform having a contoured surface with circular steps that introduce phase corrections into the incident light. The configuration of a preferred embodiment 296 in which the single lens 298 is positioned adjacent the kinoform, color correction element, 296 for a QVGA display 110 is illustrated in FIG. 15 with dimensions in millimeters. The kinoform 296 can be made of an acrylic material molded to form a concave surface 296a facing the lens. The surface 296a can have an anti-reflective coating thereon to increase the transmission. The concave surface is divided into a number of zones of different radii and width. Each zone is separated by a step in the surface. The QVGA display preferably has between 150 and 300 zones whereas a 640×480 display has between 500 and 1000 zones.

Other preferred embodiments of optical systems for color displays are described in application U.S. Ser. No. 08/565,058 filed on Nov. 30, 1995, the entire contents of which is incorporated herein by reference. Additional details on optical systems for color displays are described in U.S. Ser. No. 08/966,985 filed on Nov. 10, 1997 of Jacobsen et al. and titled “REFLECTIVE MICRODISPLAY FOR PORTABLE COMMUNICATION SYSTEM”, the contents of which is incorporated herein in its entirety by reference.

In producing the image both the twisting and untwisting of the pixel segments of liquid crystal, as described in more detail below and the LEDs 270 of the backlight system 266 needed to be controlled the LEDs 270 are flashed to produce the image as explained below. In addition, to the flashing, it may be desirable to vary the intensity.

When LEDs 270 are produced, the intensity for a given current will vary from LED to LED or lot to lot. In attempting to balance the colors of the three LEDs, red, blue and green, one technique is to connect a potentiometer to each LED and adjust to get the proper balance of color temperature.

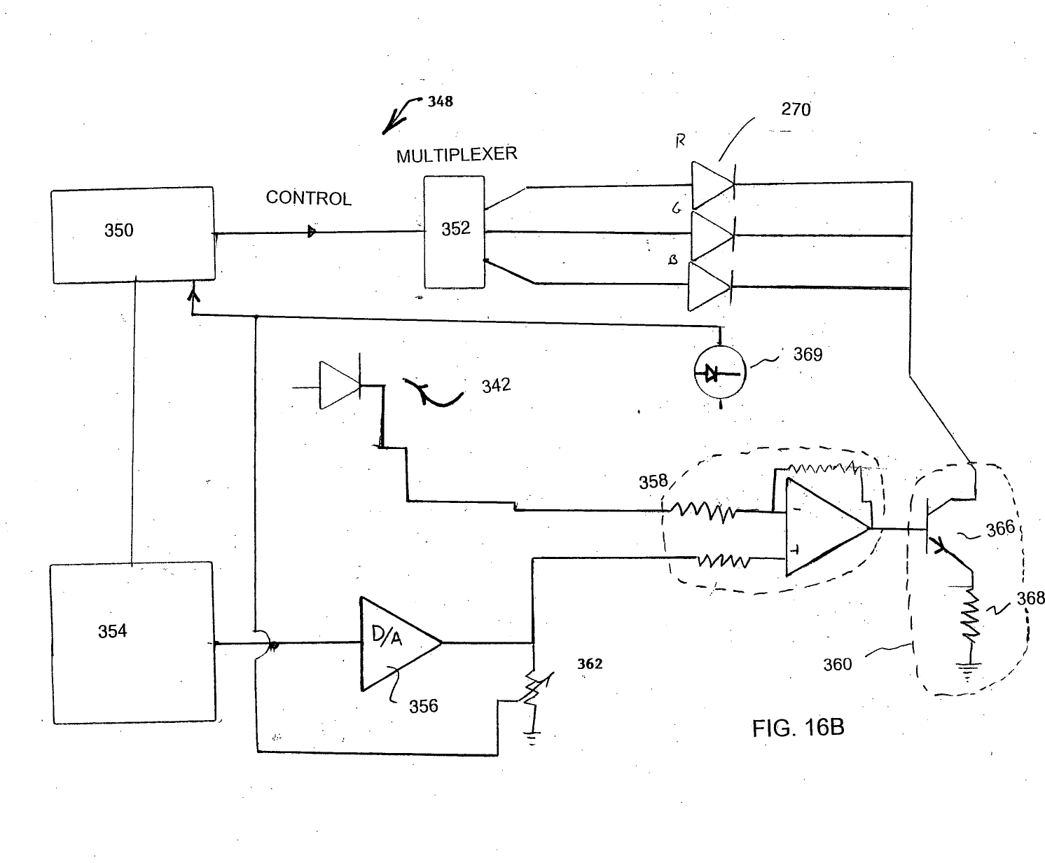

FIG. 16A is a cross sectional view of a backlight system 340 with a detector 342. The backlight system 340 has a backlight housing 278 to which a circuit board 344 and the diffuser 282 are attached. A plurality of LEDs 270 are attached to the circuit board 344. The detector 342 is located on the opposite side of the circuit board 344. An aperture or glass rod 346 allows light to pass through the circuit board 344 from the LEDs 270 to the detector 342. In a preferred embodiment, the detector 342 is made from silicon. It is recognized that other visible light sensors like photo resistive material can be used.

FIG. 16B is a schematic of a circuit 348 that controls the current to the LEDs 270. The circuit 348 has a display logic circuit 350, which controls the LEDs 270 through a multiplexer 352 which selects the LED 270. In a preferred embodiment, the multiplexer 352 is part of the display logic circuit. The multiplexer 352 is controlled by the display logic circuit 350. The display logic circuit 350 is further discussed below with respect to the microdisplay 110.

In addition to being connected to the multiplexer 352/LED 270, the display logic circuit 350 is connected to a memory 354. In a preferred embodiment, the memory is a 24 bit memory which holds predetermined values of intensity levels for the red, green and blue LEDs 270. A digital-to-analog converter 356 receives the digital value from the memory 354 and produces an analog signal representing the intensity level.

The brightness control 362 may be used to adjust the analog signal from the converter 356. In a preferred embodiment, the brightness control 362 may be a potentiometer at the output of the converter 356. In an alternative embodiment, the brightness control may be connected to the full-scale control of the converter 356.

A feedback control circuit 358 compares the signal from the detector 342 to the analog intensity signal from the converter 356 or brightness control 362, and produces an output signal for the LED current drive circuit 360. The feedback control circuit 358 adjusts its output signal so that the LED intensity measured by the detector 342 matches the intensity value set by the converter 356 and brightness control 362. In a preferred embodiment, the LED current drive circuit 360 uses a transistor 366 and resistor 368.

While in most environments it is desired to have the display as bright as possible, especially in bright sunlight, there are certain situations where it is desirous to lower the intensity of the display such that the person using the display preserves their night vision, such as an aircraft or a ship at night.

The backlight in the display transitions from a normal mode to a night or low light ambient mode. In a normal mode, the LED(s) for normal light are used, such as a single amber, green, or white LEDs for a monochrome display and red, blue, and green LEDs for a color sequential display.

For daylight operation, the “day” LED(s) would be on to provide the display to be readable in ambient sunlight. If the ambient light level decreases, the LED(s)' intensity could be decreased to provide an image with brightness comfortable to view. At some point with lower light ambient, a call for a decrease in the LED intensity would result in the turning off of the “day” LED and the turning on of the “night” LED; further reductions in display brightness would result in decrease of the “night” LED intensity until arriving to some minimum or at some point the LED is turned off. Referring to FIG. 16B, an ambient light sensor 369 connects to the brightness control 362 to vary the intensity of the LEDs 270. The ambient light sensor 369 also connects to the display logic circuit 350 such that the logic circuit 350 can switch to single color “night” LED.

Increasing the display brightness would be the reverse of this, consisting of first increasing the “night” LED brightness until some crossover point where the “night” LED was turned off and the “day” LED turned on. Further increasing of the display brightness would only increase the “day” LED brightness.

Dependent on the environment in which the microdisplay is located, the “night” LED is either a red LED or a blue green LED. While red is typically considered better for maintaining a person's night vision, the red light is more detectable using night detection gear.

It is recognized that the night illumination source can be chosen either from a class of sources that do not emit infrared and near infrared frequencies, or a filter that removes infrared and near infrared frequencies can be interposed between the night light source and the remaining structure.

While the intensity, style or color of a light source may be dependent on the ambient light, the level of ambient light does not generally effect the color sequential process described below. The circuitry for backlight was discussed above. Circuitry for controlling the microdisplay 110 is described below.

The configuration of the display for a monochrome or a color sequential display is generally the same with the same pixel pitch or size. This is in contrast to other types of color displays where there is an individual pixel for each of red, green and blue. The distinction in the display is the light source not the microdisplay 110. In a monochrome display a single light source is required, wherein in a color sequential display there are three distinct light sources (e.g., red, green and blue). In that there are three distinct colors, each color must flash in order to produce most images, in contrast to one flash for monochrome. It is recognized that for monochrome, it may be desirable to leave the LED on or to pulse the light emitting diode (LED) as described below.

In sequential color displays, the display panel is triple scanned, once for each primary color. For example, to produce color frames at 20 Hz, the active matrix must be driven at a frequency of 60 Hz. However, in order to reduce flicker it is desirable to drive the active matrix to have a frame rate of 60 frames per second, since at over 60 Hz, visible flicker is reduced. In a color display a preferred frame rate is a minimum 60 frames per second which results in 180 sub-frames per second, in that each frame has a red, a blue and a green sub-frame. In contrast for the monochrome display where there is only a frame not three subframes, the frame rate can be higher and in a preferred embodiment the frame rate is 72 frames per second. It is thus recognized that while a display for a color sequential display is substantially similar to one for a monochrome display, the sub-frame rate needs to be substantially faster to achieve the desired results in color sequential.

Referring back to FIGS. 2 and 3, the image is scanned into the active matrix display 110 by the vertical shift register 120 selecting the first row, by the row going low, and the horizontal shift register 124 or 126 selecting column by column until the entire row has been written to.

In a column inversion mode, which is the preferred mode for the integrated circuit display die 116 shown in FIG. 2, the video for each pixel element 138 is alternated from video entering throughout the p-channel transmission gates 128 from the video signal high line 132 and inverted video entering through the n-channel transmission gate 130 from the video signal low line 134. The switching back and forth from video to inverted video in each column prevents DC voltage buildup on the buried oxide 174 and the liquid crystal 146.

When the first row is done, the vertical shift register 120 selects the second row. This continues until the last row is selected. The horizontal shift register 124 or 126 selects column by column until the last column in the last row has been written to. There is therefore a set time delay between when the first pixel (i.e., the first row, first column) and when the last pixel (i.e., the last row, last column) has been written. In a preferred embodiment, the delay from writing the first pixel to the last pixel is approximately 3 milliseconds.

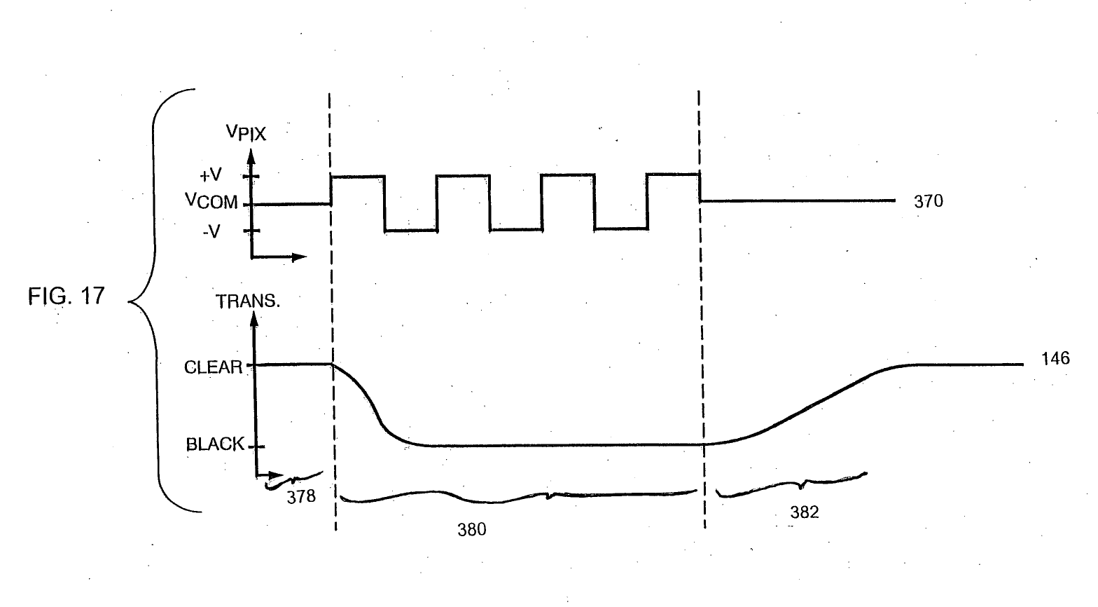

As indicated above in describing the assembly of microdisplay 110, the liquid crystal does not respond instantaneously to the change of voltage. The delay for the liquid crystal to respond is illustrated in FIG. 17. The state of the liquid crystal 146 is dependent on the voltage of the pixel electrode 142, commonly referred to as Vₚᵢₓₑₗ 370, and the voltage of counterelectrode 144, commonly referred to as V_{COM} 372. With Vₚᵢₓₑₗ 370 initially equal to V_{COM} 372, in frame 378 as seen in FIG. 17, there is no voltage drop across the liquid crystal and the liquid crystal 146, as seen through the polarizers, is clear, as illustrated in transparence graph. When Vₚᵢₓₑₗ 370 goes to a voltage, +V or ⁻V, 374 there is a voltage drop or difference across the liquid crystal; the liquid crystal is driven black as seen in frames 380.

The change is not instantaneous since it takes the liquid crystal a set time to rotate. This time is a function of several factors including the type of liquid crystal and the temperature. The voltage is shown alternating since the voltage is inverted on the pixels to prevent a DC charge building on the liquid crystal.

If after reaching the steady state black, Vₚᵢₓₑₗ is set to V_{COM}, the liquid crystal returns to the clear state. Like the translation from clear to black, the change is not instantaneous. The change of state from black to clear takes longer than when the liquid crystal is being driven to black as seen in frames 382. FIG. 17 shows it takes over 2 ½ times as long to go from black to clear as it takes to go from clear to black. In a preferred embodiment using the preferred liquid crystal at room temperature, the time to drive from white to black is approximately 4 milliseconds and the time for the liquid crystal to return to white is approximately 10 milliseconds.

As indicated above, in order for the color display to reduce flicker, there needs to be 180 subframes per second or less than 6 milliseconds per subframe. Therefore at 180 subframes per second, the liquid crystal cannot go from black to clear in a subframe.

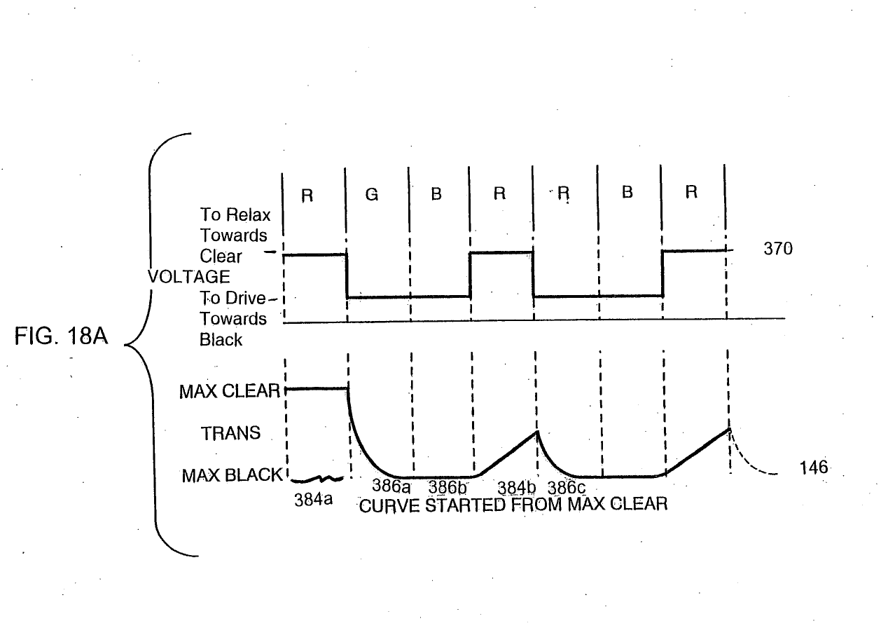

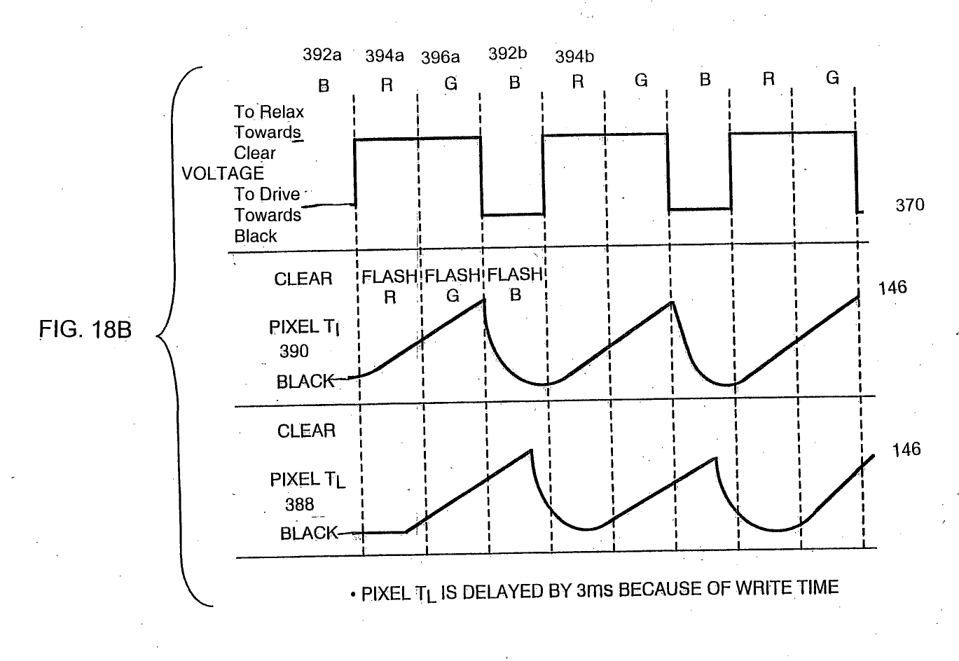

An example where a red image or pixel is desired is shown in FIG. 18A. The upper graph shows the voltage of the pixel electrode 142, Vₚᵢₓₑₗ 370. The voltage Vₚᵢₓₑₗ 370 is set to a voltage to relax the liquid crystal to clear or drive the liquid crystal to black. It is desired that the liquid crystal is clear when the red LED flash and black or opaque when the green or blue LED flashes. Therefore, to obtain the red pixel, the voltage of pixel electrode 142, Vₚᵢₓₑₗ 370 is set to V_{COM} for the subframe 384 which is associated with the red flash of light and another voltage for the subframes 386 which are associated with the green and the blue flashes. With the microdisplay 110 having 180 subframes per second, the eye blends red flash with the dark opaque periods therein producing a red pixel.

If the liquid crystal starts as clear in the first subframe 384a, it is capable of being driven black in the next subframe 386a, the subframe associated with the green flash. The display circuit continues to drive the liquid crystal black for the next subframe 386b associated with the blue flash. When the display circuit for that pixel sets the voltage for that pixel electrode 142, Vₚᵢₓₑₗ 370 to V_{COM}, the liquid crystal is allowed to relax. However, the liquid crystal 146, as represented in the illustration, does not get to a clear state by the time the subframe 384b is done. In the illustration shown in FIG. 18A, the liquid crystal only gets to about fifty percent (50%) clear. In the next subframe 386c, the green subframe, the liquid crystal 146 is driven black again. Therefore, the liquid crystal for this red pixel never gets to its completely clear state before the flash. A maximum brightness or contrast is never achieved.

With a color sequential display, even when the display is of a static image, the display is dynamic since the display is sequencing through the red image, the green image, and the blue image.

Referring back to FIG. 3, if the liquid crystal had a fast enough response to twist or untwist or if the subframe was a longer time period, even the last pixel 388 written to, as represented by the end of the write box, would be settled in the final position before the flashing of the LED. However, the liquid crystal does not respond quickly enough to allow settling at the frame or subframe speeds required to prevent flicker as illustrated in FIG. 18A. In that the pixels are written to sequentially, the first pixel 390 is written to (i.e., driven to twist or allowed to relax) a set time before the last pixel 388. In a preferred embodiment, the time between writing to the first pixel 390 and the last pixel 388 is approximately 3 milliseconds.

Therefore, the liquid crystal 146 associated with the last pixel 388 and the liquid crystal 146 associated with the first pixel 388 do not have the same amount of time to respond prior to the flashing of the backlight.

With the twist of the liquid crystal different at the two pixels, there is a different amount of light passing through the liquid crystal and therefore the contrast, the luminance, the color blend can vary from one corner to another of the display. For example, if a display had an intermediate color such as yellow at the first pixel and the last pixel, the color would not be identical.

An example of producing a yellow pixel which is created by allowing the red flash and the green flash to be seen and not the blue flash is shown in FIG. 18B. The FIG. 18B illustrates that the video signal sets the voltage for each pixel electrode 142, Vₚᵢₓₑₗ 370, to V_{COM} for the red subframes and for the green subframes, and to another voltage for the blue subframes. Therefore the video for the pixel is set to drive the pixel black for the blue subframe and allow it to relax for the red and the green subframes, as represented by the square wave. In the first subframe 392a in FIG. 18B, the blue subframe, the liquid crystal for both the first pixel 390 and the last pixel 388 are shown at a steady state black. The first pixel 390 receives its signal at the beginning of the red subframe 394a and the liquid crystal begins to relax. The last pixel 388 receives its signal at some time later, 3 milliseconds in a preferred embodiment, and the liquid crystal begins to relax at that time. The liquid crystal 146 related to the first pixel 390 and the last pixel 388 are at different points in the transition to clear when the red LED flashes, therein producing different levels of red. In the embodiment shown in FIG. 18B, the next color to flash is green and therefore the pixel electrodes 142 associated with first and last pixels 390 and 388 do not change voltage in the transition to the subframe 396a. Therefore the liquid crystal associated with both the first and the last pixel 390 continues to transition to clear. When the LED for green flashes, the liquid crystal for the two pixels 390 and 388 are in different points of transition to clear, therefore there is a different level of green. In addition, because the green flash occurred after the red flash and the liquid crystal had more time to transition, the amount of green that is visible is greater than the amount of red, therein resulting in a greenish yellow.

Still referring to FIG. 18B, the next subframe is the blue subframe 392b. The pixels 390 and 388 are driven black. The first pixel 390 once again receives its signal near the beginning of the subframe and in that in a preferred embodiment it takes 3 milliseconds for the liquid crystal to turn black, the liquid crystal 146 is black before the flash of the blue LED. The last pixel 388 receives its signal near the end of the subframe and is still transitioning to black when the blue LED flashes. Therefore, the last pixel 388 in this subframe 392b has some blue in its yellow.

In the next frame, the next red subframe 394b, the liquid crystal 146 is relaxing, therein turning to clear. The last pixel had been previously driven black, therefore as it transitions to clear, the last pixel will once again lag behind the first pixel.

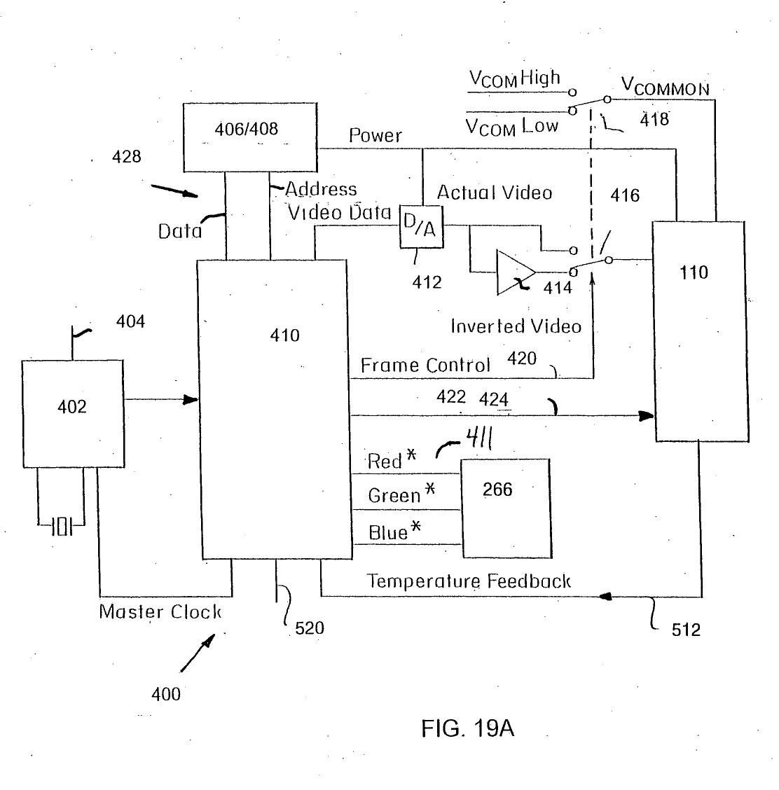

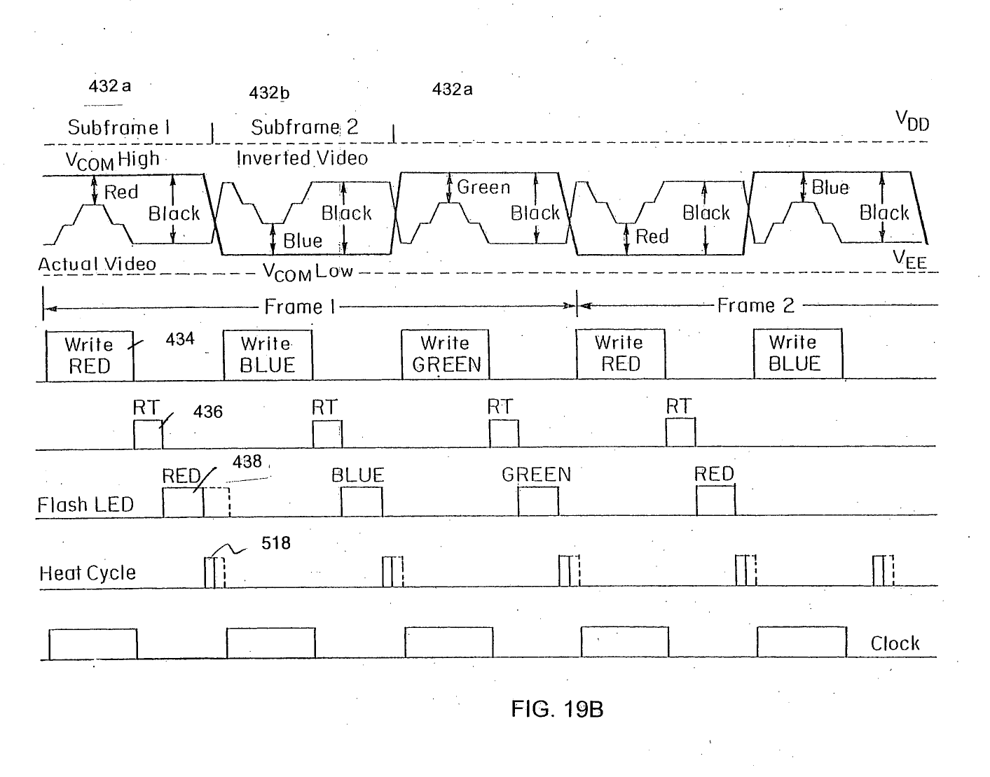

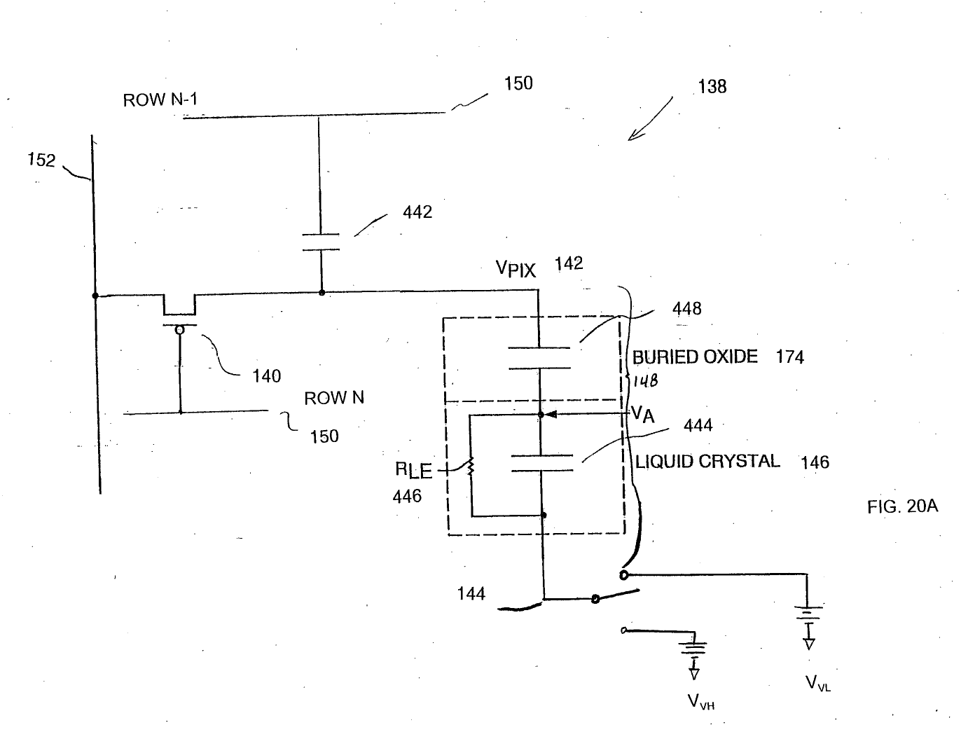

FIG. 19A illustrates a display control circuit 400 for practicing the LVV method. The digital control circuit 400 takes an image from a source and displays the image on the microdisplay 110. The digital control circuit 400 has a processor 402 which receives image data at an input 404. The processor 402 sends display data to a memory 406 and/or a flash memory 408 via a timing control circuit 410. The image data can be in a variety of forms including serial or parallel digital data, analog RGB data, composite data, or s-video. The processor 402 is configured for the type of image data received, as is well known in the art. In the preferred embodiment shown in FIG. 19A, the signal is digital or is converted to digital before entering the timing control circuit 410.

The timing control circuit 410 receives clock and digital control signals from the processor 402. The timing control circuit 410 controls both the microdisplay 110 and the backlight system 266. The timing control circuit 410 transmits control signals to the backlight 266 along a plurality of lines 411. The control signals from the timing control circuit 410 control the flashing of the LEDs 270 in relation to the image on the microdisplay 110. The timing, the duration and intensity of the flash of LEDs 270 is controlled.

The image data travels from the timing control circuit 410 to the microdisplay 110 through a digital-to-analog converter 412. The analog image data/signal is sent along two paths. One of the paths has the signal pass through an inverter 412. The analog video signal and the inverted analog video signal are alternatively fed to the microdisplay 10, with a switch 416 alternating the input on each subframe. In addition, the common voltage (VCOM) which enters the display 110 and applied to the counterelectrode 144 is alternated between the two values by a switch 418. The switches 416 and 418 for alternating the video and the V_{COM} to the display are controlled by a frame control line 420 from the timing control circuit 410.

The timing control circuit 410 transmits control signals, such as vertical start pulse, vertical clock, horizontal start pulse, and horizontal clock, to the display 110 along lines 422 and 424. Lines 428 direct ready, reset, write enable, output enable, color enable, address and data signals to memory 406/408 to control delivery of image frames to the display 110.

Referring to FIG. 19B in conjunction with FIG. 19A, the voltage of the counterelectrode 144, the common voltage (V_{COM}) alternates between two voltages. The video signal is alternating between actual video signal and inverted. In contrast to the column inversion in the previous embodiment where the video signal is inverted in every column, in LVV the video signal is inverted only every frame.

In a preferred embodiment, V_{COM} alternates between a video high voltage (V_{VH}) of 6 volts and a video low voltage (V_{VL}) of 1.5 volts. Therefore, V_{COM} alternates between a high voltage V_{VH}, referred to as V_{COM} HIGH and a low voltage V_{VL}, referred to as V_{COM} Low. The video signal voltage fluctuates between V_{VL} and V_{VH}. Both the supply voltage source (VDD) and the supply voltage sink (VEE) are off-set from V_{VH} and V_{VL} by 1.5 volts, ie. VDD is 7.5 volts and VEE is 0 volts. These offset or headroom increase pixel transistor conduction in the on state and decrease pixel transistor leakage in the off state.

With VC_{OM} high as in frame 432a, the actual video signal is scanned or written 434 into the matrix circuit/microdisplay 110. After a rest time or delay 436 to allow for the liquid crystal 146 to twist towards the desired position, a flash period 438 occurs where the LED backlight 266 flashes to present the images.

Prior to the next frame, subframe 2, 432b, V_{COM} goes low. With V_{COM} switching to the low voltage, the image that has just been scanned is erased because the voltage across the pixel changed. However, since the flash period 438 ended and the LED backlights 270 are not on, the loss of the image is not seen.

With V_{COM} low in frame 432b, the inverted video signal is scanned or written 434 into the matrix circuit/microdisplay 110. Similarly after the rest time 436, a flash period 438 occurs to present a refreshed or new image.

Prior to the next frame 432c, V_{COM} goes high. With V_{COM} switched to the high voltage, V_{COM} high, the image that was scanned in is erased. The actual video signal is written 434 into the microdisplay 110 with V_{COM} high. A delay occurs and the flash of the LED.

A schematic of pixel element 138 is shown in FIG. 20A. The pixel element 138 has the transistor (TFT) 140 through which the video is fed. The transistor (TFT) 140 is controlled by a signal from the vertical shift register 120.

There is a storage capacitor 442 which holds the charge and in a preferred embodiment connects to another row line 150, the previous row line (N-1). In addition, the liquid crystal 146 in proximity to the pixel electrode 142 acts as a capacitor 444 and a resistor 446. The buried oxide 174 interposed between the pixel electrode 142 and the liquid crystal 146 acts as a second capacitor 446. The counterelectrode 144 which has the common voltage V_{COM} switches back and forth as described above.

If the display is a color display, the LEDs 270 of the backlight 266 sequentially flash the distinct colors. In addition, three screen scans, one for each color LED 270, comprise a frame and the V_{COM} alternates each screen, sub frame.

The delay time before beginning the flash and the flash time are shown as identical in FIG. 19B. However, both the delay time (the delay for response time of the liquid crystal) and the flash time can depend on the specific color to be flashed. The delay time depends on when the liquid crystal associated with the last pixel to be written has sufficient time to twist to allow that specific color to be seen. The duration of the flash, or the point that the flash must be terminated, depends on when the liquid crystal associated with the first pixel to be written of the next frame has twisted sufficiently that light from the backlight is visible to the viewer.

The timing control circuit 410, as seen in FIG. 19A, can vary the flash duration and the delay or response time depending on the color that is to be flashed. In addition, the current to the backlights 266 can be varied to adjust the intensity of the color. If desired, a color control line 520 can be added to the timing control circuit 410 to allow the user to vary the color.

In a preferred embodiment, V_{COM} fluctuates every 5-6 milliseconds. It takes approximately 3 milliseconds to write/scan the image. The LED flashes for a time period of about 0.5 milliseconds. There is a waiting period between writing to the last pixel and the flash of about 1.5 milliseconds, such as represented in FIG. 19B. It is recognized that it may be desirable to vary the delay time before flashing the LED or vary the length of the LED flash depending on the color LED to be flashed.

Less time is needed to write with a smaller storage capacitor and therefore a smaller pixel TFT can be used. If the liquid crystal has a fast enough response, the storage capacitor can be eliminated and the capacitance of the liquid crystal becomes the storage capacitor. In addition, with no storage capacitor a larger aperture is possible. With a larger aperture and increased aperture ratio, the image will be brighter for the same cycling of the backlight or the total power used can be reduced with the same image brightness.

Referring to FIG. 20B, a portion of the display control circuit of FIG. 19A with an enlarged schematic of one pixel 138 is shown. The pixel 138 is charged by the horizontal shift register 124 selecting the column 152 by turning a transmission gate 262 and the vertical shift register 170 selecting a row 150. The video is written to the pixel and the liquid crystal begins to twist and become optically transmissive. After the entire display has been written and there has been a delay before the LED flashes, the V_{COM}, i.e., the voltage to the counterelectrode 144, is switched from high to low or vice versa by the frame control line 420. At the same time, the video signal is switched from actual video to inverted video or vice versa, so that the video will be switched for the next frame.

The liquid crystal can be twisted to become either optically transmissive or optically opaque. The orientation of the polarizers affect whether the liquid crystal is driven to white, transmissive, or to dark, opaque.

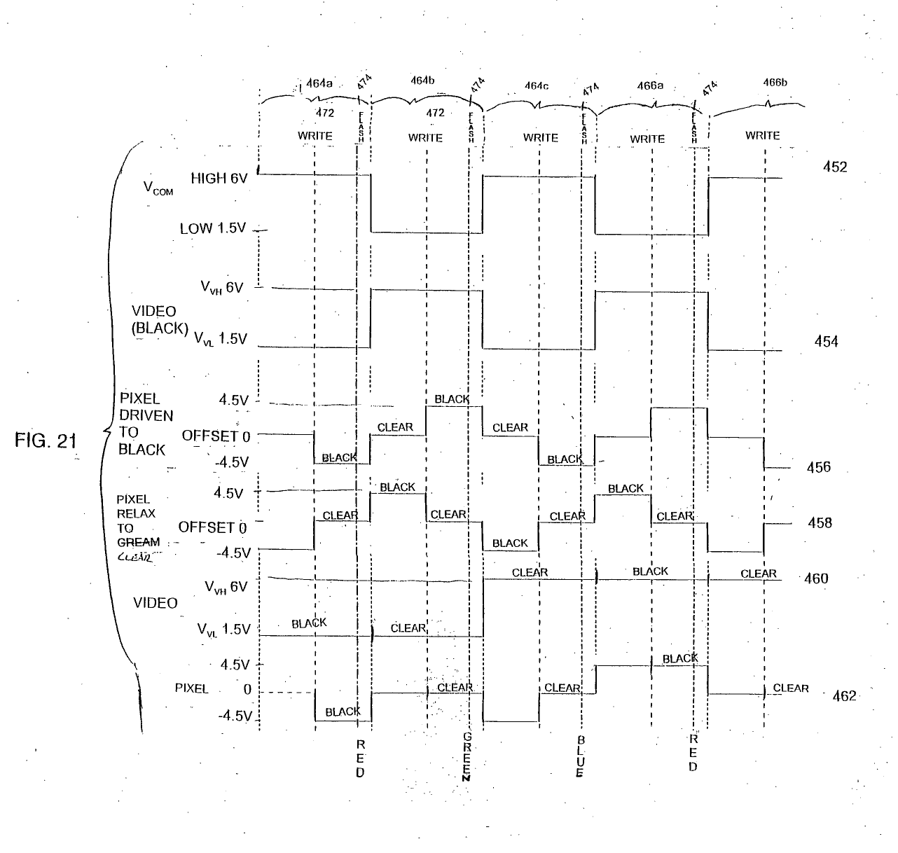

Referring to FIG. 21, the top graph 452 illustrates the switching of the voltage to the counterelectrode 144, V_{COM} every subframe. The voltage switches between 6 and 1.5 volts in a preferred embodiment. The resetting of the V_{COM} changes the reference voltage for the pixel 138.

The second line 454 illustrates the video signal that switches between a video and an inverted video signal. The video signal varies from a voltage representing clear to a voltage representing black. When V_{COM} is at the low voltage, 1.5 volts in a preferred embodiment, the voltage for clear would equal V_{COM}, 1.5 volts and the voltage for black in a preferred embodiment is 6 volts. This second line represents the video signal for black which is offset voltage of 4.5 volts from the voltage of V_{COM}.

The middle two lines 456 and 458 of FIG. 21 illustrate the voltage offset on a particular pixel element. The upper of the two lines 456 illustrates a pixel written to black and the lower line 458 illustrates the same pixel written to clear.

Referring the third line 456, the pixels start as clear, ie. the voltage offset between the pixel electrode and the counterelectrode is zero. When the proper column and row is selected for the pixel, the pixel electrode voltage is set at 4.5 volts offset from the V_{COM}, ie. 1.5 volts wherein VCOM is 6 volts in a preferred embodiment. The liquid crystal begins to be driven to the dark position. At a set period of time afterwards, the pixel has been written and the LED is flashed. When the V_{COM} is switched from 6 volts to 1.5 volts, as indicated in the first line 452, the offset of this pixel electrode goes from 4.5 to zero therein resulting in the liquid crystal relaxing back towards the clear direction. When the video signal is again written to the pixel to drive it black, the video signal is offset once again by 4.5 volts but in this case it is a video signal of 6 volts. The flash of LED occurs a set time period afterwards. When V_{COM} once again is flipped from 1.5 to 6 volts, the offset returns to zero between the pixel electrode and the counterelectrode and the liquid crystal begins to relax back towards clear. This pattern continues to repeat.

With respect to the fourth line 458 in FIG. 21, which illustrates the pixel written to clear, the pixel starts as black with the offset voltage between the V_{COM} and video being 4.5. When the pixel electrode is written to clear, the offset voltage between the V_{COM} and the pixel electrode becomes zero and the liquid crystal begins to rotate towards a clear position. At a set period afterwards, the LED flashes. When the voltage of the counterelectrode is switched from 6 volts to 1.5 volts the offset between the pixel electrode and the counterelectrode goes from zero to 4.5 volts and the liquid crystal begins to be driven black. When the pixel electrode is next written, the voltage to the pixel electrode is set to 1.5 volts which is equivalent to the counterelectrode voltage and an offset voltage of zero therein the liquid crystal begins to relax back to a clear state. The LED is flashed a set time afterwards. When the voltage of the counterelectrode is next switched from 1.5 volt to 6 volts, the offset of the voltage between the pixel electrode and the counterelectrode becomes 4.5 volts again and the liquid crystal associated with this pixel electrode is driven towards black. When the video signal for this pixel electrode is written to white the voltage is set to 6 volts and the voltage offset between the pixel electrode and the counterelectrode is zero volts and the liquid crystal begins to relax back to the clear position. This pattern continues to repeat.

The fifth line 460 in FIG. 21 represents a video signal for the pixel. For simplicity and clarity, the video signal is shown constant for the entire frame even though the video signal only at the time period associated with that pixel is relevant. The first subframe 464a, the video signal is to drive the liquid crystal black therein the voltage of the signal is 4.5 offset from V_{COM} or 1.5 volts. In the next subframe 464b, the signal to be written is for clear therein the voltage is set to the voltage of V_{COM} the voltage remains at 1.5 volts since the voltage V_{COM} is once again 1.5 in that V_{COM} has switched to 1.5 volts. The third subframe 464c the video is once again set for clear, however, in that V_{COM} has switched from 1.5 volts to 6 volts, the video signal likewise is flipped or inverted from 1.5 to 6 volts so that the offset is maintained at zero. In the fourth subframe 464d shown, the video signal is written such that the pixel will turn back to black therein the video needs to be offset by 4.5 volts in a preferred embodiment from that of V_{COM} and V_{COM} in this subframe is 1.5 volts and the video is set to 6 volts.

The sixth and bottom line 462 shows the video of the pixel using the video from the above line 460 written at the proper location indicated by the dashed vertical lines 472. The video pixel is initially offset from that of the counterelectrode by zero volts until the pixel electrode is written to black therein putting an offset of 4.5 volts. The liquid crystal associated with the pixel 138 is driven, twisted to black. The flash is indicated by the dashed vertical line 474 however, in that the pixel electrode has been driven so that the liquid crystal has rotated to black therein the red flash is not seen. Upon the counterelectrode switching from 6 volts to 1.5 volts, the pixel begins to relax to clear since the voltage offset between the counterelectrode and Vpixel is zero. Upon the pixel electrode being written, it is written to clear however, the voltage has already had a zero offset so there is no change. When the flash occurs for subframe 464b in that the liquid crystal has rotated to a clear position, the green flash is seen at the pixel.

Upon the counterelectrode switching to 6 volts from 1.5 volts at the beginning of subframe 464c, the offset between the voltage of the pixel electrode and the counterelectrode is 4.5 volts therein the liquid crystal begins to be driven to the black state. When the pixel electrode is written to clear (white) the voltage of the pixel electrode is set to 6 volts wherein the offset from the voltage and the counterlectrode is zero and the liquid crystal begins to relax back to clear. When the flash occurs the liquid crystal has been moving towards the clear state and the blue LED light is seen.

Upon the counterelectrode being switched from 6 volts back to 1.5 volts at the start of the next subframe 466a, the offset between the counterelectrode and the pixel electrode is 4.5 volts and the liquid crystal begins to be driven black. When the pixel electrode is written to again, to the black state, the voltage of the pixel electrode does not change therein when the flash occurs the liquid crystal blocks the light and the red LED is not seen therein the green and blue lights are seen to give a cyan color.

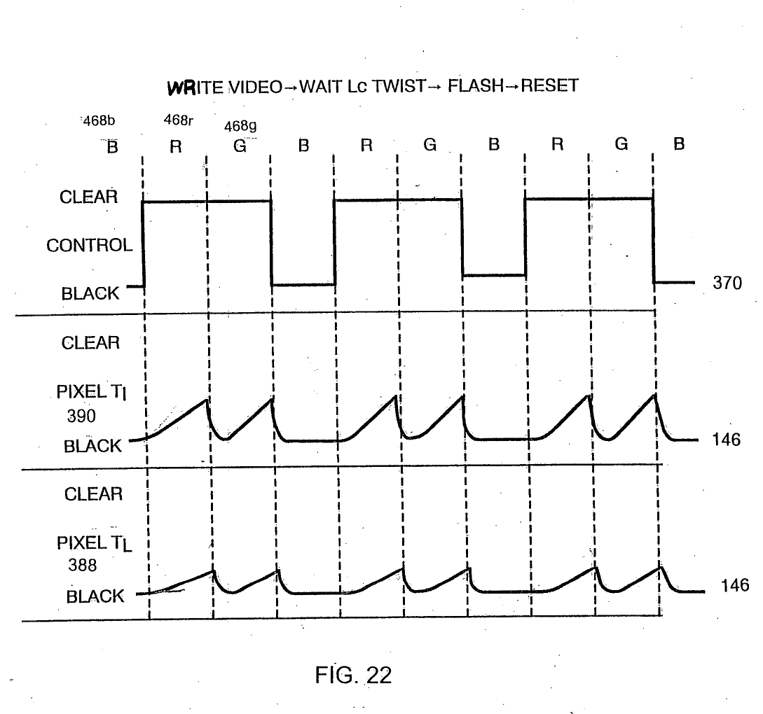

FIG. 22 illustrates the creation of a yellow pixel for the first pixel and the last pixel, similar to what is shown in FIG. 18B, with the voltage of the counterelectrode 144 V_{COM} switching after each subframe. While generally referring to a frame as a red, green and blue subframe, the first color flash and order is merely a preference. The video for the pixel is set to drive the pixel black for the blue subframe 468b and allow it to relax for the red 468r and the green subframes, as represented by the square wave. In the first subframe in FIG. 22, the blue subframe 468b, the liquid crystal for both the first pixel and the last pixel are shown at a steady state black. The first pixel 390 receives its signal at the beginning of the red subframe and the liquid crystal begins to relax. The last pixel 384 receives its signal at some time later, 3 milliseconds in a preferred embodiment, and the liquid crystal begins to relax at that time. The liquid crystal related to the first pixel and the last pixel are at different points in the transition to clear when the red LED flashes, therein producing different levels of red as in FIG. 18B. However, in contrast to the previous embodiment, the switching of the voltage to the counterelectrode resets the clear pixels to black. This is represented by the downward slope between the red subframe 468r and the green subframe 468g.

The next color to flash is green. The first pixel receives its signal at the beginning of the green subframe 468g and the liquid crystal begins to relax. The last pixel receives its signal at some time later, 3 milliseconds in a preferred embodiment, and the liquid crystal begins to relax at that time. When the LED for green flashes, the liquid crystal for the two pixels are in different points of transition to clear, therefore there is a different level of green. However, in contrast to the previous embodiment, the liquid crystal does not have more time to transition prior to the flash of the green LED compared to the red LED, since the voltage to the counterelectrode is switched every frame. The color is thus more uniform in that both the first pixel and the last pixel have the same ratio of red to green.

Still referring to FIG. 22, the next subframe is the blue subframe 468b. The pixels are driven black by the switching of the voltage to the counterelectrode V_{COM}, as represented by the slope between the green subframe 468_{g} and the blue subframe 468b. In contrast to the previous embodiment, both the first pixel 390 and the last pixel 388 are driven black at the same time by the switching of the voltage to the counterelectrode. When the individual pixel is written to, the pixel is written to black so there is no change. The last pixel 388 is therefore not still transitioning when the blue LED is flashed. With the switching of the voltage to the counterelectrode V_{COM}, while there are still variations of luminosity from the top to the bottom, there is now uniform color.

In an alternative embodiment, the storage capacitor 422 for each pixel element 138 is connected to the black matrix 190 instead of the previous row line 150 for a new LVV display. With the storage capacitor 422 connected to the black matrix 190, the microdisplay 110 can progress from the top to the bottom or from the bottom to the top. In that the video data is stored digitally, the video can be scanned alternatively from the top to the bottom and then scanned from the bottom to the top to average out the time between writing and the flashing for the total image.

To achieve good color purity, the liquid crystal must complete its transition to the proper state prior to or during a settling phase 476, which is illustrated in FIG. 23A. Otherwise, the liquid crystal state is effected by the position, state, of liquid crystal in the previous subframe (e.g. the green flash will depend on its state during the red field). This “color shift” effect appears at the bottom of the display first, since those pixels are the last to be updated during the Write phase 472.

As indicated above, LVV (low voltage video) is a combination of the switching of the voltage of the counterlectrode 144 and the initialization. Initialization is discussed below.

Initialization occurs prior to the writing of the image to the display. An initialization phase (Init) 478 is shown in FIG. 23A just before the write phase 472. The initialization phase 478 takes advantage of the fact that the black-to-white and white-to-black liquid crystal transition times are different in the preferred embodiment. In a preferred embodiment in which the black-to-white transition is slower, all pixels are initialized to the white state at the beginning of the field by setting the voltage to the pixels V_{PIXEL} to the same voltage as the counterelectrode, V_{COM}, as referred to as initialization, after flashing the backlight.

In one preferred embodiment, the odd rows are first set to V_{COM} with the even rows subsequently set to V_{COM}. With the pixel electrodes set to V_{COM}, the liquid crystal begins to relax to the clear state, if the liquid crystal associated with the pixel is in some other state. This gives those pixels which will be written to clear (white) pixel a head start, so that the Settle phase 476 need be only as long as the faster clear (white)-to-black transition. (It is recognized that the optimal initialization state will depend on such particulars as liquid crystal chemistry, alignment, and cell assembly, and that initialization to black, clear, or intermediate gray levels might be preferred for a given display).

Once the voltage to the pixel electrodes V_{PIXEL} has been reset to V_{COM} in the initialization phase 478, the writing phase 472 begins and the first pixel receives its signal and begins to transition. Each pixel receives its signal until the last pixel receives its signal. The liquid crystal associated with each pixel is relaxing, rotating to the clear state, until that specific pixel receives the signal. The first pixels will have the majority of the writing period to get to their desired position and the initializing of the pixel to V_{COM} will have minimal effect. However, the pixels which receive their signal last will be clear or near clear prior to receiving their signal. As indicated above it takes less time to drive black than relax white (clear). Therefore, with the end pixels being clear, the response time is quicker driving to black than if the pixels were black and needed to relax to clear.

The drive electronics quickly update all pixels in the array. First, the data scanners drive all column lines to the appropriate initialization voltage. An initialization switch 482 is associated with each column. FIG. 23B shows switches implemented with p-channel MOS transistors; it is recognized that n-channel transistors, complementary MOS pairs, or other configurations could be used. Second, the select scanners 484 select multiple rows simultaneously as described in relation to the power down reset circuitry. The control logic is modified to support the initialization operation. In power down reset the columns are all set to V_{DD} in contrast to the initial voltage as in the initialization phase 478.

A preferred method according to the invention which we refer to as low voltage video (LVV) improves the image by overcoming several of the image quality problems discussed above. An integrated circuit display die 258 for a LVV display is shown in FIG. 11.

It is recognized that the switching of the voltage to the counterelectrode V_{COM} or initializing can be done individually or in combination. However, in LVV (low voltage video) both the switching of the voltage to the counterelectrode and the initializing are done. The combination allows for lower voltages and takes advantage of the fact that the response time driving white to black is quicker than the response time driving black to white.

FIG. 23C illustrates a LVV microdisplay with both the switching of the voltage to the counterelectrode and the initializing of the pixels to clear. In contrast to FIG. 21 and similarl to FIG. 22, a first and last pixel are discussed. The top two graphs 462 and 454 are similar to the top two graphs of FIG. 21.

The top graph 452 illustrates the switching of the voltage to the counterelectrode 144, V_{COM} every subframe. The voltage switches between 6 and 1.5 volts in a preferred embodiment. The second line 454 illustrates the video signal which switches between a video and an inverted video signal. The video signal varies from a voltage representing clear to a voltage representing black. This second line 454 represents the video signal for black, which is an offset in voltage of 4.5 volts from the voltage of V_{COM}.

The third line 460 of FIG. 23C, similar to the fifth line in FIG. 21, represents a video signal for the pixels. For simplicity and clarity, the video signal is shown constant for the entire frame even though only at the time period associated with the pixels is relevant.

In addition, while the video signal is shown at either totally black or totally clear, it is recognized that the video signal can be at a level in between. For example, if the voltage of the video signal is 4 volts using the preferred embodiment voltages, the video is some gradient between clear and black, resulting in a gradient or grey scale.

In the first subframe 486r of the third line 460, the video signal is at a level to drive the liquid crystal black therein the voltage of the signal is 4.5 volts offset from V_{COM} or 1.5 volts. In the next subframe 486g, the signal to be written is for clear, therein the voltage is set to the voltage of V_{COM}; the voltage is once again 1.5 volts in that V_{COM} has switched to 1.5 volts. The third subframe 486b, the video is once again set for clear, however, in that V_{COM} has switched from 1.5 volts to 6 volts, the video signal likewise is flipped or inverted from 1.5 to 6 volts so that the offset is maintained at zero. In the fourth subframe 488r shown, the video signal is written such that the pixel will turn back to black therein the video needs to be offset by 4.5 volts in a preferred embodiment from that of V_{COM}; V_{COM} in this subframe is 1.5 volts and the video is set to 6 volts.

The fourth line 490 and the fifth line 492 show the video of the pixel using the video from the third line 460 written to the pixel at the respective time. The fourth line 490 illustrates the writing to the first pixel 390 that is written to in the microdisplay 110. The fifth line 492 illustrates the writing to the last pixel 388 that is written to in the microdisplay 110.

Both pixels are written to black, therein putting an offset of 4.5 volts. The pixel T_{L} 388 is written at a set time after T₁. In a preferred embodiment, the delay between the writing to the first pixel 390 and to the last pixel 388 is 4.2 milliseconds, during which all the interposed pixels are written.

The sixth line 494 and the seventh line 496 illustrate the position of the liquid crystal associated with the first pixel element (T₁) 490 and last pixel element (T_{L}) 492 respectively. The flash is indicated by the dash line. However, in that the pixel electrode has been driven so that the liquid crystal has rotated to black as seen in the sixth and seventh lines 494 and 496, the red flash is not seen.

Referring to the fourth and fifth lines 490 and 492, upon the counterelectrode switching from 6 volts to 1.5 volts entering subframe 486g, the voltage offset between the counterelectrode and Vpixel is zero and the liquid crystal begins to relax to clear, as seen in the sixth and the seventh lines 494 and 496.

In that the switching of the voltage to the counterelectrode sets the pixel electrodes to a voltage representing clear, the initialization does change the pixel electrode or the transitioning of the liquid crystal. Upon the pixel electrode being written, it is written to clear however similar to the effect of the initialization, since the voltage has already had a zero offset, there is no change. When the flash 474 occurs, in that the liquid crystal has rotated to a clear position as illustrated in lines six and seven 494 and 496, the green flash is seen at the pixels.

In the next subframe 486b, upon the counterelectrode switching to 6 volts from 1.5 volts as illustrated in the first line 452 of FIG. 23C, the offset between the voltage of the pixel electrode and the counterelectrode is 4.5 volts therein the liquid crystal begins to be driven to the black state as illustrated in the downward line in both the fourth line 490 and the fifth line 492. The liquid crystal begins to rotate towards black as seen in lines 494 and 496. However, shortly after the switching of the voltage to the counterelectrode all the pixels are initialized to the clear position/voltage as illustrated by the upward line in both the fourth line and fifth line. The liquid crystal beings to relax to clear state as illustrated in the sixth line and the seventh line 494 and 496. The initializing occurs less than 100 microseconds after the switching the voltage counterelectrode in a preferred embodiment.

Upon the two pixel electrodes being written, the pixels are written to clear; however, in that the voltage is already a zero offset, there is no change to the voltage to the pixel electrode. The liquid crystal continues to relax to the clear position as illustrated in the sixth line 494 for pixel T₁ or remains in the proper position as when the last pixel 388 would be written as illustrated in the fifth line 492 and the seventh line 494. When the flash occurs, the liquid crystal for both pixel T₁ and T_{L}, as illustrated by the sixth line 494 and the seventh line 496 of FIG. 23C, have settled in the clear state and the light of the blue LED light is seen.

In the next subframe 488r, upon the counterelectrode being switched from 6 volts back to 1.5 volts, the offset between the counterelectrode and the pixel electrode is 4.5 volts as illustrated by the downward line in the fourth line 490 and the fifth line 492 and the liquid crystal begins to be driven towards the black state as illustrated by the downward sloping line in the sixth and seventh lines 494 and 496.

However, shortly after switching the voltage to the counterelectrodes, all the pixels are initialized to the clear position/voltage as illustrated by the downward line in both the fourth line and the fifth line 490 and 492. The liquid crystal begins to relax to the clear state as illustrated in the sixth line and the seventh line 494 and 496.

The liquid crystal of the first pixel T₁ does not get back to the completely clear position prior to the pixel being written 498 as seen in the sixth line 494 of FIG. 23C. The writing to the pixel, T₁ sets the pixel electrode to a 4.5 volt offset over the counterelectrode voltage of 1.5 volts as seen in the fourth line and the first line respectively. The setting of the pixel electrode to a voltage representing black results in the liquid crystal being rotated to black.

The liquid crystal of the last pixel T_{L} returns to the completely clear position prior to the pixel being written 500 as illustrated in the seventh line 496. The writing to the pixel T_{L} in subframe 488r, as illustrated in the fifth line 492 to black, results in the liquid crystal being rotated to black. In that the liquid crystal can be driven quickly to black in contrast to relaxing to clear, the liquid crystal associated with the last pixel 288, pixel T_{L} along with first pixel 290 T₁, is in proper position prior to the flash of the red LED. However, in that the liquid crystal has rotated to black, the red flash is not seen.

The process is continued. In contrast to the previous embodiment, in that each pixel electrode has been set to an offset of zero which results in the liquid crystal rotating towards clear, the liquid crystal is either clear or moving towards clear when the image is written to the pixel. In that the liquid crystal can be driven from clear to black in the setting time between the writing of the last pixel T_{L} and the flash, the liquid crystal is either at or in close proximity the desired state when the flash occurs. This results in the color being more uniform and the contrast and brightness improved over the previous embodiments.

In LVV, the switching of the voltage to the counterelectrode allows for a reduced voltage range. The initialization allows the liquid crystal associated with each pixel to relax, rotate to the clear state, until that pixel receives the signal. The first pixels will have the majority of the writing period to get to their desired position and the initializing of the pixel to V_{COM} will have minimum affect. However, the pixels which receive their signal last will be clear or nearly clear prior to receiving their signal. As indicated above, it takes less time to drive black than relax clear (white) in the embodiment discussed. Therefore, with the end pixels being clear, the response time is quicker driving to black than if the pixels were black and relaxing to clear. (It is recognized that the optimal initialization state will depend on such particulars as liquid crystal chemistry, alignment, and cell assembly, and that initialization to black, white, or gray levels might be preferred for a given display).

In a preferred embodiment, the writing of each subframe takes 4.2 milliseconds. The settle, flash, LVV of switching the voltage to the counterelectrode and initialization combines for 1.3 milliseconds. The settle time in a preferred embodiment is approximately 1.0 milliseconds before the beginning of the flash. While the flash can extend into the beginning of the writing of the next subframe, in that LVV affects the pixel by beginning to turn the liquid crystal, the end of the flash may need to be based on the beginning of LVV. However, the use of LVV results in a shorter settling time requirement.

In another embodiment associated with the die of FIG. 11, the writing of each subframe takes 1.64 milliseconds. The settle, flash, LVV of switching the voltage to the counterelectrode and initialization combines for 3.92 milliseconds. The settle time ina preferred embodiment is approximately 3.12 milliseconds before the beginning of the flash.

Referring to FIG. 24, in normal operation the voltage of the pixel is fluctuating. The voltage at the point (V_{A}), as seen in FIG. 20A, between the buried oxide and the liquid crystal generally follows the pixel voltage, but is lower because of the drop across the buried oxide and drops because of the resistance of the liquid crystal (R_{LC}). When powering off, V_{DD} drops to zero. The pixel voltage (V_{PIX}) is unable to discharge through the p-channel pixel TFT and drops. V_{A} which is coupled to V_{PIX} drops likewise. If a sufficient time transpires, V_{A} will return to zero due to the R_{LC}.

However, if the power is turned back on to the display prior to the natural discharge time, a portion of the image may be seen for several seconds. V_{PIX} goes positive when the power comes on and since V_{A} is coupled it goes positive above and creates a black image. V_{A} returns to normal in several minutes due to R_{LC}. The reason the image may be retained even with switching the voltage to the counterelectrode and the initialization relates to the inherent capacitance of the buried oxide. The buried oxide does not have an associated inherent resistance and the voltage shift by pixel causes a DC build-up. This DC build-up will eventually decrease due to R_{LC}.

A display circuit is illustrated in FIG. 25. In this embodiment, a digital circuit 506 is used to control color sequential display operation. The processor 402 receives serial digital image data at 404 and sends display data to memory 406 via the timing control circuit 410. The timing control circuit 410 receives clock and digital control signals from the processor 402 and transmits control signals to the backlight 266 and display 110 along lines 411 and 422, respectively. Lines 428 direct ready, reset, write enable, output enable, color enable, address and data signals to memory to control delivery of image frames to the display 110.

An analog comparator 508 samples the voltage of the main power in real time. When the voltage drops below the level to run the circuit plus some margin which is set by a reference 510, a reset signal (PDR*) is asserted low. On receipt of the PDR* signal the display circuitry will place V_{DD} on all the column lines, see FIG. 2, and activate all the row lines. The normal timing continues for two or more cycles, therein sequentially activating all the even and odd rows. This clocks the V_{DD} signal on the column lines into every pixel.

Referring back to FIG. 20A, V_{DD} will also charge the pixel storage capacitor 442. As indicated above, in a preferred embodiment, the storage capacitor 442 is connected to the previous row line 150. By activating all the even row lines, (i.e., driving them low) and not the odd row lines (i.e., maintaining high), the storage capacitors 442 on the even rows will be discharged to 0 volts. (V_{DD} is high logic level). On the next cycle the odd rows storage capacitors will be discharged. Because the storage capacitor is several times larger than the pixel capacitor, the voltage on the storage capacitor will then discharge the pixel capacitor to 0 volts. At this point the display can be de-energized without any residual charge left on either the storage or pixel capacitor.

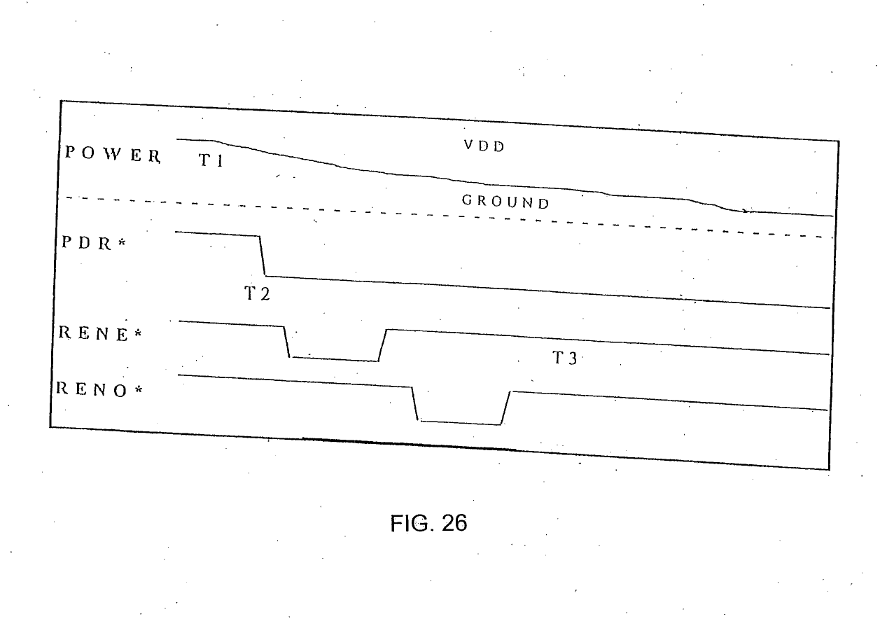

FIG. 26 illustrates a timing diagram. The system power is turned off at time T1 and is shown as a classical discharge as the logic continues to run powered by the bypass capacitors. The comparator senses the threshold voltage level and asserts the PDR* low, at time T2. The additional row enable signals are then asserted and completed at time T3. No additional logic or signals are required after T3 and the power is allowed to randomly discharge. The power down reset works with the modes discussed above including column inversion and the switching of the voltage to the counterelectrode V_{COM}.

As indicated above, the temperature of the display and in particular the temperature of the liquid crystal effects the response and the characteristics of the display.

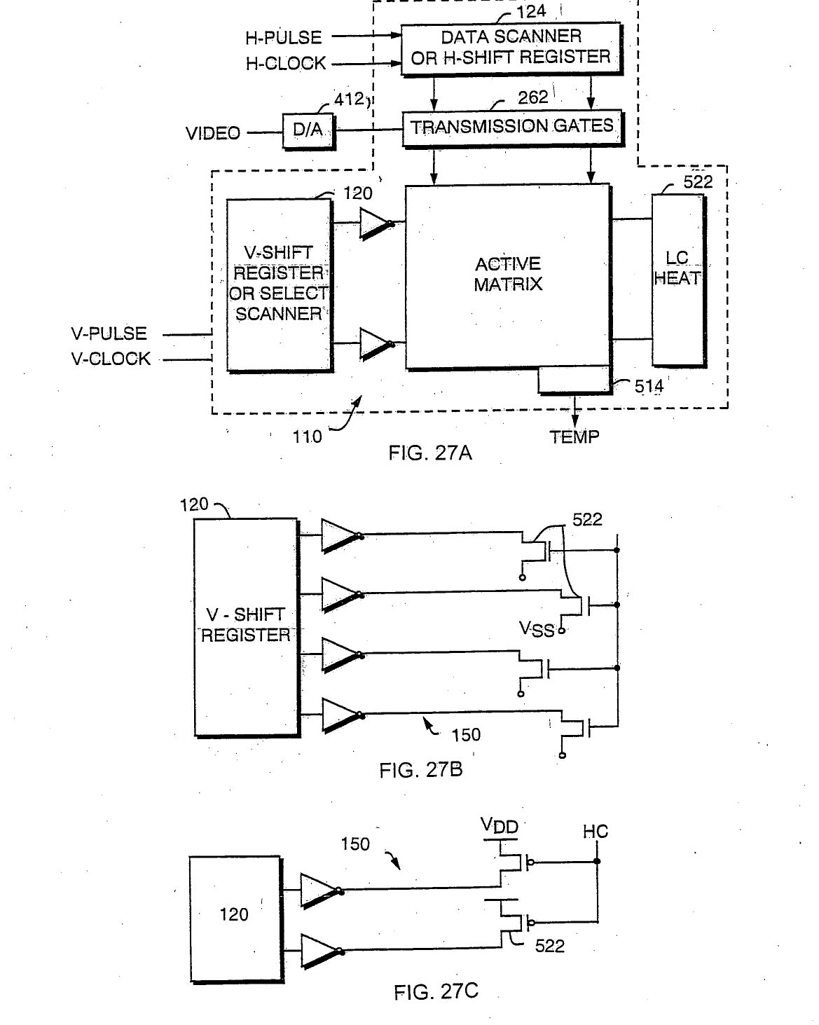

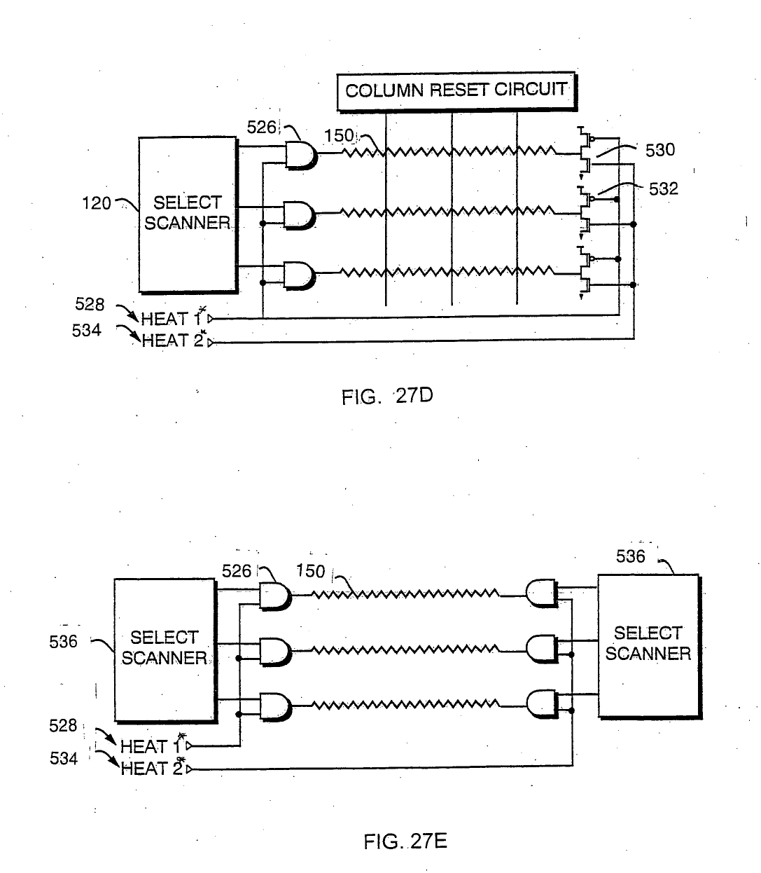

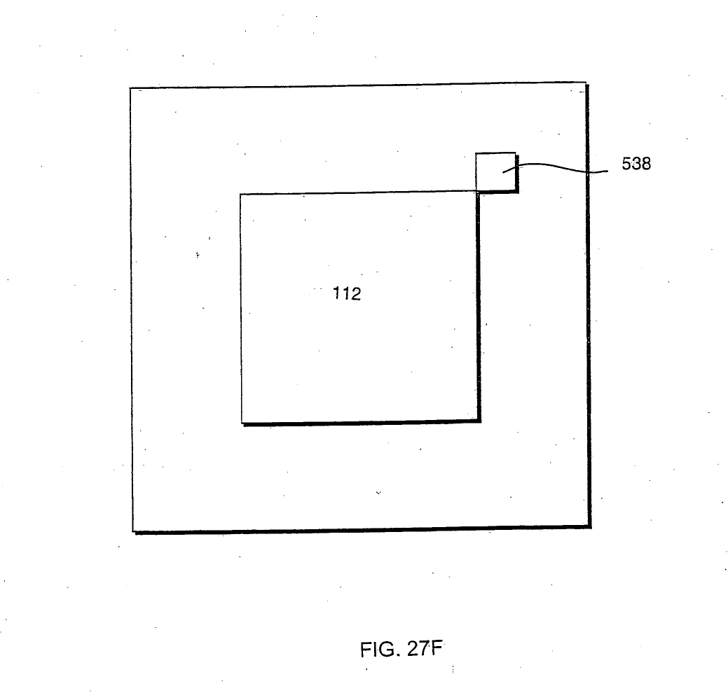

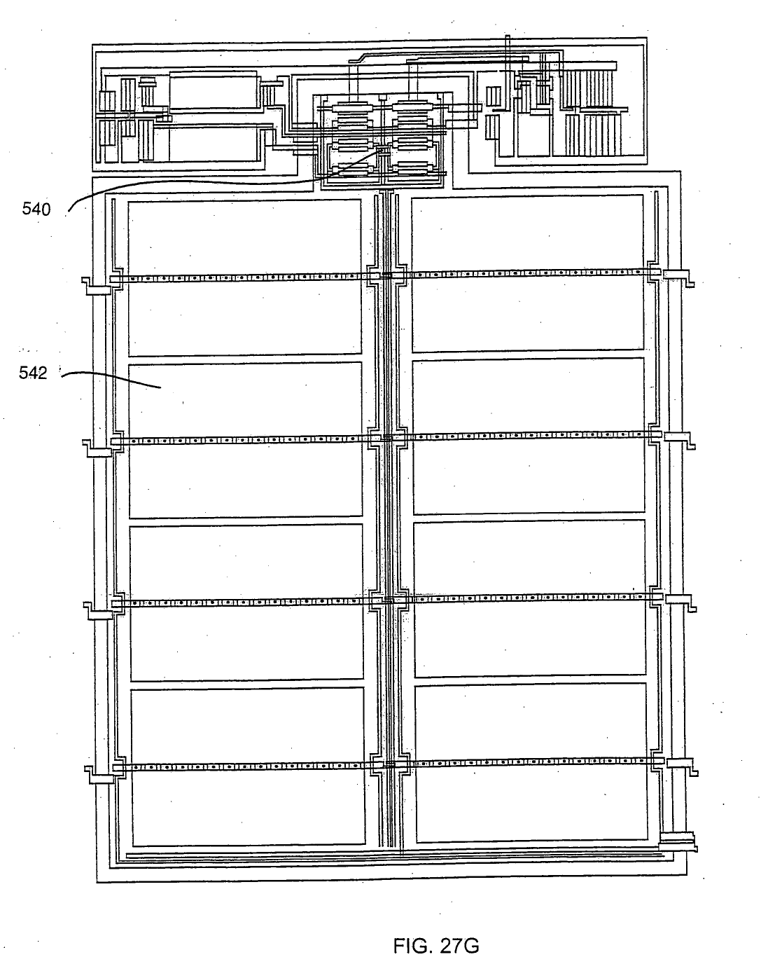

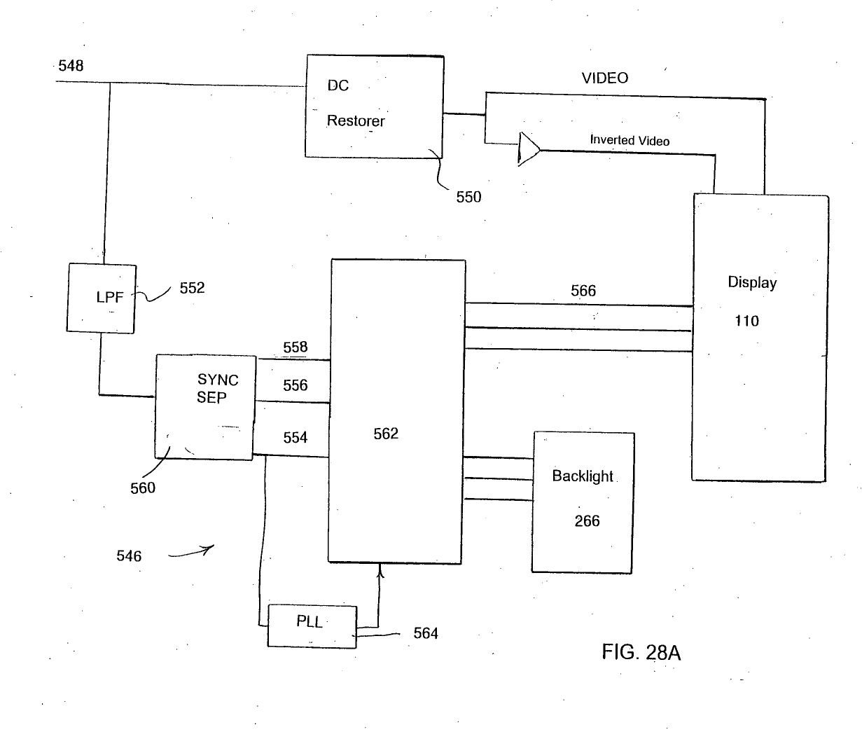

Referring back to FIG. 19A, the display circuit has an additional line, a temperature sensor line 512, which runs from the display 110 to the timing control circuit 410. The active matrix comprises a plurality of pixels arranged in columns and rows. Heat is preferably absorbed substantially uniformly throughout the liquid crystal material. However, there may be local temperature variations due to the nature of the image being displayed as well as display and heater geometry and environmental conditions. Temperature sensors can be distributed throughout the active matrix region including around the perimeter of the active matrix including the corners and also disposed near the center of the active matrix. The use of a temperature sensor is described in U.S. patent application Ser. No. 08/364,070 filed Dec. 27, 1994 and is incorporated herein by reference. A temperature sensor 514 is illustrated in the corner of the display in FIG. 27A. As indicated above, temperature sensors can be distributed throughout the active matrix region.

The characteristics of the liquid crystal material are effected by the temperature of the liquid crystal. One such example is the twist time of twisted-nematic liquid crystal material, which is shorter when the liquid crystal material is warm. By knowing the temperature of the liquid crystal, the timing control circuit 410 can set the duration and timing of the flash of the backlight 260, therein achieving the desired brightness and minimizing power consumption.

Referring back to FIG. 20B, during normal operations, the vertical shift register 120 has only one row on, so that as the horizontal shift register 124 moves from column to column only one pixel is affected. After the last pixel on a row is addressed, the vertical shift register 120 switches the active row. The display 110 can be placed in a heat mode where each row 150 is turned on and has a voltage drop across the row to create heat. In the embodiment shown in FIG. 20B, an end 516 of each row line is connected to V_{DD} and the end near the shift register is driven low thereby creating a voltage differential across each line. Heat is generated at a rate P=V²/R, where R is the resistance of the parallel combination of row lines and V the voltage differential across the row lines. In normal operation, only the selected line which contains pixels to be driven low generates heat, not the entire display.

Referring back to FIG. 19B, with the common voltage (V_{COM}) high, the actual video signal is scanned into the matrix circuit. After a delay to allow for the liquid crystal to twist into position, the LED backlight 266 is flashed to present the image. Prior to the next screen or subframe, a heat cycle 518 occurs where all the row lines are driven such that there is a voltage differential across the row. The heating can occur while V_{COM} and the video are being alternated and inverted, respectively, by the frame control line 420, as seen in FIG. 19A. FIG. 19B shows a heating cycle 518 after each subframe, but the number and time period of heat cycles can depend on the temperature of the liquid crystal as determined by the temperature sensor 514. In cold environments, the digital circuit can have a warm-up cycle where the heater is turned on prior to the first painting of the screen.

Referring to FIG. 27A, a schematic of the display 110 and the digital to analog converter 412 are shown. The display has a horizontal shift register 124, a vertical shift register 120, and switches 262 similar to what is illustrated in FIG. 20B. In addition, and in contrast to FIG. 20B, FIG. 27A illustrates a heating gate 522.

Referring to FIG. 27B, for pixels which have p-channel TFTs, the heating gate 522 has a series of n-channel TFTs. Typically when writing to the display only the row being written to is on (V=0). When not writing to the display, all the rows are V_{DD}. When the n-channel TFTs turned on, by applying V_{DD} to a row line 150 results in current flowing from the inverter associated with the vertical shift register 170 through the row to the n-channel TFT and heat is dissipated along the entire row. The source is connected to V_{SS}, which is zero. It is also recognized that the display 110 can have several extra rows outside the typical array to assist in uniform heating.

Likewise for pixels which have n-channel TFTs, referring to FIG. 27C the heating gate 522 has a series of p-channel TFTs. Typically when writing to the display only the row being written to is on (V=V_{DD}). When not writing to the display, all the rows are approximately zero (0) volts. When the p-channel TFTs are turned on by setting the gate to zero (0), there is a voltage drop across the row of V_{DD}.

It is recognized that LVV (low voltage video) including the switching of the voltage to the counterelectrode V_{COM} and the heating of the display discussed above can be used independently. Heating can be incorporated into the embodiments described with respect to FIG. 2. While an internal heater is preferred, it is recognized that a separate heater can be used with the temperature sensor.

In the embodiments shown in FIGS. 27B and 27C, a DC voltage drop ΔV develops across the display as current flows through the row lines 150 to create the heat. Depending on the length and frequency of the heating cycles, a DC field can be created that affects the performance of the Liquid Crystal. An alternative embodiment shown in FIG. 27D alternates the direction of current flow in the row lines 150 to reduce or eliminate a DC field.

Still referring to FIG. 27D, the display has two-input AND gates 526 between the select scanner 120, also referred to as a vertical shift register, and the row lines 150, with one of the inputs of the AND the input from the select scanner 120. The other input is a heat signal, HEAT1*, 528. The other side of each row line 150 is connected to the drains of two transistors, a n-channel TFT 530 and a p-channel TFT 532. The gate of each of the p-channel TFTs is connected to the HEAT1* 528. The gate of each of the n-channel TFTs is connected to a second heat signal, HEAT2, 534.

The two heat signals HEAT1* and HEAT2* are held HIGH and LOW, respectively during normal display operation. When HEAT1* is asserted (LOW), the select scanner side of each row line 150 is driven low while the right side is pulled high. The current flow, from right-to-left, as seen in this figure, in this situation. Alternatively, HEAT2 is asserted (HIGH)and the right side is pulled down and the current flows left-to-right. The alternating of HEAT1* and HEAT2 heating cycles helps equalize the DC component of any electric fields to which the liquid crystal may be exposed.

For the above embodiments, the other lines that extend across the active area, the column lines, are not driven to a set voltage. In an alternative embodiment, a column reset circuit 154 drives all columns to a known voltage during the heat cycle to improve image uniformity. It is recognized that the column lines or additional added lines can also be used for heat.

Referring to FIG. 27E, most larger displays use a pair of two select scanners 536, on opposite sides of the array to drive the video signal to the pixel elements. A more detailed explanation of two select scanners is described in U.S. patent application Ser. No. 08/942,272, which was filed on Sep. 30, 1997, the entire contents of the which is incorporated herein by reference.

The display with the pair of select scanners 536 has two input AND gates 526 at each end of each row line 150. The HEAT1* 528 is connected to an input of the AND gate 526 on one side of the display and the HEAT2* 534 is connected to an input of the AND gate on the other side of the display.

An alternative embodiment to having the AND gates is to incorporate equivalent logic within the select scanner.

The measuring of the temperature of the liquid crystal requires additional analog circuitry which adds complexity to the circuit of the display. It is recognized that it is the operational characteristics of the liquid crystal, not the actual temperature, that is ultimately desired. Therefore, the capacitance of the liquid crystal, an electrical measurement of the liquid crystal capacitance is performed instead of the measurement of temperature in order to determine when heating is required. Thus the heater can be actuated in response to a liquid crystal sensor that responds to the optical or electrical properties of the liquid crystal.

FIG. 27F illustrates a liquid crystal response time sensor 538 located just off the active matrix display 112 that is seen by the user. The liquid crystal response time sensor has a plurality of dummy pixels 540, eight pixels in a preferred embodiment seen in FIG. 27G, and a sense amplifier 542. The dummy pixels need not be the same size as those in the active area. In a preferred embodiment, the dummy pixels are created large enough to dominate parasitic capacitance effects, within area constraints of the microdisplay.

The eight pixels are divided into two sets of four dummy pixels. The voltages of the pixels are driven to V_{HB} (high black), V_{W} (white) and V_{LB} (low black). In a preferred embodiment, in one set, two pixels are driven to V_{HB} and one pixel to V_{LB} and the other pixel is set to V_{W}. In the other set, two pixels are driven to V_{LB}, and one pixel to V_{HB} and the other pixel is set to V_{W}. The liquid crystal is given a time period much longer than the anticipated response time, to allow the capacitance of the liquid crystal to settle. In a preferred embodiment, the time period can be in excess of 5 milliseconds.

When the capacitance is set, the two identical voltage dummy pixels of each set are set to V_{W}. Therefore in the first set, the two pixels with V_{HB} are set to V_{W} and in the other set, the two pixels with V_{LB} are set to V_{W}. The pixels are held at this voltage for a specific time, the response period time to be checked. In a preferred embodiment, the time period can be in a range between 1 to 3 milliseconds.

After the time period, those pixels that were just set to V_{W} are set back to the previous setting. Therefore, in the first set, the two pixel voltages are set to V_{HB} and in the second set, the two pixels voltages are set to V_{LB}. The remaining pixel which had a voltage of V_{W} is set to other black voltage setting (i.e., V_{LB}, V_{HB}). Therefore each set has two pixels set to V_{HB} and two pixels set to V_{LB}.

This state is held for enough time for the pixels to charge electrically, but not so long that the liquid crystal begins to turn and the capacitance changes. In a preferred embodiment, this time period is approximately 1 microsecond.

In the final sensing phase, the driving voltages are removed from the dummy pixels and the four dummy pixels in each set are shorted together to allow charge sharing. A sense amplifier measures a voltage ΔV, given by the equation below:

$$Δ V = ( {V}_{+} - {V}_{-} ) = ( {V}_{HB} - {V}_{LB} ) \frac{( {C}_{M} - {C}_{G} )}{( {C}_{M} + {C}_{G} )}$$

wherein
C_{B}=Black capacitance; C_{W}=White capacitance;
C_{M}=Capacitance to measure; and 2C_{G}=(C_{B}+C_{W}).

The sign of ΔV indicates whether C_{M} is greater or less than C_{G}. If ΔV is positive, then C_{M} is greater than C_{G}, and the dummy pixels have completed less than half the transition from black to white. That is, the response time is greater than the period being checked. A negative ΔV indicates a response time faster than the checked period.

The preferred embodiment described above measures the off-time (black-to-white) transition time, because this is usually slower than the on-time. It is recognized that the method described above can be readily adapted to on-time measurement.

In addition to having a response time sensor, the microdisplay of a preferred embodiment has a sensor to determine if the liquid crystal is approaching the characteristic clearing temperature of the liquid crystal. The clearing temperature sensor is likewise located just off the active display area. The capacitance of a white pixel and a black pixel converge as the liquid crystal approaches its characteristic clearing temperature.

In contrast to the response time sensor, the characteristic clearing temperature sensor does not have identical sized pixels. The sensor has two sets of dummy pixels, wherein each set has a pair of pixels. The areas of the two pixels in each pair differ by a ratio α, where α is chosen to match the known ratio of the liquid crystal white-state and black-state capacitances for the temperature of interest. In each set the voltage of the larger pixel is set V_{W} and the a pixel has a voltage of V_{HB} in one set and V_{LB} in the other set. Similar to the response time, the liquid crystal is given a time period much longer than the anticipated response time, to allow the capacitance of the liquid crystal to settle. In a preferred embodiment, the time period can be in excess of 5 milliseconds.

The next step is to precharge those pixels which have a voltage of V_{W} to a voltage such that each set has one pixel at V_{HB} and the other at V_{LB}. This state is held for enough time for the pixels to charge electrically, but not so long that the liquid crystal begins to turn and the capacitance changes. In a preferred embodiment, this time period is approximately 1 microsecond.

In the final sensing phase, the driving voltages are removed from the dummy pixels and the two dummy pixels in each pair are shorted together to allow charge sharing. A sense amplifier measures a voltage ΔV, given by the equation below.

$$Δ V = \frac{{V}_{HB} - {V}_{LB}}{α {C}_{B} + {C}_{W}} ( α {C}_{B} - {C}_{W} )$$

The sign of ΔV indicates whether the ratio of the C_{W} to C_{B} is greater or less α. If ΔV is negative, then the ratio (C_{W}/C_{B}) is greater than α, which means that the liquid crystal is nearing its clearing temperature.

An alternative clearing sensor design uses a single dummy pixel with circuitry to drive it blak or white. The dummy pixel loads an oscillator circuit which outputs a signal with frequency inversely proportional to the dummy pixel capacitance . The ration C_{W}/C_{B} is then equal to the ratio f_{B}/f_{W} of frequencies measured in the black and white (clear) states.

One of the traits of liquid crystal that is desired is the long time constant which allows the image to be maintained without having to refresh in certain instances. Single crystal silicon using CMOS technology provides circuitry with extremely low leakage currents. In combination with high quality Liquid Crystal (LC) material, the low leakage of the circuitry and extremely high resistance of the LC can produce long time constants. These time constants can be in the order of several minutes. Therefore, a residual image can be retained depending on the point where the scanning circuitry stops functioning during power offs.

In contrast to digital cameras, digital cellular telephones and other devices which receive digital data and/or are embedded memory applications and where the video signal is fairly well controlled, the signal from a video device such as a camcorder is not well controlled, especially in fast scans.

In addition, inherent in the distinction between a digital device and a video device is that the first has digital data which is capable and typically is stored in memory and the video device has an analog signal which is generally not stored in memory in the device from the camera (input) or the tape to the display. In addition, the video device in some circumstance is interlace data. Interlace data is data in which the odd rows are scanned first and then the even rows. Interlace data is typically used where the video rate is not as fast (e.g. odd fields refresh at 60 Hz and even fields refresh at 60 HZ, total refresh rate of 30 Hz). By alternating odd and even fields the entire display has some data writing to the display at a rate of 60 Hz therein reducing flicker.

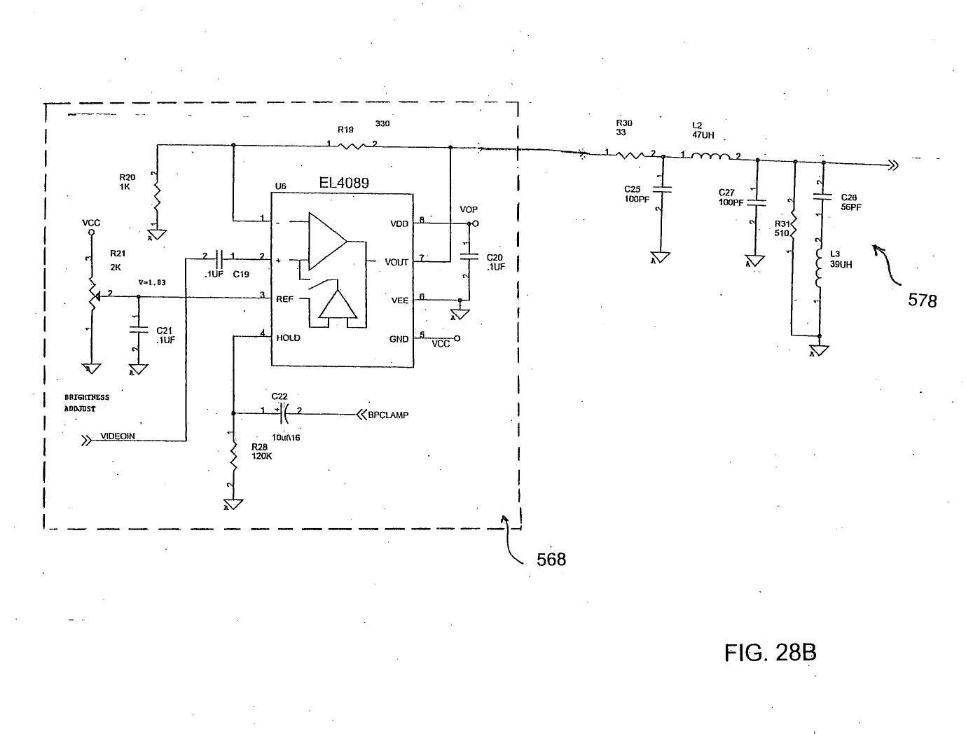

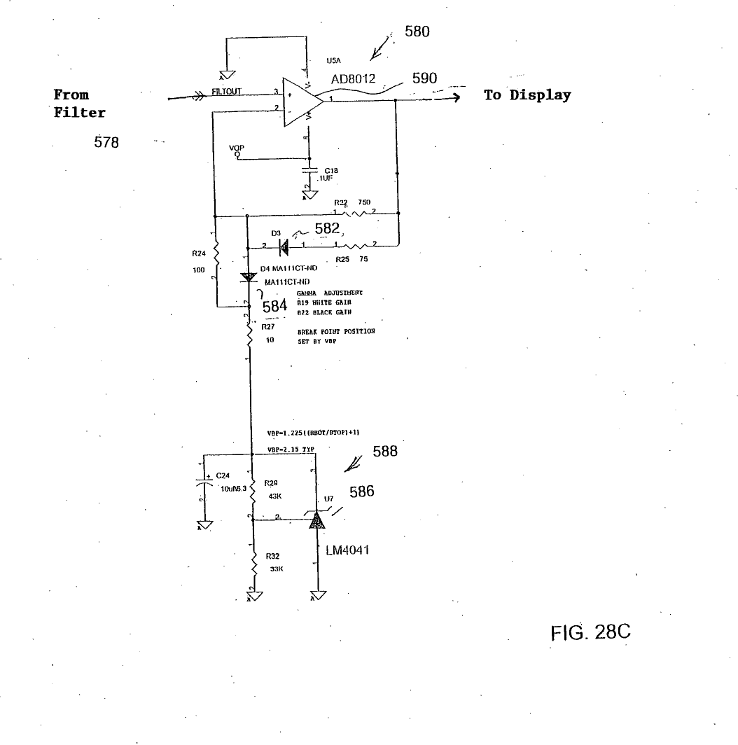

FIG. 28A is a schematic of a display control circuit 546 for an analog signal. A signal 548 received by the display control circuit 546 contains a video signal and a synchronization signal. The signal is sent in two paths wherein on one path a DC restorer 550 restores the black level and directs the corrected signal to the display 110. The signal is sent to the display as video and inverted video.

The signal is additionally passed through a low pass filter 552 which separates the synchronization signals from the video signal. The synchronization signals are separated into a horizontal synchronization 554, vertical synchronization 556, and even/odd (E/O) 558 by a synchronization separator 560. These synchronization signals are input into the complex programmable logic chip 562. A PClk is also input into the complex programmable logic chip 562 from a phase lock loop 564 which receives the horizontal synchronization signal 554. From the programmable logic chip or device 562, a plurality of signals 566 including video clear, VP, HP, are sent to the display. A backlight system is in addition controlled by the complex programmable logic chip.

In a typical embodiment, the timing control circuit 562 is a device such as an RC6100 Horizontal Genlock Chip and a Philips Complex Programmable Logic Chip (CPLD). These devices can incorporate several of the other blocks illustrated in FIG. 28A and are used to generate the timing signal for the display such as a QVGA LCD. The RC 6100 chip accepts composite video and contains a sync separator, PLL frequency multiplier and timing generator blocks. Vertical sync (VS), horizontal sync (HS), and pixel clock (PClk) from the RC6100 drive the CPLD. The CPLD has been programmed to implement horizontal and vertical counters and other logic functions. Signal HS resets the horizontal counter, signal PClk increments the counter, the counter provides a time base from which logic functions are derived. Signal VS resets the vertical counter, signal vinc (horizontal counter derived) increments the counter, the counter provides a vertical time base from which logic functions are derived.

The display control circuit 546 separates a synchronization signal from the video signal since the signal comes into the interface (VIDEOIN) as a composite signal. The display control circuit 546 can have a plurality of switches for selecting between NTSC or a PAL signal. One switch selects between the type of signal. The other switches allow selection between the four types of each signal.

Several of the components/circuitry discussed above with respect to the display control circuit 546 are conventional. However, not all components are conventional, some of which are discussed below.

The DC restorer 550 is indicated by the box 568 in FIG. 28B. The DC restorer 550 normalizes to a standard voltage the signals such that the reference black is a constant voltage. In another words, the DC restorer allows for same intensity image even if potential exists between systems and allows for AC coupling. From the DC restorer 568 the signal goes through a filter 578 for stripping out or removing the color image of the signal.

The signal passes from the filter 578 to a gamma corrector circuit 580 illustrated in FIG. 28C. The gamma corrector 580 uses a pair of diodes 582 and 584 to compensate for the non-linear effects of the liquid crystal. The diodes 582 and 584 are selected to match the characteristics of the liquid crystal. The gamma correction circuitry 580 is adjusted to a center point by a linear diode 586 as part of a stabilization offset ground circuitry 588. The gamma corrector circuit 580 incorporates an output operational amplifier 590 which boosts the signal. The signal from the gamma corrector circuit 580 is sent as video and inverted video to the microdisplay. The phase lock loop 564 and gamma correction circuit 580 reduce artifacts on the displayed image so that all of the image can be displayed without cropping of lines around the periphery of the image that is common in existing camera displays.

As indicated above, in devices such as video cameras the signal that is received for the display circuitry is analog. The synchronization signal is carried as part of the video. The previous portion discussed improvement of the video portion. The following details the control signals.

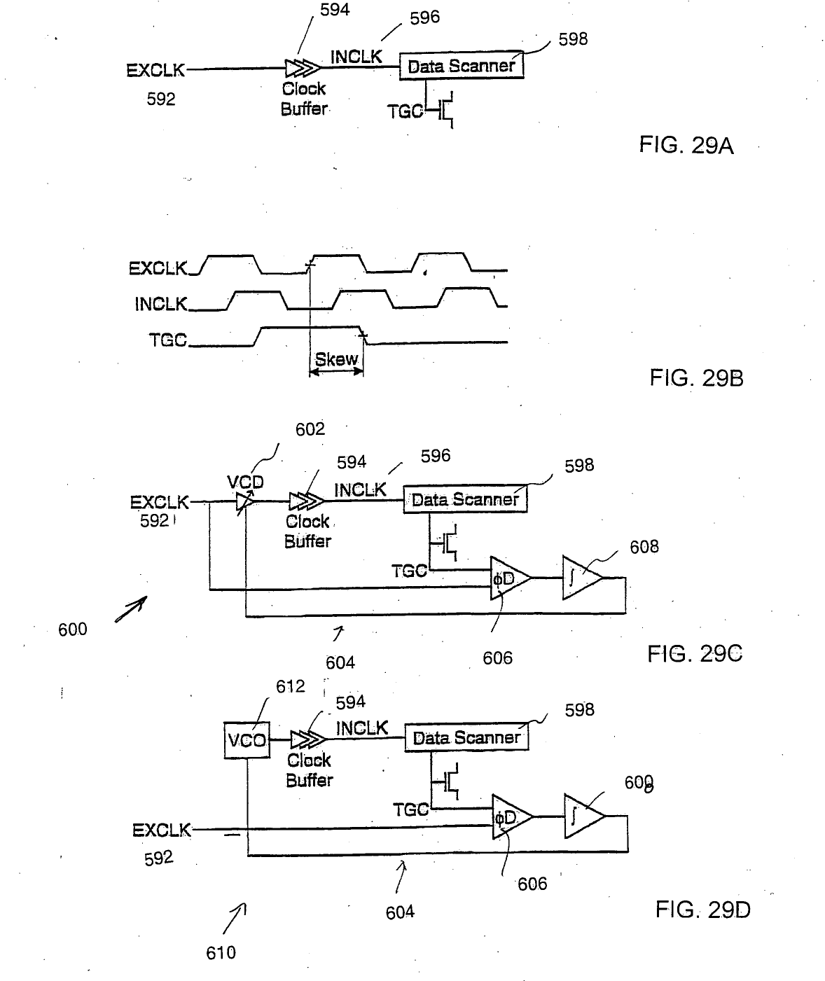

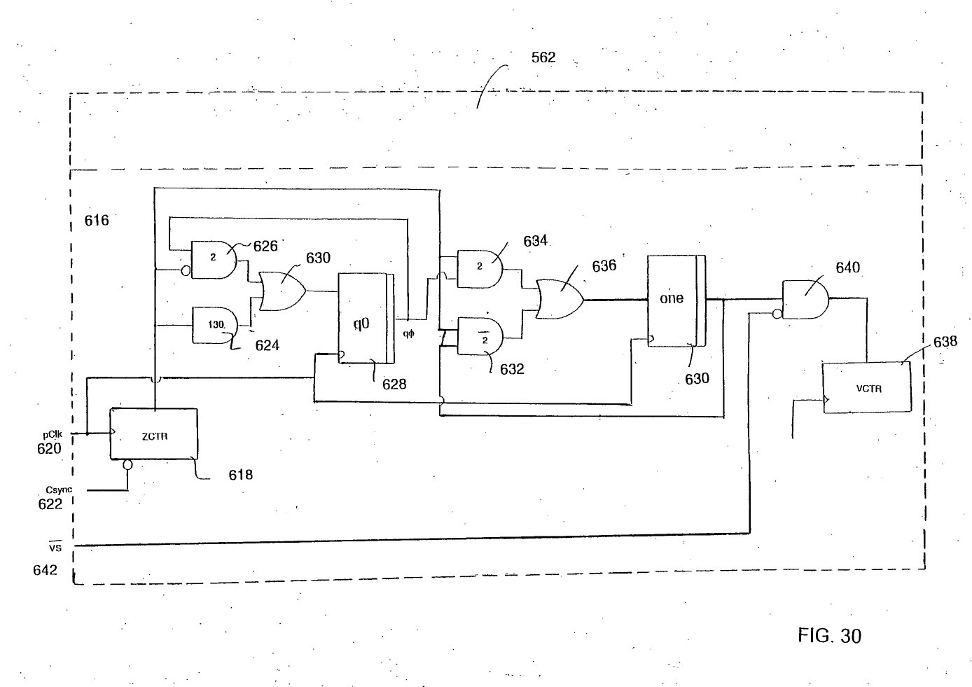

Referring to FIG. 29A, integrated displays, such as an active matrix liquid crystal display typically have a critical signal path. An external clock input (EXCLK) 592 is buffered through a clock buffer 594 to produce an internal clock (INCLK) 596 which controls a data scanner 598 timing. The data scanner is similar to the horizontal shift register of FIGS. 2 and 10. The data scanner 598 produces TGC (Transmission Gate Clock) pulses to enable the transmission gates (one shown). As shown in the timing diagram of FIG. 29B, the propagation delays of the clock buffer 594 and the data scanner 598 result in a timing skew between the active edge of the EXCLK and the sampling edge of the TGC. The skew is typically temperature-dependent and may vary from one display to the next of apparently identical displays.

FIG. 29C shows a delay-locked loop (DLL) 600 for eliminating the skew. A voltage-controlled delay (VCD) element 602 is inserted in the signal path. A feedback path 604 comprising a phase detector (ØD) 606 and an integrator 608 controls the VCD 602, increasing the delay until the sampling edge of the TGC becomes coincident with the next active edge of the EXCLK. That is, the phase detector 606 and integrator 608 adjust the VCD 602 to maintain zero skew between EXCLK and TGC.

FIG. 29D shows an alternative technique for controlling a synchronization, using a phase-locked loop (PLL) 610 instead of the delay-locked loop 600. This PLL 610 is located on the integrated circuit display die 116 of the microdisplay 110, and should not be confused with the PLL 564 associated with the complex programmable logic chip 562 in FIG. 28A. The VCD 602 is replaced with a voltage-controlled oscillator (VCO) 612, which generates the internal clock. The internal clock signal is sent from the VCO 612 to the data scanner 598 via a clock buffer 594. As with the DLL (delay-locked loop), a feedback loop 604 is used to eliminate the skew between the TGC and the EXCLK, as sensed by the phase detector. The PLL involves a second-order control loop. The second integration is implicit in that the VCO generates a frequency but the ØD senses phase.

Camcorders and video cassette recorders (VCRs) have several modes of operation including play, record, fast forward and reverse. Two additional modes, that of fast forward play mode and fast reserve play mode, allow the user to view the image at a speed-up rate. The frame rate for these two modes remains approximately 60 frames per second, but the video signal is missing approximately one-half of the signal. The video signal is therefore broken up into bands that have good video and noise, the portion where the video is missing. When the incoming video is bad, both the image part and synchronization (sync) part of the signals may have random signals, or noise, throughout the video stream.

Referring back to FIG. 28A, one of the synchronization (sync) signals that is on a composite video in signal 548 (CVIN) is the vertical synchronization signal 556 which indicates that the image should start repainting from the top of the screen. A synchronization (sync) separator, which looks for the vertical sync signal, can misinterpret noise to be an extra vertical sync, causing the frame to restart its scan prematurely. The extra vertical syncs cause the good parts of the image to jump up and down. A similar problem happens with horizontal sync if extra syncs are present. This problem is more noticeable on active displays such as active matrix liquid crystal displays (LCD) than cathode ray tube (CRT) displays, because of distinctions in how the image is painted to the screen. The distinction being that CRT displays use a synchronized analog ramp instead of a shift register as in LCD.

While horizontal synchronization will similarly try to restart the row, the image signal is typically noise and therefore the problem is not as major a concern as vertical synchronization. The real problem with the horizontal sync noise comes about because it is the horizontal sync that is used to lock the phase-locked loop (PLL) as indicated above. If the sync separator generates an extra horizontal pulse, the PLL tries to slow down. If the sync separator misses a horizontal pulse, then the PLL tries to speed up. The PLL becomes unstable and unlocks. It will take several good horizontal syncs for the PLL to become stable again. While the PLL is unstabilized the image will appear to be torn and misaligned in the horizontal plane. Depending on how confused the PLL becomes, it may take up too many rows to become stable. The tradeoff between PLL lock time and regular PLL noise or jitter becomes an issue.

Referring back to FIG. 28A, a portion of the timing circuit is illustrated. The signal passes through a low pass filter 552 which separates the synchronization signals from the video signal. Synchronization signals are input into the complex programmable logic chip 562. A PClk signal is input to the complex programmable logic chip 562 from the phase lock loop 564. The phase lock loop 564 receives a horizontal synchronization signal 554.

When composite video is received from VCRs and camcorders running at normal playback speed the above system will work fine since there is no portion where the signal has been removed. However, when composite video is received at fast-forward or rewind speeds, the system has portions where the signal is removed. The noise is interpreted as a vertical synchronization signal. The RC6100 produces multiple VS signals which reset the vertical counter and cause the image on the LCD panel to frame erratically vertically.

FIG. 30 illustrates a representation of a digital logic 616 to detect the vertical sync signal. An eight-bit counter (ZCTR) 618 is located inside a complex programmable logic chip of the timing control circuit 562 and clocked by PClk 620 and reset by CSync (composite synchronization pulse) 622. The CPLD 616 is similar to the CPLD discussed above with the addition of one or more of these features discussed below.

CSync 622, when high, causes ZCTR 618 to remain at count=0. CYSNC 622, when low, allows ZCTR 618 to increment. ZCTR 618 increments such that it counts through two and continues higher. However, in that CSync 622 normally goes high in a short time period (such as for 4 microseconds), ZCTR 618 resets to zero and ZCTR 618 never counts that far beyond two or in proximity to the number 130.

The output of the ZCTR 618 goes to a pair of gates 624 and 628. One gate 624 goes high when ZCTR receives a specific number, such as 130. The other gate 626 has an input of not 2 ( 2̅) and output from a “q0” flip/flop 628. The outputs of the and gates 624 and 626 are sent to an OR gate 630.

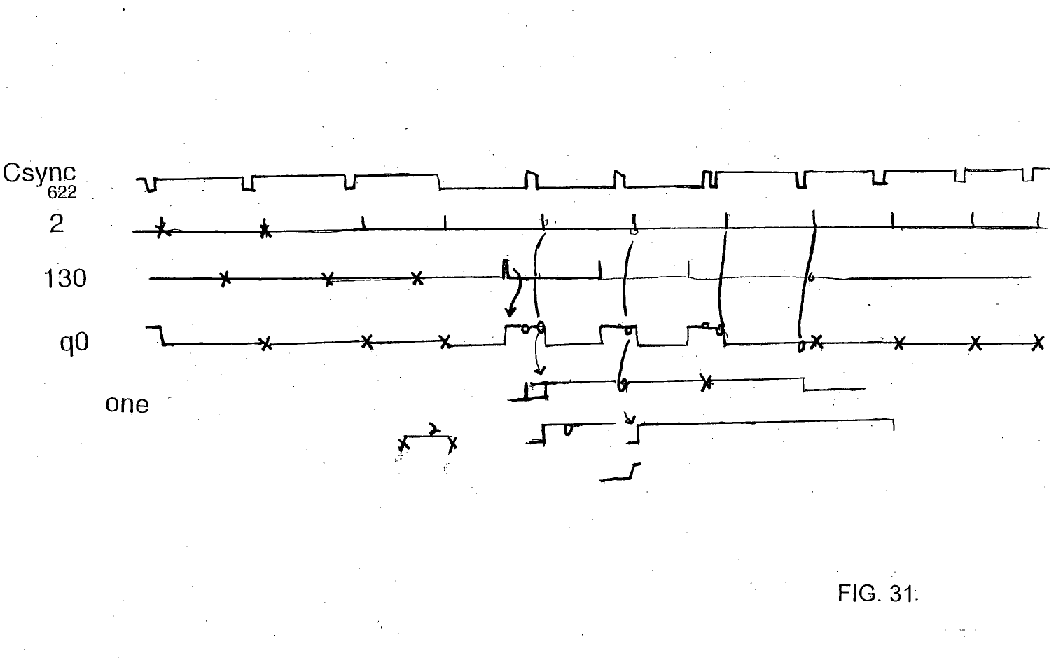

When CSync 622 pulses become predominantly low, referring to FIG. 31, the ZCTR 648 counts for a significant time period (such as for more than 20 microseconds), therein counting to and beyond a preselected number, such as 130, where it sets the flip/flop “q0” 648. The flip/flop “q0” 628 remains set until next ZCTR 618 decode of two which would occur after CSync 622 goes high. When this occurs the “q0” flip/flop 628 resets. The “q0” flip/flop 628 therefore normally remains reset because ZCTR 618 typically does not count long enough to get to the preselected number, such as 130, because CSync 622 resets ZCTR 618.

Still referring to FIG. 30, the state of the “q0” flip/flop 628 is sampled by a “one” flip/flop 632 when ZCTR 618 reaches a count of 2 (2 count). The “one” flip/flop 630 receives it signal through an OR gate 636 which receives its signal from a pair of gates 632 and 634. Gate 632 receives input from ZCTR 618 and the output of the “one” flip/flop 630. The other gate, gate 634, receives input from ZCTR 618 and the “q0” flip/flop 628. The state is held in the “one” flip/flop 632 until the next ZCTR 618 reaches another count of 2 (2 count). The signal of the “one” flip/flop 632 will set at the second serration pulse. If the CSync 622 goes high before the ZCTR 618 counts to 130 the “one” flip/flop 630 will be cleared.

The signal of the “one” flip/flop 630 is used as an input or an additional qualifier to reset a vertical counter reset (VCTR) 638. The signal of the “one” flip/flop 48 is inputted into a two input AND Gate 640 with the other signal being the Vertical Synchronization (VS) signal 642. The output of the AND Gate is directed to the reset of the VCTR 638.

Referring to FIG. 31, a timing diagram showing the relationship of the output of the “one” flip/flop 632 to that of the input CSync 622, the “q0” flip/flop 628 and the “2” AND Gate 628 and the “130” AND Gate 624. As can be seen in FIG. 31, CSync 622 is usually a hi signal with a short pulse lo. During synchronization, the CSync 622 is usually lo.

As seen, the 2 counter, reaches 2 every cycle because of the CSync 622 having a low portion. The 130 counter is high only when the CSync 622 has been lo for the set time, in a preferred embodiment for example at 6 MHZ and 130 clocks 21.6 microseconds. The q0 flip/flop 628 latches when the 130 AND gate 624 is hi. The q0 flip/flop 628 is examined by the one flip/flop 630 on the next 2 count. The one flip/flop 630 combines with the VS sync 642 to reset the vertical counter 638.

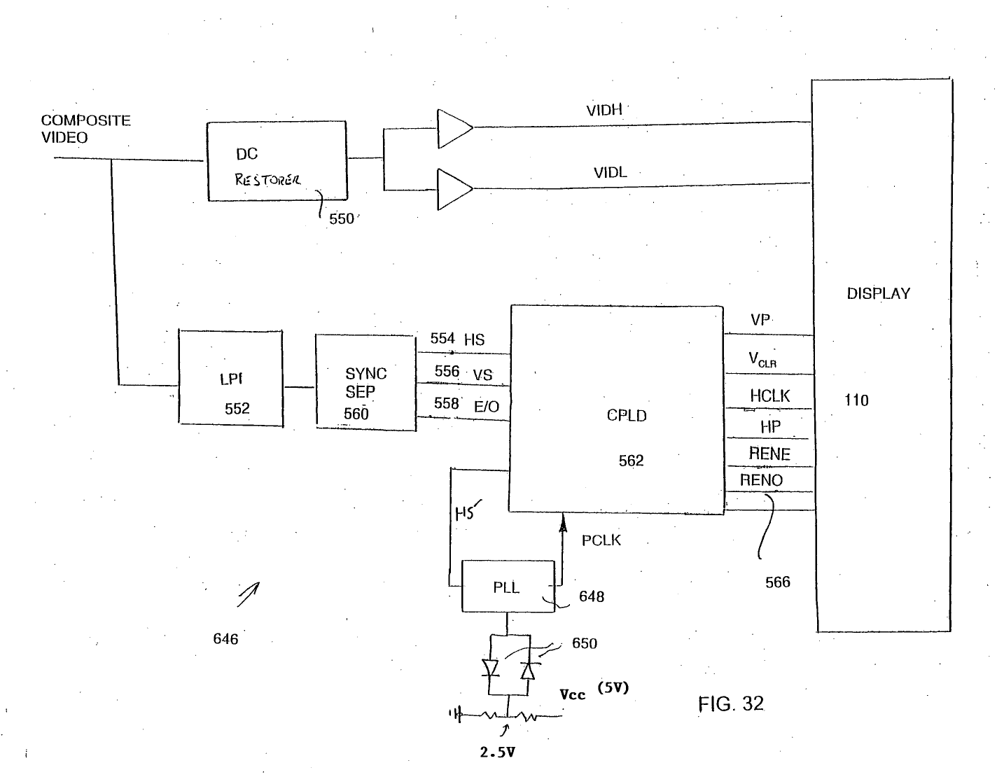

FIG. 32 is a revised detailed timing control circuit 646 similar to FIG. 28A. A phase-locked loop (PLL) 648 receives its signal from the logic CPLD 562, not the original horizontal synchronization signal 554. The logic CPLD 562 de-noises the signal and generates a clean horizontal synchronization signal (HS′). The PLL 648 has a pair of diodes 650 connected with a 2.5 volt source. This circuitry allows the PLL 648 to move away from 2.5 volts by only as much as the voltage drop through a diode.

The above logic is build into the CPLD and prevents extraneous VS signals from resetting the vertical counter. The LCD panel frames correctly in fast forward and rewind modes.

As indicated above, in certain situations, it is desirable to have the video signal received by the processor at an accelerated rate, such as fast forward scan or review scan as explained in further detail below. The phase-locked loop which takes its signal from the video signal as indicated above is subject to more noise.

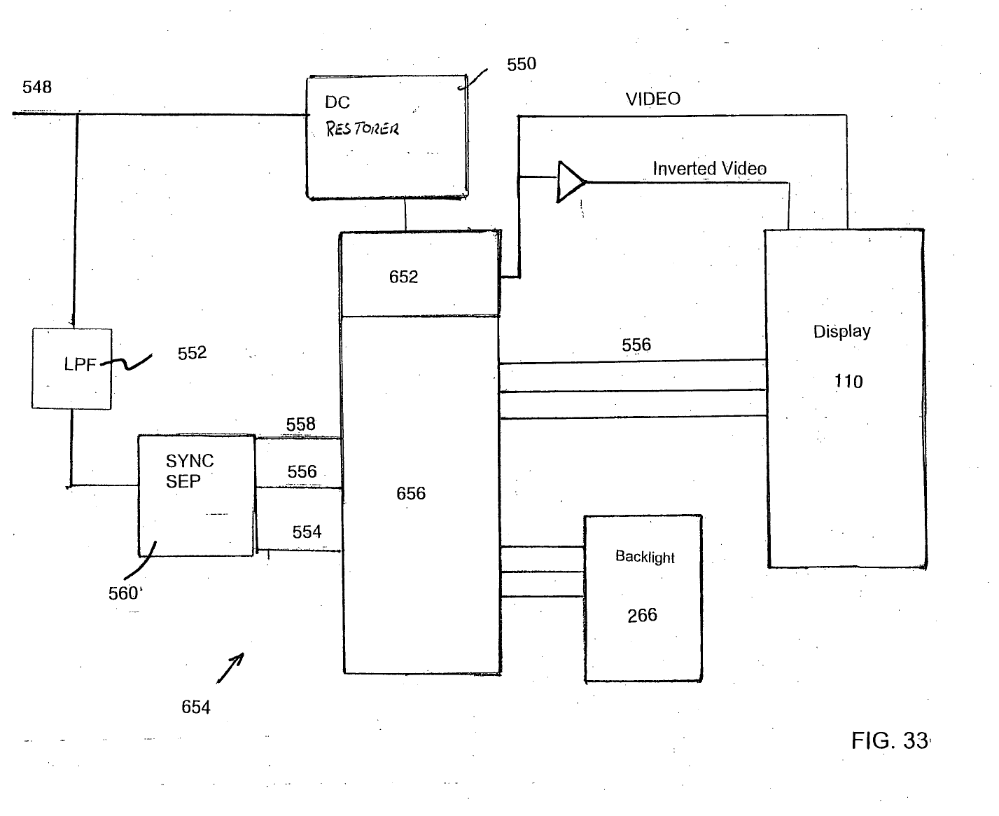

In a preferred embodiment, as seen in FIG. 33, the timing from the video is used to control timing from the receipt of the composite signal 548 and the writing of video data to a frame buffer 652.

The timing of the display control circuit 654 for reading from the frame buffer to the microdisplay 110 is controlled by a second clock located in a timing control circuit 658. In certain types of video, the clock is 27 MHZ. The timing for the display side can be a different speed such as 25 MHZ.

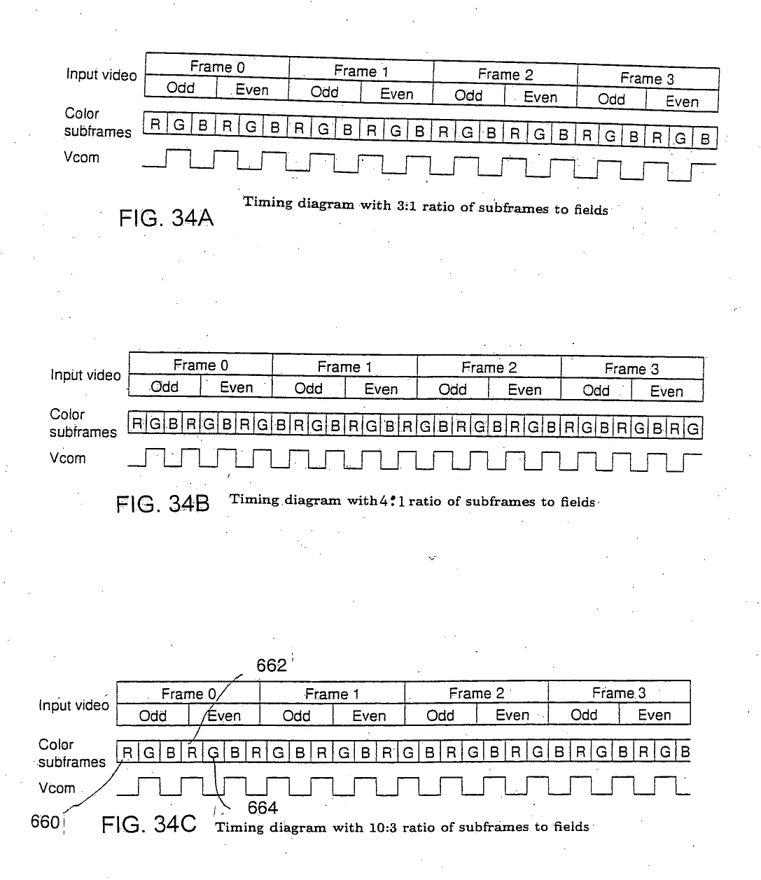

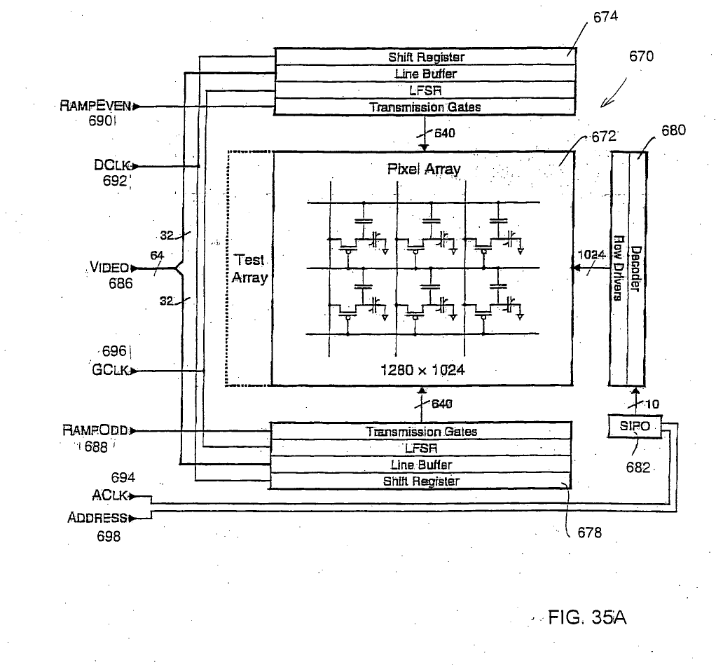

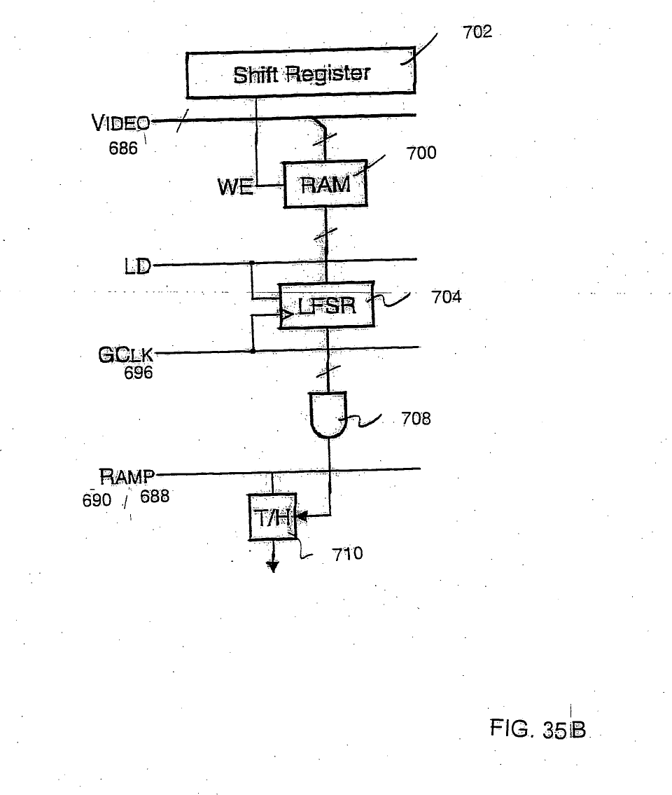

In certain embodiments the image is scanned into the display, such as interlace data, first the odd rows and then the even rows. If the rows are scanned in at a rate of 60 per second, the actual rate of refresh is 30 frames per second. This technique of refresh has been used for conventional cathode ray tube (CRT) displays. A problem that results if the fields do not have similar information (e.g., a series of different color lines) is the unbalance of the oxide. FIG. 34A shows a 3:1 drive scheme where the voltage to counterelectrode V_{COM} is switched after each subframe (i.e. a color and even or odd). It therefore takes six subframes for a frame.

The 3:1 scheme does not preserve DC balance, except in the special case where the even and odd fields are identical. Observe that V_{COM} is always high during the green subframes of odd fields, and low during green subframes of even fields. If a pixel is magenta in the odd field but white in the even, then it will spend 1 of 6 subframes in the high black state and 5 of 6 subframes in the white state. A DC imbalance is created because the pixel is never driven into the low black state.

The 4:1 timing shown in FIG. 34B preserves DC balance a high and low subframes of red, green, and blue color occur in both even and odd fields. The color subframe rate is 200 Hz for PAL systems with 50 Hz field rate, which gives good results and no objectionable flicker. However, the 60 Hz field rate of NTSC systems results in 240 Hz subframe rate, which may compromise color uniformity.

For improved color uniformity in NTSC systems, the subframe rate may be reduced to 200 Hz by using the 10:3 ratio illustrated in FIG. 34C.

With a 10:3 ratio, the end of the color subframe which coincides with the switching of the voltage of the counterelectrode does not necessarily coincide with the end of input frame. However, in that the writing to the display occurs in the first third of each subframe in a preferred embodiment, and the 10:3 ratio causes at least the first third to be in the same frame, the writing all occurs before the switch. The writing in a preferred embodiment takes 1.64 milliseconds. The flashing and the switching of the voltage of the counterelectrode, and initialization of the pixel if desired, occurs on subframe.

For example, referring to FIG. 34C, the frame 0 odd input has a pair of identical red video input indicated as 660 and 662. The second red video input odd frame 0 662 is written prior to the switch to the even input video. The liquid crystal has time to settle and the red LED is flashed as indicated above prior to the switching of the voltage to the counterelectrode. The next subframe written is green even frame 0 indicated as 664. Each odd or even portion of a frame has at least one write of each color.

It is recognized that while column inversion and frame inversion have been predominately discussed, that other drive scheme may be desired in certain instance. Column inversion is where one column receives video and the next column recieves inverted video. In the next frame or subframe, the signals are inverted such that frame that received video in the first subframe or frame, receives inverted video in the next frame. In frame inversion, the entire display receives video one frame and inverted video the next subframe or frame. In addition to column inversion and frame inversion, other types of inversion are row inversion and pixel inversion. In pixel inversion, the first pixel receives video and the next pixel receives inverted video similar to column inversion, but in addition, each row is flipped.

As indicated above, the ratios can be changed which result in different number of images be associated with a signal or inverted video signal. Depending on the clock rate and the pattern of video and inverted video the noticing of stick and flicker is reduced. The placing of several inverted video subframes together and then several video subframes would minimize stick and increase flicker. By mixing various modes, both flicker and stick is minimized.

The previous portion discussed displays in which an analog video signal is received and the signal remains analog for the entire period. The next portion returns back to displays on which the initial signal is digital.

The display is analog, but analog circuitry is subject to both large power consumption and the increased likelihood of interference from other circuitry. It is therefore desired in some embodiments to have the display signal as a digital signal until the signal is closer in proximity to the display, such as on the integrated circuit In one preferred embodiment, the display signal is digital until it reaches the integrated circuit of the microdisplay as illustrated in FIG. 35A. This is in contrast to FIGS. 2, 10 and 11 wherein the signal that enters the integrated circuit of the microdisplay over the ribbon cable as an analog signal, as seen in FIG. 9 and in FIG. 19A from the external digital to analog converter 412.

Referring to FIG. 35A, an integrated circuit active matrix display 670 having a 1280×1024 pixel microdisplay 672 is illustrated. High definition television (HDTV) formats use a 1280×1024 pixel array. Incorporated into the circuit 670 are a pair of horizontal scanners 674 and 678, a vertical driver 680, a SIPO 682, and the active matrix display 672.

The active pixel array 672 has a plurality of pixel 138. Each pixel has a transistor 140 and a pixel electrode 142 such as seen in FIG. 20A. Each pixel electrode works in conjunction with a counterelectrode 144 and the liquid crystal layer 146 to create the displayed image. The pixel element 138 is connected to the adjacent row 150 to form a storage capacitor 442 in an embodiment.

Adjacent to the active pixel array 672 in a preferred embodiment is a test array 678. The test array 678 can include a temperature sensor, a capacitance measurement of the liquid crystal sensor, and/or a characteristic clearing temperature sensor as described above.

The integrated circuit 670 of the microdisplay receives the digital video signal over a 64-channel bus 686 which in part is formed by a ribbon cable. In addition, the integrated circuit receives two analog ramp signals 688 and 690, (Rampodd and Rampeven), three clocking signals 692, 694, and 696 (digital clock, address clock and gate clock) and address signal 698.

The address signal 698 and the address clocking 694 signal in conjunction with the SIPO 682 and the vertical driver 680 select the row on which data is to be written. The vertical driver 680 has a decoder which selects the proper row driver and a plurality of row drivers, 1024 row drivers in this preferred embodiment, which turns on the transistors in that row.

The two column or horizontal scanners 674 and 678 are identical except that they differ in that the upper column scanner 674 receives and handles the signal for even columns while the lower column scanner 678 receives and handles the signal for odd columns. The feeding of the signal for odd columns from one side and signals for the even columns from the other side is similar to that shown with respect to FIG. 11. However, the signal received in FIG. 11 is analog, wherein the signal in FIG. 35A is digital.

Each column scanner 674 and 678 has a shift register, a line buffer, a LFSR and transmission gates as explained below. An analog ramp signal, gate and data clocking signals and digital data is received by each scanner.

Referring to FIG. 35B, the video signal in a timed pulse enters the Random Access Memory (RAM) 700 along 32-channel data line. The RAM for the desired column is selected using a write enable (WE) generated by a shift register 702 of the column or horizontal scanner 674 or 678.

The shift register 702 selects the proper RAM 700. The data in the selected RAM 700 is sent to a linear feedback shift register (LFSR) 704. The LFSR 704 in a preferred embodiment is a 8-bit LFSR. The LFSR 704 produces a sequence of 2ⁿ−1 states where n is the number of bits.

With an 8-bit LFSR, the display can have 256 of gray or distinction within a color. The RAM contents are transferred to the LFSR when the load signal LD 706 is asserted, thereby setting the initial state of the LFSR. The date clock GCLK 696 cycles the LFSR through its state sequence. When all the bits of the LFSR become 1, the AND gate 708 outputs a 1, which puts the track-and-hold T/H circuit 710 in the hold state and samples the ramp voltage on the column line 7101. In this way, the digital data input sets the initial state of the LFSR, which determines the number of GCLK cycles until the LFSR fill, with 1 s, which in turn determines when the ramp signal will be sampled to set the analog column voltage.

In a preferred embodiment, the RAM 700 may be written with data for the next row while the LFSR is operating on data from the present row.

Timing

| Array size | 1280 × 1024 | | 1280 × 1024 | | 1280 × 720 | | 1280 × 720 | |
|---|---|---|---|---|---|---|---|---|
| Gray levels | 2⁸ = 256 | | 2⁷ = 128 | | 2⁸ = 256 | | 2⁷ = 128 | |
| Field rate | 180 | Hz | 180 | Hz | 180 | Hz | 180 | Hz |
| Row rate | 184 | kHz | 184 | kHz | 130 | kHz | 130 | kHz |
| Row period | 5.43 | μs | 5.43 | μs | 7.72 | μs | 7.72 | μs |
| GCLK rate | 51.6 | MHZ | 25.8 | MHZ | 36.3 | MHZ | 18.1 | MHZ |
| GCLK period | 19.4 | ns | 38.8 | ns | 27.6 | ns | 55.1 | ns |
| DCLK rate | 31.0 | MHZ | 31.0 | MHZ | 21.8 | MHZ | 21.8 | MHZ |
| DCLK period | 32.3 | ns | 32.3 | ns | 45.9 | ns | 45.9 | ns |

In certain embodiments, it may be desirous to send information from one location to another, such as in head mounted units for a vehicle as explained below. On technique is to use a data link 720.

The data link 720 converts the information so that it can be transmitted quickly at high band width with a minimum number of connections. For example, in a preferred embodiment, the microdisplay 110 is 1280×1024 pixel array having an eight bit gray scale.

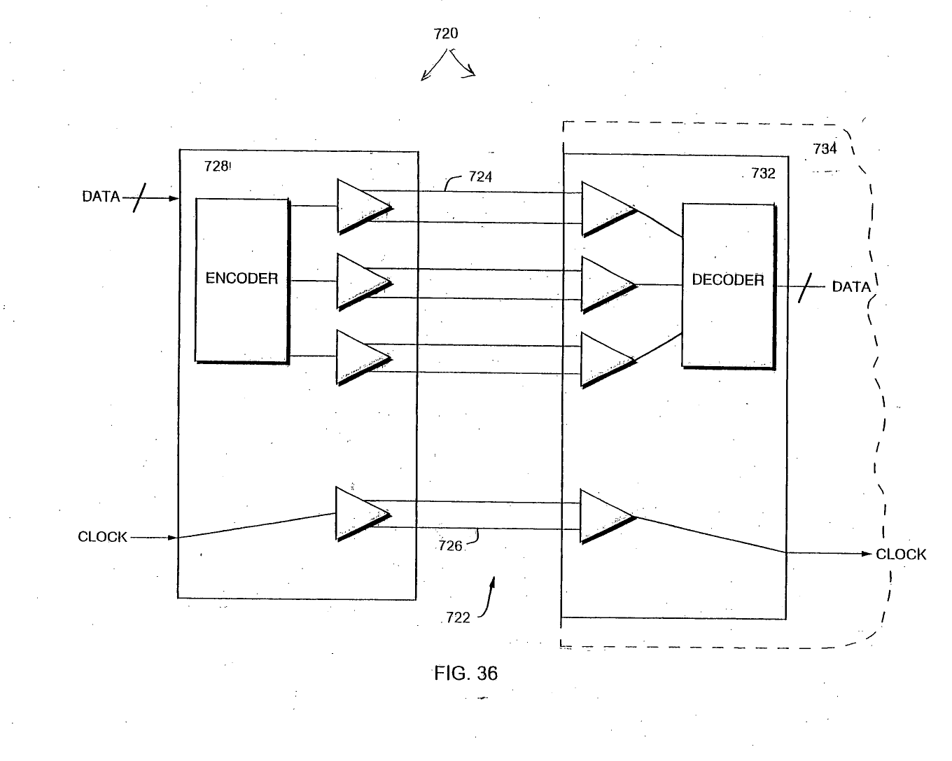

The data link 720 has a link 722 as shown in FIG. 36A, has a plurality of paired data signal wires 724 or fiber optics and a clock-pair wires 726 or optics. The data is encoded and serialized by a transmitter unit 728 located on a video card 730. The data is sent across the link at a higher clock rate. A receiver 732 located on the display a driver board 734 decodes the data and places it back into a “parallel” data form. In a preferred embodiment, the data link is such as the one marketed by Silicon Images, Inc. under the tradename PanelLink. The purpose of the link is to speed the data using the minimum number of data lines. The data link or transmission system uses a Fibre Channel such as available from numerous suppliers such as FlatLink™ Data Transmission System from Texas Instruments or PanelLink™ Technology from Silicon Images.

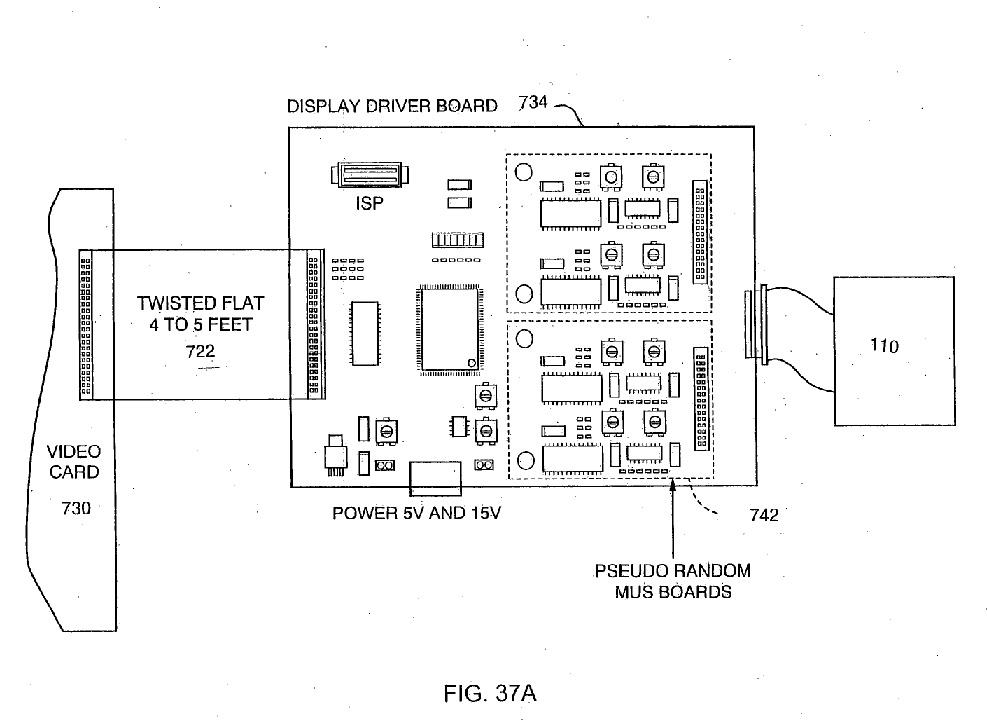

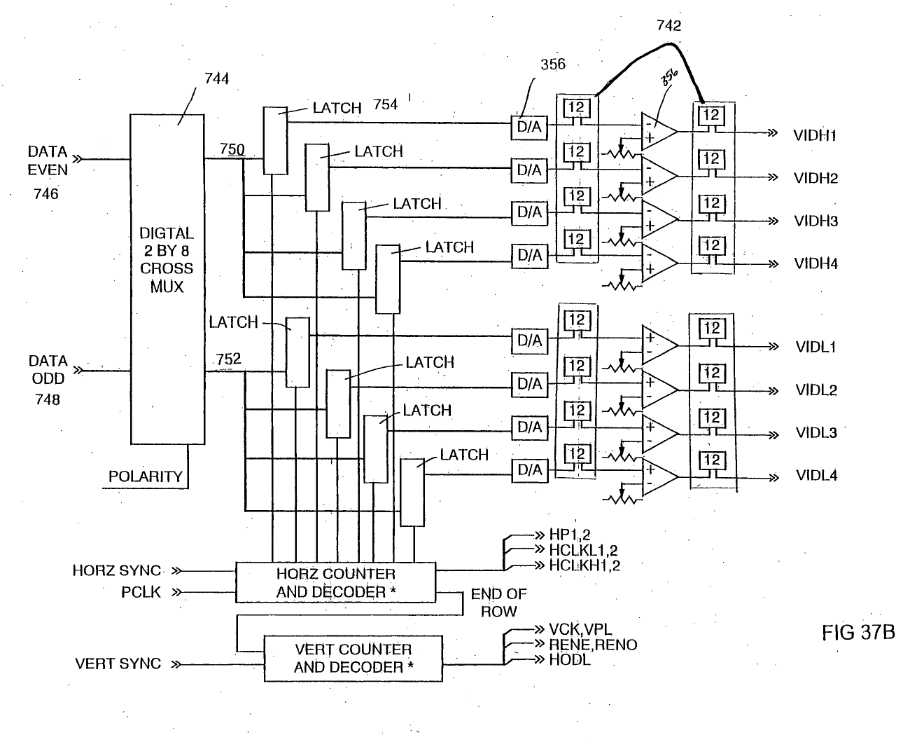

In addition to the data link 720, a display system can have pseudo-random multiplexers to compensate for differences in amplifiers as explained below. The microdisplay 110 in a preferred embodiment receives an analog signal which is converted from a digital signal on the display driver board 734 as seen in FIG. 37A. The signal converted through the digital to analog converter (D/A converter) 356 as seen in FIG. 37B is sent through an amplifier (operational amplifier) 740. Each amplifier is slightly different; therefore, if the same signal is input into each amplifier, a different signal would be output. When the amplifiers are used for the signal on a display, the user may note dark and light columns because of the varying output signal. While the amplifiers can be tuned/adjusted to correct for the differences, a pseudo-random multiplexing system corrects for variances.

The pseudo-random multiplexing system in an embodiment has a pair of pseudo-random multiplexers 742. Each of the pseudo-random multiplexers 742 in a preferred embodiment is formed on a board that plugs into the display driver board 734 in a preferred embodiment. It is recognized that the pseudo-random multiplexing system can be formed integral with the display driver board.

The pseudo-random multiplexing system captures the signal from the D/A converter 356 pseudo-randomly sends the signal to one of the amplifiers and then takes the signal from the amplifier and sends it to the proper output, the inputs for the microdisplay. Referring to FIG. 37B, the driver for the display is schematically shown. The data enter in series a digital 2-by-8 cross mux demultiplexer 744 in two channels, a data even channel 748 and a data odd channel 748. The data exits the multiplexer 744 in eight (8) channels, four (4) channels video high (even rows) 750 and 4 channels video low (odd rows) 752. The data is sent to the D/A converters 352 with a plurality of latches 754 controlled by the horizontal counter 756 controlling the flow of data. The converted signal from the D/A converter 352 is taken by the pseudo-random multiplex board 742 and routed to one of the amplifiers 758 and then to the proper output. The inputs to the pseudo-random multiplex board are represented by the “1” on the terminals and the outputs are represented by the “2” on the terminals shown in FIG. 37B.

The pseudo-random multiplexer has two identical units in a preferred embodiment. One unit pseudo-randomizes the inputs to the video high and the second unit pseudo-randomizes the inputs to the video low. The pseudo-random multiplex does not mix amplifiers between the high signal and the low signal in a preferred embodiment. The amplifiers have different offsets. It is recognized however that such mixing could occur.

The pseudo-random multiplexer board has a header with eight (8) inputs, for receiving the outputs from four respective D/A converters 352 and the outputs from four amplifiers 758. The header has eight (8) outputs for sending the signal to the four amplifiers and four respective video signals.

The signals (the four signals) from the D/A converter 352 are each fed to four individual switch circuits. There are therefore sixteen (16) switching circuits. In a preferred embodiment, each set of four switches are located on a chip. Each of the individual switches receives a controlling input from a logic chip. Only one switch in each set, and a different one in each set, is closed to all the input flow to the output which is the input to the amplifier. The output from the amplifier follows a similar path to a second set of switches. The second set of switches is controlled using the same inputs from the logic chip, and therefore the output from the switch is sent to the proper video signal. The signal going through the top D/A converter in FIG. 37B is sent down the top signal line.

The following are two examples of how the respected switching can be set. In the first example, the signal from the first two inputs is sent to the amplifier which it would be sent to without the pseudo-random multiplexer. The signals from the third and the fourth inputs are switched by the multiplexer before entering the amplifier and then switched back to the correct line before forwarding to the display.

OUTPUT

| | 0 | 1 | 2 | 3 |
|---|---|---|---|---|
| 0 | X | | | |
| 1 | | X | | |
| 2 | | | | X |
| 3 | | | X | |

| Switch A | Switch B |
|---|---|
| VH01→VH02 | VH03→VIDH0 |
| VH11→VH12 | VH13→VIDH1 |
| VH21→VH32 | VH33→VIDH2 |
| VH31→VH22 | VH23→VIDH3 |

In the second example, the signals from the inputs are sent to the following amplifier. The signal from the last input is sent to the first amplifier. The output from the amplifier and then switched back to the correct line before forwarding to the display.

OUTPUT

| | | 0 | 1 | 2 | 3 |
|---|---|---|---|---|---|
| INPUT | 0 | | X | | |
| | 1 | | | X | |
| | 2 | | | | X |
| | 3 | X | | | |

| Switch A | Switch B |
|---|---|
| VH01→VH12 | VH13→VIDH0 |
| VH11→VH22 | VH23→VIDH1 |
| VH21→VH32 | VH33→VIDH2 |
| VH31→VH02 | VH03→VIDH3 |

With the four (4) input and four (4) outputs, the two above examples are just two of 16 combinations. The pseudo-random multiplexer constantly switches between the sixteen (16) conditions to allow the eye to integrate the amplifiers. The rate can be either frame rate (60 HZ) or row rate (60 KHZ). Row rate is preferred.

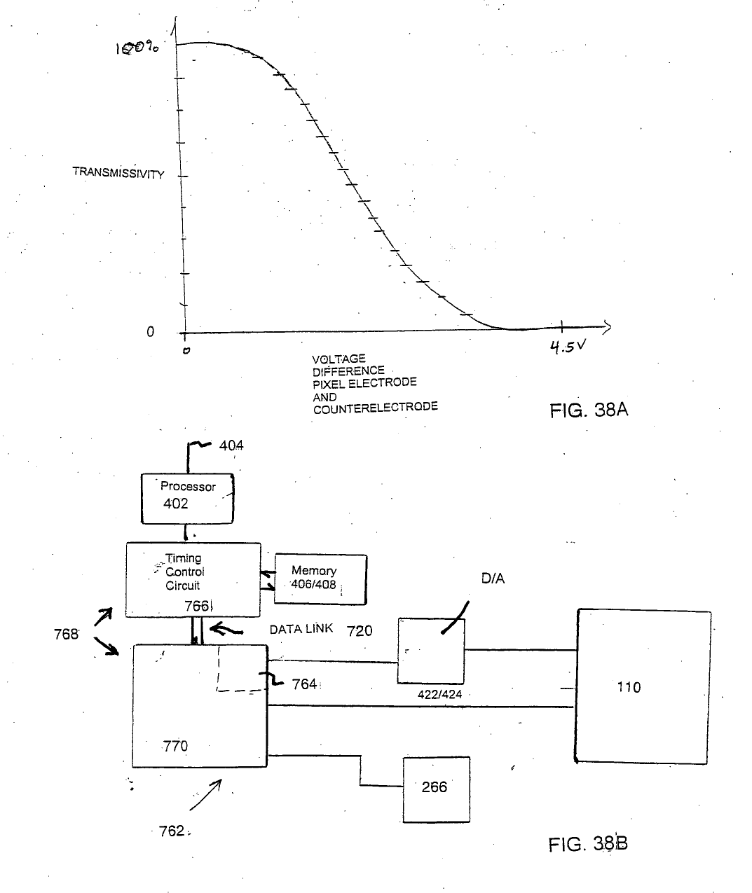

Referring to FIG. 38A, the liquid crystal does not respond linearly to changes in voltage, that is difference in voltage between the pixel electrode and the counterelectrode. If the voltage offset varies 4.5 volts from clear to black as in a preferred embodiment, the first half (½) volt change and the last half (½) volt change effect the transmitivity the least as illustrated in FIG. 38A. In addition, in that the video signal is stored digitally in several embodiments discussed above, the voltage selected can only be at a number of discrete positions. Furthermore, the data link 722 as illustrated in FIGS. 36 and 37A, and marketed by Silicon Images, National Semiconductor, and Texas Instrument, supports 32 bits per clock cycle. The discrete positions and the limited band width limits the colors and results in non-uniform color imagery.

FIG. 38B illustrates a display control circuit 762 for a microdisplay. The display control circuit 762 has a digital look-up table 764 for correcting the image gray scale and color. The look-up table also referred to as a gamma correction look-up table spaces the intensity or in this case, the transmissivity of the liquid crystal selected to achieve the desired image. It is recognized that while the non-linearity as shown in FIG. 38A is not desired, it is also not desired to have the intensity or transmissivity selected on available uniformly spaced since the human eye tends to discern differences more by ratios than absolute values.

The video signal is received by a processor 402 of the digital control circuit 762. The processor 402, similar to the processor of FIG. 19A, converts the signal 404 into a digital signal from whatever form the signal was previously, RGB, NTSB, PAL, etc. The digital signal is sent to a first portion 766 of a timing control circuit 768. The first portion 766 of the timing control circuit 768 forwards and receives data from the memory 406/408 as needed. The data from the timing control circuit 766 is sent across the data link 720.

On the microdisplay 110 side of the data link 720, a second portion 770 of the timing control circuit 768 which has the look-up table 764 located. The look-up table 764, in particular a gamma correction look-up table, is used to linearize the signal for the display transfer characteristics.

The backlight system 266 and the control lines 422 and 424 to the display 110 are controlled by the second portion 770 of the timing control circuit 768. The look-up table 764 can be used with displays with and without the switching of the voltage to the counterelectrode.

The input to the look up table is a multi-bit piece of information relating to a discrete gray scale or color shade desired to be displayed. This set of bits is treated by the table as an address or location in the table. The memory value at this location is then output from the table as a new multi-bit piece of information, which may have more, fewer, or the same number of bits as in the input data, depending on the table design and function. In a preferred embodiment, there would be 8 bits of data input to a table with 10 bits of data output. The 10 bits then gets converted to an analog signal in the D/A 422, providing the display 110 with the proper voltage to transmit light to the viewer corresponding to the desired input bits. The look up table values are derived from the gamma curve for the display, similar to FIG. 38A.

In a preferred embodiment, for a 24-bit data link 720, originally designed for 8 bits each of red, green, and blue pixels, four 6-bit pixel values or three 8-bit pixel values can be transmitted per clock cycle for adjacent pixels in a color sequential format. The use of 6 bits input to a 6 bit by 8 bit look up table will provide the viewer with 64 distinct and equally spaced gray shades per color. The use of 8 bits input to a 8 bit by 10 bit look up table will provide the viewer with 256 distinct and equally spaced gray shades per color. Higher data transfer throughput is achieved with minimum impact on image quality.

In a preferred embodiment, for a 48-bit data link 720, originally designed for 16 bits each of red, green, and blue pixels, eight 6-bit pixel values or six 8-bit pixel values can be transmitted per clock cycle for adjacent pixels in a color sequential format. The use of 6 bits input to a 6 bit by 8 bit look up table will provide the viewer with 64 distinct and equally spaced gray shades per color. The use of 8 bits input to a 8 bit by 10 bit look up table will provide the viewer with 256 distinct and equally spaced gray shades per color. Higher data transfer throughput is achieved with minimum impact on image quality.

While the look-up table has been described with respect to an embodiment that has a data link, it is recognized that the look-up table can be used independently of the data link.

In contrast to the color sequential display in which the flashing of the LEDs is synchronized to allow maximum settle time prior to the flash and ensure the flash is turned off before the next color settles, the precise timing of the flash in a monochrome is not necessary in certain embodiments.

FIG. 39A illustrates a timing diagram for a monochrome display. In that the display is monochrome, the LED 270 is constantly on and the image is written over and over using column inversion or another inversion technique. In column inversion, in one frame (e.g. FRAME 1) the odd columns are written with video and the even columns are written with inverted video. In the next frame (e.g. FRAME 2) the even columns are written with video and the odd columns are written with inverted video. If the monochrome display switches the voltage of the counterelectrode or initializes the pixels at the beginning of each frame such as in LVV, flashing of the LED as described above with respect to color sequential is done with the monochrome display.

Referring to FIGS. 39B1 and 39B2, a display control circuit 774 for an alternative embodiment is shown. This display control circuit 774 can work in conjunction with the integrated circuit display die 258 shown in FIG. 11, in which two pixels are written at the same time. The digital control circuit 774 takes an image from a source and displays the image on the microdisplay 110. The video signal 404 may be in an analog format such as NTSC, PAL, or S-Video, in which case it is received by an analog video decoder 776a and converted to digital representation 404v of red-green-blue (RGB) or luminance-chrominance (YCbCr) components. The decoder 776a also extracts timing information to produce synchronization signals 404s.

Alternatively, the input video signal 404 may be in a digital format such as BT.656, in which case a digital front end 776d separates the digital video 404v and synchronization 404s signals.

If the digital video signal 404v is represented with YCbCr, then it is converted to RGB by format converter 778. If signal 404v uses RGB representation, then converter 778 is bypassed.

In a preferred embodiment, all components of display control circuit 774, except the analog video decoder 776a, are integrated in a single application specific integrated circuit ASIC 782. In alternative embodiments, decoder 776a may be fully or partially integrated in the ASIC. In another alternative embodiment, DRAM 1004 or digital to analog converters 356 may be external to the ASIC 782. The timing generator 780 receives the synchronization signals 404s and produces all the necessary timing signals for the ASIC 782.

The ASIC 782 also includes an IIC interface 796, which provides means for an external processor to read and write the configuration registers 798. The configuration registers are used to program operating modes and timing parameters of the other components of ASIC 782.

Digital video formats conforming to the BT.656 standard can be scaled to fit a 320×240 display. Analog NTSC and PAL video decoded with a conventional 27 MHz clock can also be scaled. In the horizontal dimension, 9:8 scaling is required to reduce 360 samples to 320.

Formats with 525 lines and 60 Hz field rates (NTSC) do not require vertical scaling. With 243 and 244 active lines per field, the extra 3 and 4 lines may be discarded for 240-line vertical resolution. However, formats with 625 lines and 50 Hz field rates (PAL) require 6:5 vertical to reduce 288 active lines to 240.

The horizontal scaler 786 performs 9:8 horizontal scaling. A preferred embodiment uses the interpolation scheme illustrated schematically in FIG. 39C. The vertical scaler 780 performs 6:5 vertical scaling. A preferred embodiment uses the interpolation scheme illustrated schematically in FIG. 39D. Alternative interpolation schemes can be used.

Non-standard video formats may not require scaling, in which case the scalers 786 and 788 may be bypassed. It is recognized that other video formats may require scaling ratios other than 9:8 horizontally and 6:5 vertically.

Referring back to FIG. 39B1, the video signal from the vertical scaler 788 is sent to gamma correction circuit 792, which is similar to that discussed above with respect to FIG. 38B. For each of the red, green, and blue components of the input video signal, the gamma correction circuit 792 produces a corrected output value such that when the signal is converted to analog by D/A converter 356, the resulting intensity is proper for the eye.

In one preferred embodiment, the gamma correction circuit 792 uses a look up table 764 containing correct output values for all possible input values. In another preferred embodiment, the gamma correction circuit 792 computes a piece-wise linear function of the input, interpolating between values stored in 17 configuration registers. The signal from gamma corrector 792 is sent to pixel pairing circuit 794.

In pixel pairing, the individual values of the red, green, and blue pixels are reordered to more efficiently use memory. A schematic of pixel paring is shown schematically in FIG. 39E. The pixel pairing circuit 794 receives 24-bit words at 6.75 MHz. Each word contains the red, green, and blue components of a single pixel as three 8-bit values. The 16-bit output words contain two 8-bit values of the same color from horizontally adjacent pixels, the format required by the display.

Referring to FIG. 39B2, the 16-bit data stream from the pixel pairing circuit 794 is steered to one of two DRAM field memories 1004 by tri-state buffers 1002. One DRAM field memory is written while the other is read. Address and control signals for writing and reading are generated by DRAM controllers 1008 and 1010, respectively. Multiplexors 1006 steer the read and write address and control signals to the appropriate field memory 1004.

Data from the DRAM field memory 1004 being read is passed to the output processing circuit 1012, which inverts the video if necessary. The output data then passes to the digital-to-analog converters 356, with a peak data rate of two 8-bit words at 27 MHZ. The analog signals from converters 356 are amplified by external video amplifiers 1014 to drive the display 110.

The ASIC 782 also contains a display timing control unit 1016, which generates control signals for the display 110, the backlight 266, and the analog switch 1018 for the counter electrode.

The embodiments of both monochrome and color active matrix display described above can be used in various products including digital cameras, view finders, vehicle displays, printers and wireless communication devices such as pagers and cellular telephones.

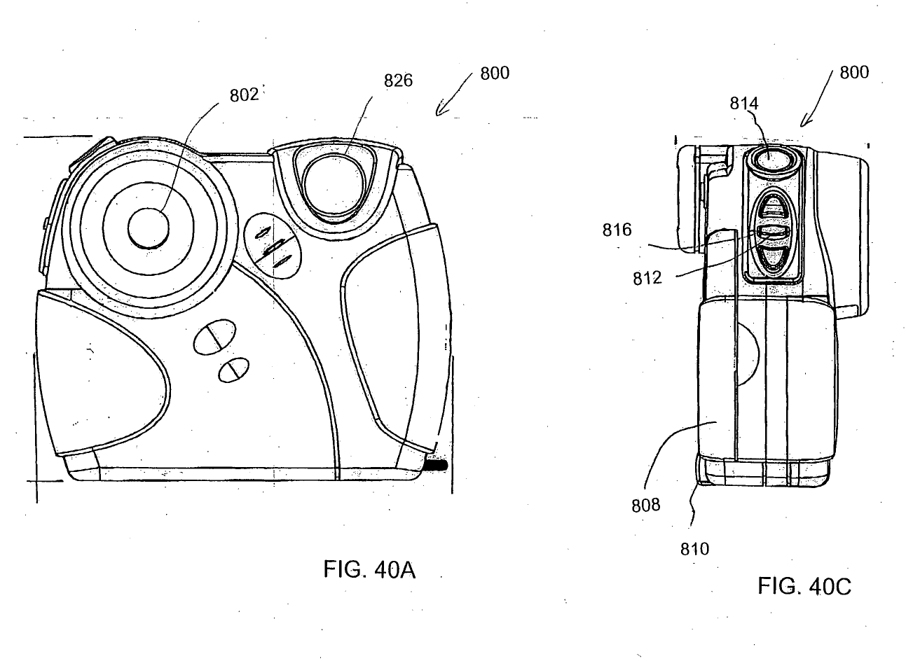

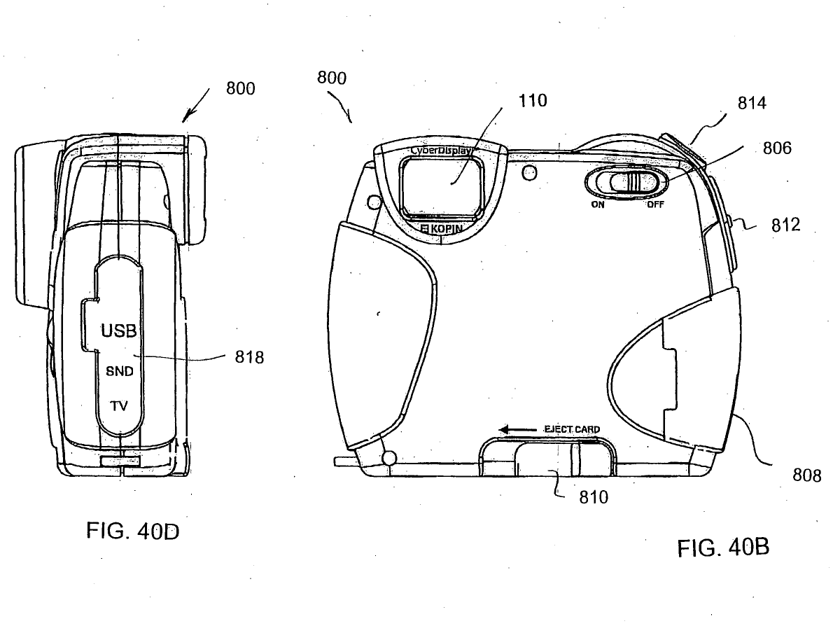

A digital camera 800 for still photographs is illustrated in FIGS. 40A-40D. An exploded view of the camera 800 is seen in FIG. 41. The digital camera 800 has a lens 802 located in front of an image sensor 804, as seen in FIG. 41. The digital camera 800 has a microdisplay 110, as described above, and an off/on switch as seen in FIG. 40B. The microdisplay 110, seen through the lens 298, such as seen in FIG. 13B, to both aim the camera and to view the captured image. A focus knob 826 for focusing the microdisplay viewer 110 is located on the front of the digital camera 800 as seen in FIG. 40A.

Referring back to FIG. 40B, in a preferred embodiment, the digital camera 800 receives a removable memory card such as compact flash card (CF), smart media, etc. The digital camera 800 has a compact flash card access door 808 and an eject button 810.

Referring to FIG. 40C, a selection switch 812 and a shutter/push button 814. A flexible bezel 816 attaches the housing 828 and 830. The selection switch 812 in combination with the push button 814 allows deleting a recorded image, saving images and viewing images. An input/output door cover 818 as seen in FIG. 40D, covers inputs and outputs 820 carried by a circuit assembly 822 as seen in FIG. 41.

The camera 800 encases the circuit assembly 822 with a front and a rear plastic housing 828 and 830 as seen in FIG. 41. The camera 800 has a battery holder 832 located in front of the circuit assembly 822 to hold a plurality of batteries 834 and a battery door 836 accepted by the front plastic housing 828. It is recognized that the battery holder 832 can be formed integral with this housing.

In a preferred embodiment, the camera 800 has a microphone 838 for recording sounds in conjunction with documenting photographs. It is recognized that the camera 800 has an infrared sensor for focusing.

The digital camera is capable of interfacing with items such as a portable computer, a cardreader to transfer images from the digital camera to a computer or printer. In a preferred embodiment a card, such as the compact flash card, is removed from the camera and inserted in the computer. In an alternative embodiment, the transfer can be both to and from the digital camera by a cable interference accessible through the input/output door cover 818 for connecting to the computer or an NTSC TV output.

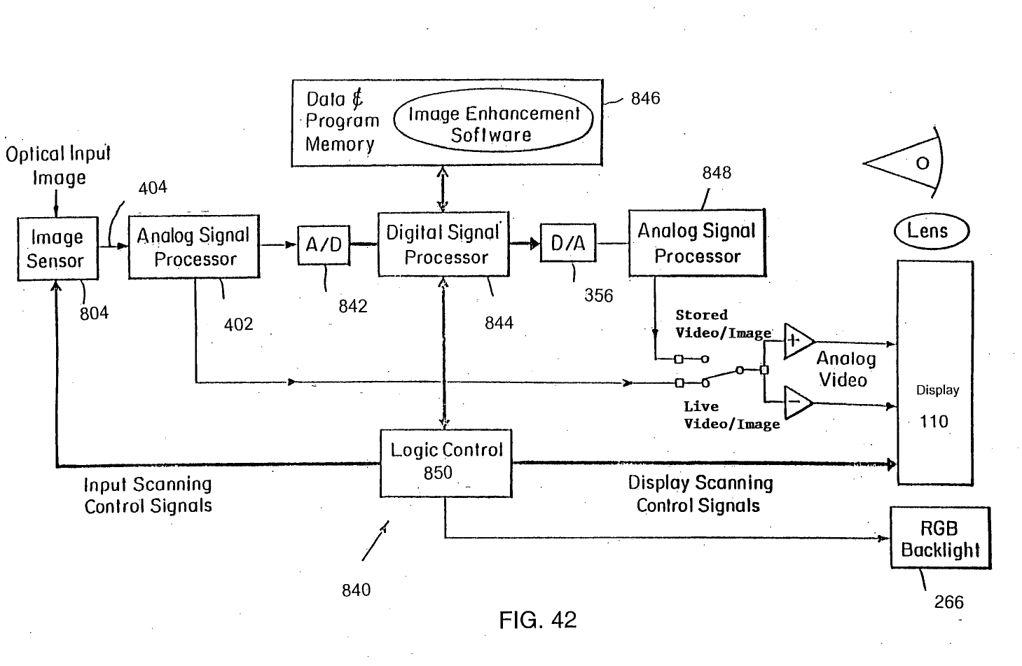

A preferred embodiment of a display control circuit 840 for a color sequential microdisplay 110 for a camera 800 is illustrated in FIG. 42. The display control circuit 840 receives an analog composite signal 404 at an analog signal processor 402 from the image sensor 804. The analog signal processor 402 can be a commercially available chip, such as the Sony CXA1585, which separates the signal 404 into red, green and blue components. While the embodiment has been discussed with respect to an analog signal, it is recognized that the signal can be digital. A digital system incorporates teaching found in this patent.

The image is sent from the analog signal processor 402 directly to the microdisplay 110. The interfaces related to gamma correction, Pclk, and the two synchronization clocks discussed above, with respect to FIGS. 28A-34 can be incorporated.

At the same time, the three analog color components are converted into digital signals by an analog to digital (A/D) converters 842. The digital signals are further processed by a digital signal processor 844 and stored in a memory circuit 846. The signal stored in the memory circuit 846 can be enhanced or altered such as compression, gamma correction, smoothing and/or dithering. The enhancing or altering uses commercially available software, such as Photoshop, Inc. that marketed by Adobe, Inc.

In addition to viewing directly from the analog signal processor 402 associated with the image sensor 804, the microdisplay 110 can display what is stored in memory 846 by the digital signals going through the digital signal processor 844 to a digital-to-analog converter 356 to convert the digital signal back into an analog signal. The display control circuit 640 has an analog signal processor 848 for separating the signal into red, green and blue components. The analog signal processor after the digital processor corrects the image sensor data.

The display control circuit 840 has a logic circuit 850 including a timing circuit. The logic circuit 850 is connected to the image sensor 804, the microdisplay 110, the digital signal processor 844 and the memory 846 for controlling the flow of the video signal.

When taking the images directly from the image sensor to the microdisplay through the analog signal processor 402, the logic circuit 850 synchronizes the signal into red, green and blue signals which the microdisplay 110 uses. This synchronization can include the use of various filters to gather image data in a synchronized color order to be fed to the microdisplay 110 and coordinating actuation of the backlight 266.

The logic circuit 850 controls the sequential flow of each color frame onto the display by sending video data from the memory 846 onto the display 110 and coordinating actuation of the backlight 266 along lines for each primary color.

The microdisplay 110, in addition to being used for a viewfinder for a still camera 800, is used for a viewfinder for a camcorder or video recorder 860 as seen in FIG. 43. The camcorder 860 has a viewfinder housing 862 with the microdisplay 110 including the optical housing.

As described above with respect to FIGS. 13A and 13B, an assembled display module 286 has the microdisplay 110, the backlight housing 278, and the optical holder 294 with the lens 298. The view finder housing 862 contains the assembled display module 286 with its components extending along an optical axis 306 and a circuit board 864.

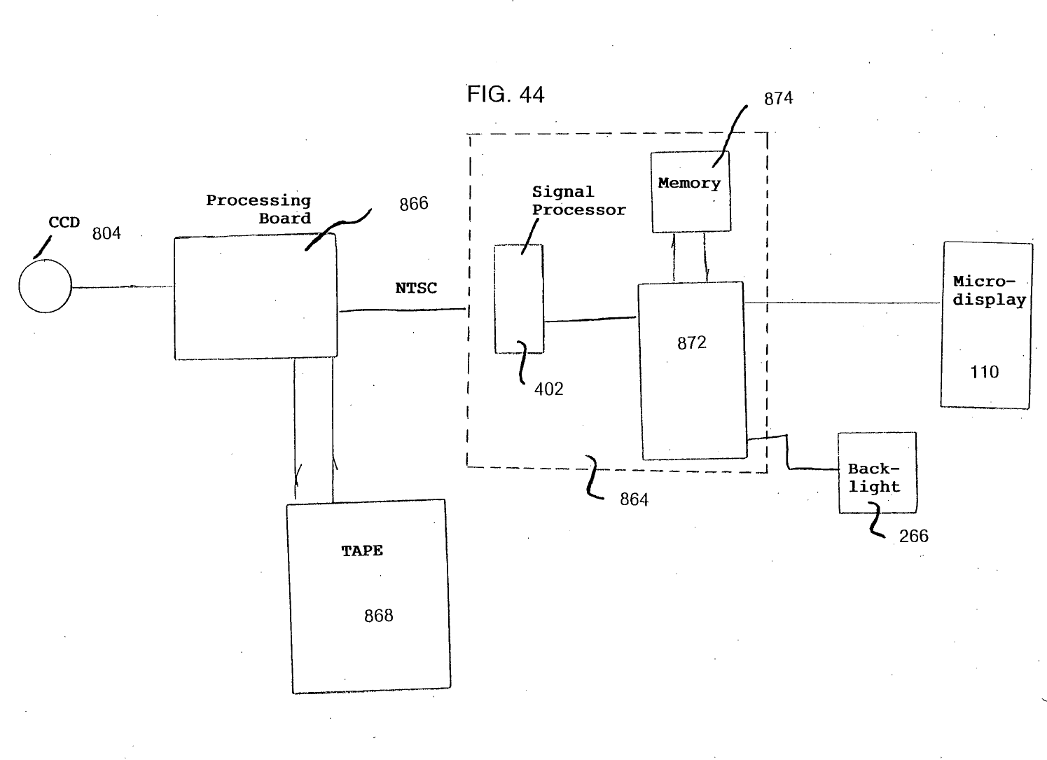

The circuit board 864 for the display is illustrated schematically in FIG. 44. The circuit board 864 has an analog signal processor 402 for receiving a NTSC signal 404. The NTSC signal 404 is received from a processing board 866. The processing board 866 receives images from an image sensor 804a or in a playback mode from a tape 868, or internal memory. In a record mode, the image from the image sensor 804 is recorded on the tape 868. Switches 870, as seen in FIG. 43, associated with the processor board 866 allow the operator to select the signal 404 sent to the analog signal processor 402 from the image sensor 804 or the tape 868. The tape 868 can be selected at a normal speed and in addition at other speeds, such as fast scan speed.

The circuit board 864 which is located in the viewfinder housing 862, in addition to having the analog signal processor 402, has a timing control circuit 872 and memory 874. FIG. 44 also illustrates the microdisplay 110 and backlight 266 which are located in the view finder housing 862. In a preferred embodiment, the circuitry includes the synchronization of video signal and two clocks as discussed above with respect to FIGS. 28A-34C

In a vehicle such as a helicopter or plane, the operator is required to process a large amount of information quickly to operate the vehicle. In one preferred embodiment, the display is a head-mounted display. Therefore, the display and those components mounted on the head via a helmet need to be both lightweight and rugged. In addition, due to the varying light conditions experienced by the pilot from bright sunlight to darkness, the display needs to be able to vary the intensity.

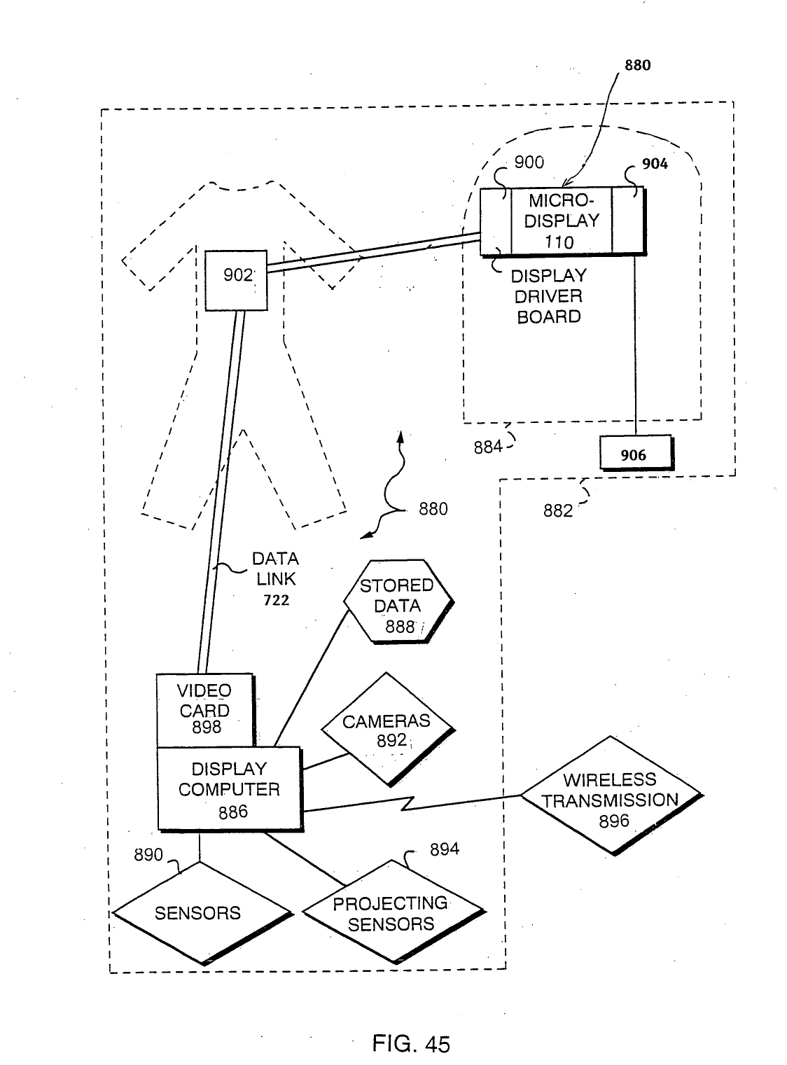

Referring to FIG. 45, a schematic of a display system 880 for a vehicle 882 is shown. In this embodiment, the display 110, a microdisplay, is mounted on a helmet 884 worn by the user. The information that the display projects is transmitted from a display computer 886 to the microdisplay 110 through a data link 722. The system can be binocular or monocular, with two (2) or one (1) display.

The computer 886 receives its information from numerous sources which can include store data 888, sensors 890 on the vehicle for items speed, direction, altitude; cameras 892 for enhanced vision, such as night or infrared; projecting sensor 894, such as a radar system, and information received from other sources by wireless transmission 896. The computer 886 can select and combine the data based on inputs from the operator.

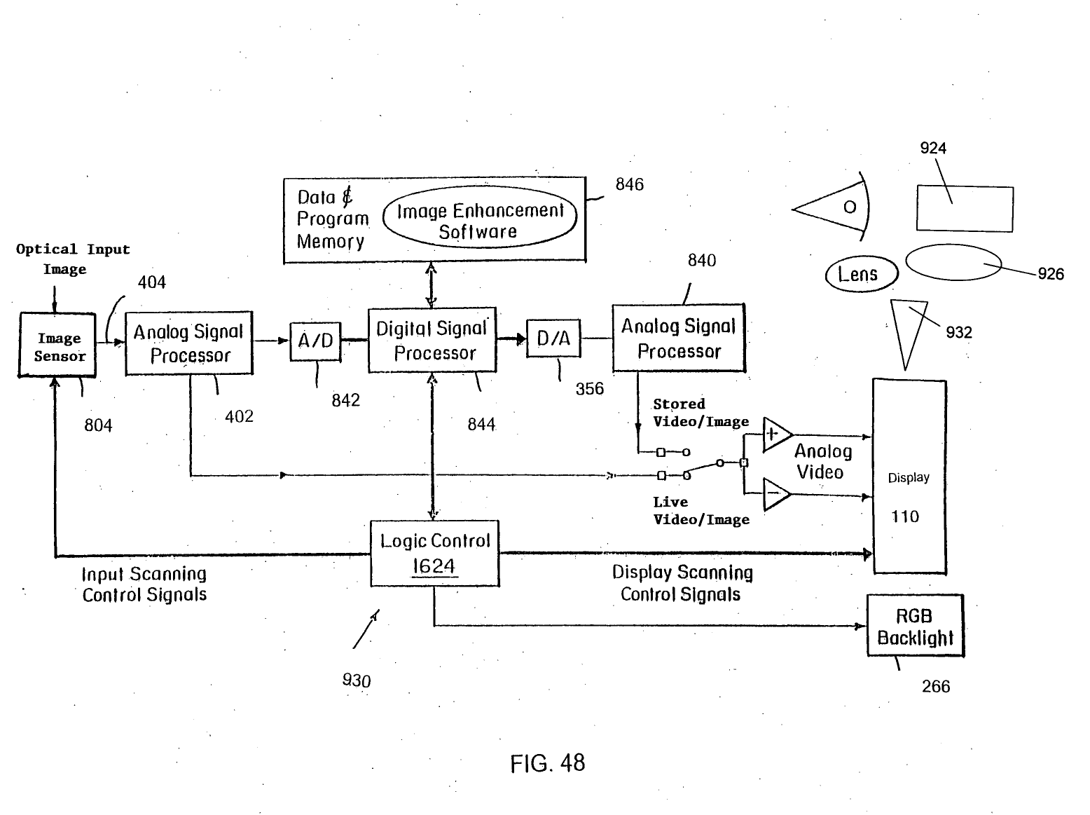

The information is transferred to the microdisplay 110 from the display computer 886 using the data link 722. The data link 722 takes the data which is converted on a video card 898, which is connected and adjacent to the display computer 886, and transfers it to a display driver board 900, located in proximity to the microdisplay 110. The data link 722 can be either a twisted flat wired cable or/and optical cables, as seen in FIG. 37A. In FIG. 48, the data link 722 has a quick-disconnect 902 on a user's flight suit.

In a preferred embodiment, the vehicle is a helicopter. The backlight light source is located remote from the microdisplay. The light source for the backlight is located either below or aft of the user, a pilot, and channeled by fiber optics to the pilot's helmet. The microdisplay works in conjunction with a lighting system, in a preferred embodiment, a backlight 904.

The lighting system is connected to a controller 906, as seen in FIG. 45, for varying the intensity of the light for both day-to-night vision. In addition, in another preferred embodiment the controller is capable of varying the intensity of the light of individual LEDS to improve the color quality for a color sequential display as discussed above. The lighting system shown in FIG. 45 is a monochrome LED mounted in proximity to the microdisplay 110 on the helmet 884.

While the above has been described related to a vehicle such as an aircraft, it is recognized that the configuration may be used in other embodiments such as connecting to an ordinary personal computer.

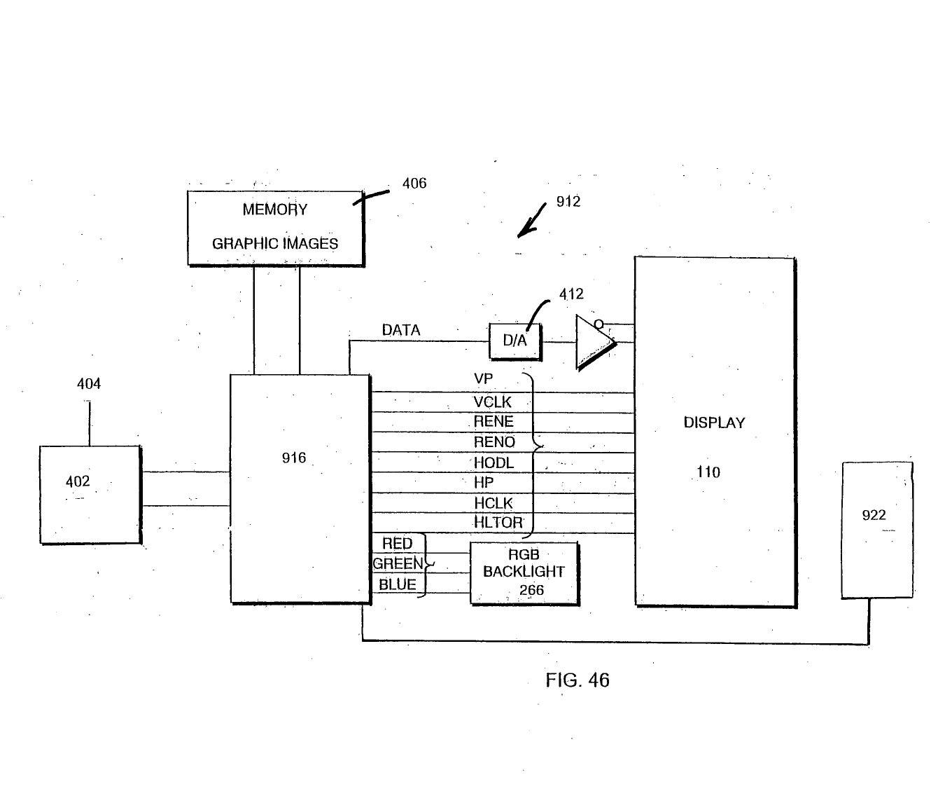

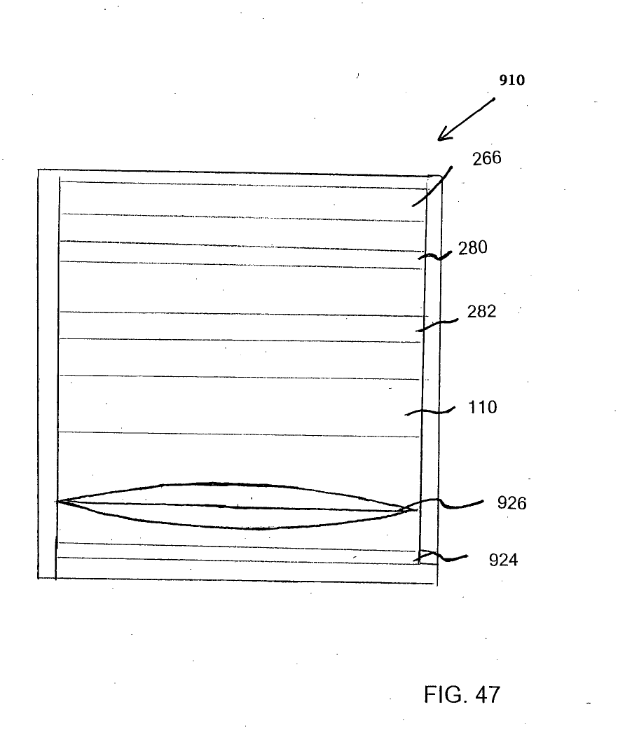

In addition to cameras and displays, the microdisplay 110 can be used to print on photosensitive paper using a digital printer 910, as illustrated in FIG. 47. A display circuit 912 for the digital printer 910 is illustrated in FIG. 46. The display circuit 910 is used to control the digital printer 910 with a color sequential display operation.

The display circuit 912 has a processor 402 which receives image data 404 from an external source and converts the data to the proper form, which includes tailoring the image into three distinct images, one for red, one for green, and one for blue. The image data can be sent to memory 406 via a control circuit 916. The control circuit 916 takes the data from memory 406, where the image is saved in three distinct colors, and sends the data to the microdisplay 110 through the digital to analog converter 412. The image is written to the microdisplay 110 in a similar manner to embodiments discussed above. The control circuit 916, after the display has sufficient time to be written to and settles, flashes the specific backlight 266 such that the image on the display is projected to a printer paper 920, as seen in FIG. 47.

One distinction from previous embodiments discussed above, in that the image is projected to the photo sensitive paper 920, the frame rate does not need to be in excess of 60 frames per second or 180 subframes per second. The write and settle time can be in terms of tenth-of seconds and seconds with no noticeable delay to the user. In a preferred embodiment, the control circuit 916 has a control input from a film type detector 922 which is capable of reading the type of paper 920 installed in the digital printer 910. The control circuit 916 can adjust the flash and other adjustment dependent on the type of film.

Referring to FIG. 47, a sectional view of the digital printer 100 is shown. The digital printer has the microdisplay 110 which is spaced both from the backlight 266 and a printing plane 924. Interposed between the microdisplay and the backlight 266 is the diffuser 282 and a brightness enhancing film 280. Interposed between the display 110 and the paper plane 924 is a lens 926.

The microdisplay 110 is painted with the proper image and the backlight 266 is turned on for a sufficient time such that the light passes through the brightness enhancing film 280 and the diff-user 282 to pass through the clear portions of the microdisplay 110 and through the lens 926 to be received by the paper 920 located at the printing plane 924. After the first portion of the print is completed on the film, the backlight 266 is turned off and the control circuit 916 drives the microdisplay to a second image, that for one of the other colors. The backlight once again is turned on for a certain time such that the image is captured by the paper at the printing plane. The control circuit 916 then turns off the backlight and drives the microdisplay to the third and final image for the respective third color. Wherein, the backlight is once again placed on for a set period.

While the digital printer 910 is shown as a separate unit, it is recognized that the printer 910 can be incorporated in devices such as an instant digital camera. FIG. 48 illustrates circuitry 930 for an instant digital camera. The circuitry 930 is similar to the display control circuitry 840 described above with respect to FIG. 42. A separate microdisplay 110 and backlight 266 can be included or the microdisplay 110 and the backlight can be the same for viewing and image redirection, such as a mirror or prism, 932 directs the image.

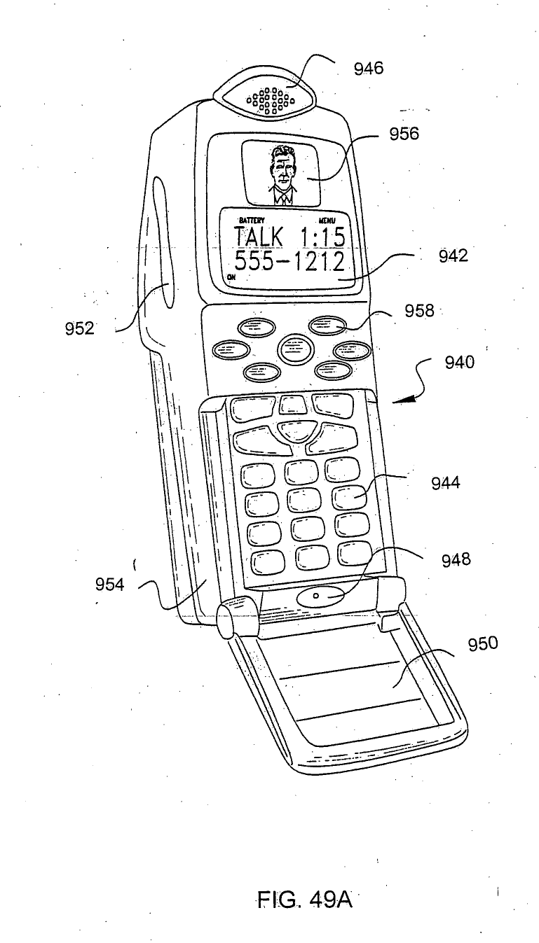

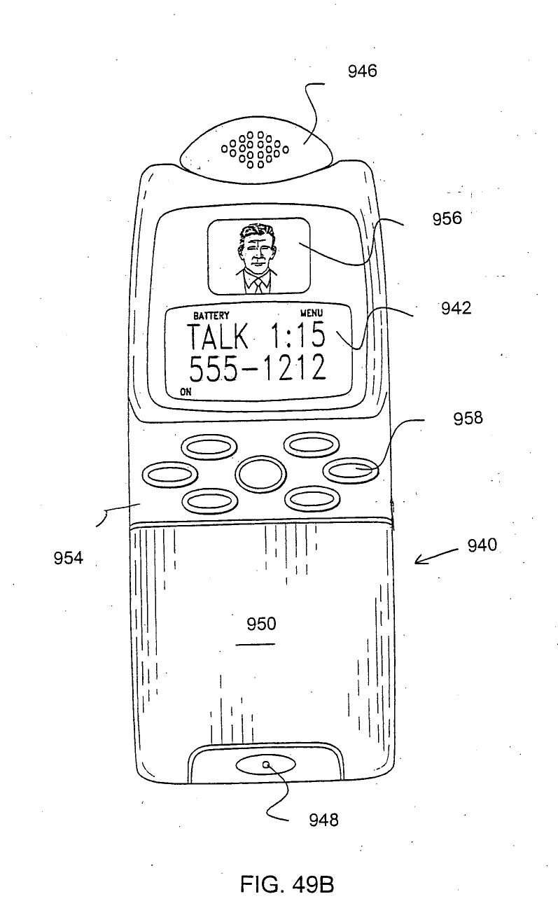

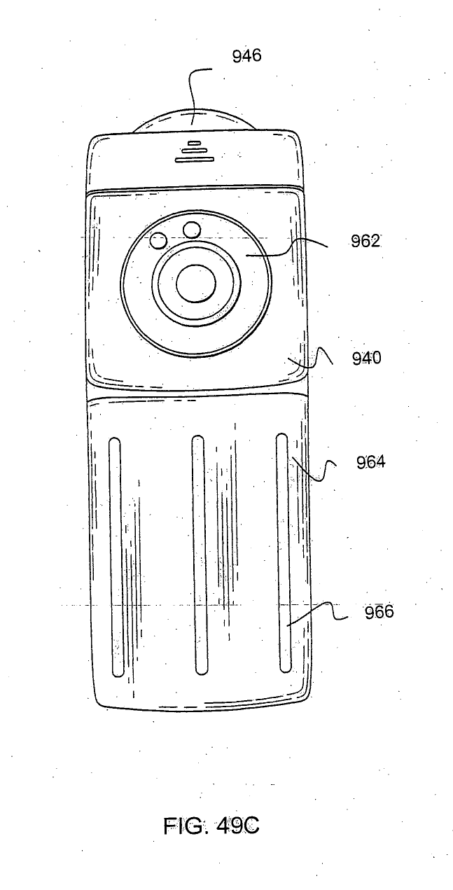

FIG. 49A is a prospective view of a cellular telephone 940 having an alphanumeric display 942, a keypad 944, a speaker 946, and a microphone 948. In addition, the cellular telephone 940 has a flip-lid 950 for covering the keypad 944 as found on a lot of conventional cellular telephones. In addition, the cellular telephone 940, in a preferred embodiment, has a scroll switch 952 which is shown on the left side of the housing 954 in FIG. 49A. The scroll switch 952 can be used to select information on the alphanumeric screen 942 or on a microdisplay 956 located above the alphanumeric screen 942 in a preferred embodiment. Information on the microdisplay 956 can likewise be accessed using an additional keypad 948 or the conventional keypad 944 dependent on the workings of the particular cellular telephone 940.

FIG. 49B shows the front of the cellular telephone 940 with the flip lid 950 covering the keypad. In a preferred embodiment with the flip cover 950 in the closed position, the user can hold the cellular telephone 940 away from the user's face so that they can view the microdisplay 956. The phone is placed in a half-duplex mode such that the speaker 946 and the microphone 948 are not on at the same time, therein preventing feedback. The user is able to hear the speaker 946 from the distance that they are located in this mode and converse with the party on the other end of the cellular telephone call. The scroll switch 952 as seen in FIG. 49A and/or the keypad 958 can be programmed to control and select images on either the alphanumeric display 942 or the microdisplay 956.

In an alternative embodiment, the earpiece 946 is detachable from the housing 954 of the cellular telephone 940 such that the user places the speaker 946 in or in proximity to the user's ear. The microphone 948 is capable of picking up conversation from the distance, approximately one foot, in that the cellular telephone 940 is spaced from the user.

FIG. 49C shows the back of the cellular telephone 940. The speaker housing 946 is seen in the rear view. The cellular telephone 940 has a camera 962. The electronic images taken by the camera 962 can be transmitted by the cellular telephone 940. The microdisplay 956 as seen in FIGS. 49A and 49B is used for the camera element 962. The image to be recorded is selected using keypad 958. In addition, the cellular telephone 940 has a battery pack 964. In the preferred embodiment the battery pack 964 has a series of ribs 966 for easy handling.

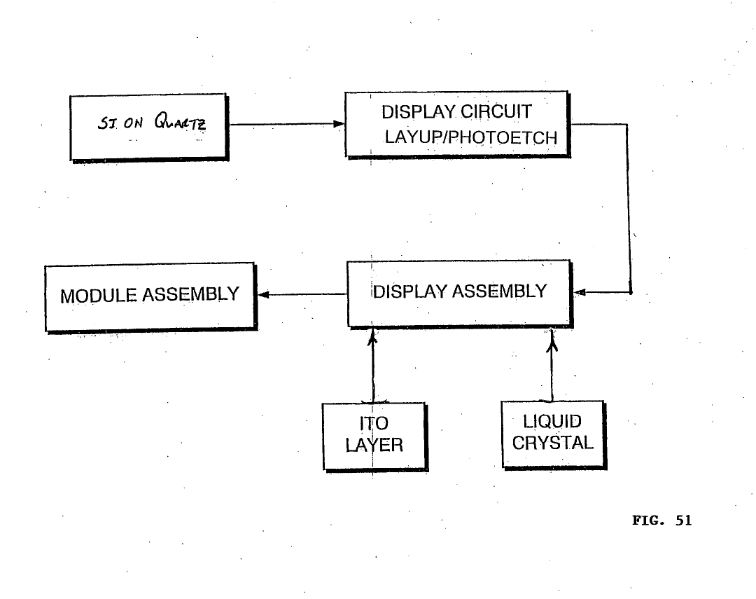

While the microdisplay 110 is described above being made on a SOI (silicon on Insulator) wafer, it is recognized that the microdisplay can be formed by other techniques such as silicon on quartz such as illustrated in FIG. 51.

The process of forming a microdisplay using silicon on quartz is similar to that described above with respect to SOI wafers and FIGS. 4-8. The benefits of silicon on quartz for displays over SOI are a simpler process overall. The benefits of SOI for displays over silicon on quartz are easier and lower cost integrated circuit processing.

It is recognized that instead of a transmissive microdisplay 110 as described above, a microdisplay can be reflective. In a reflective display, the light is flashed into the display and reflects back.

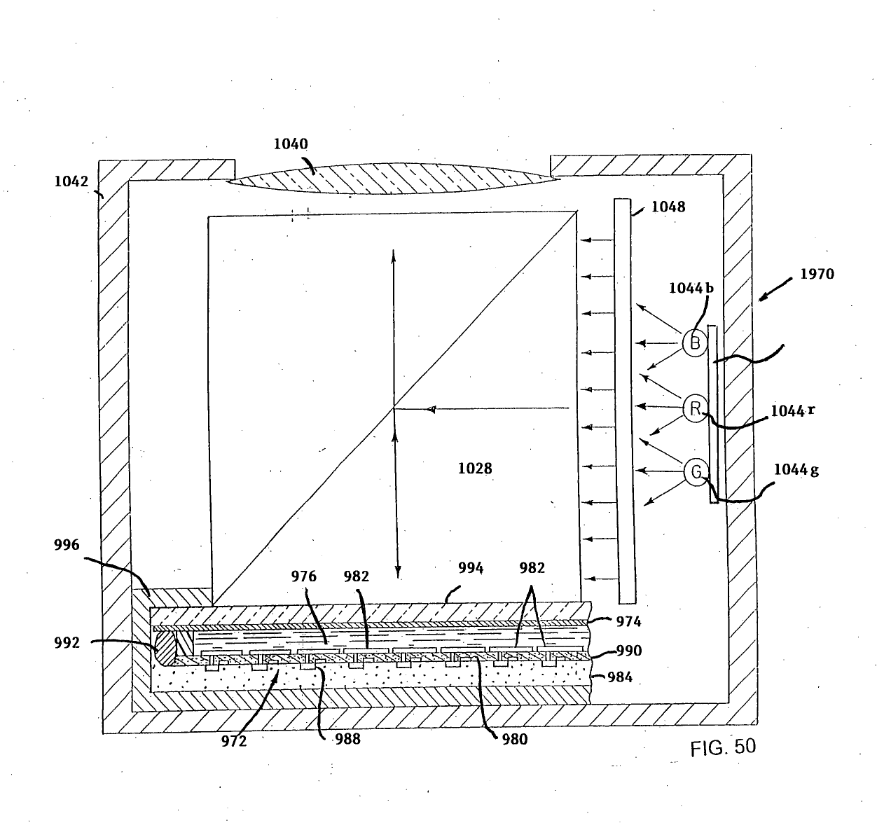

A preferred embodiment for a reflective microdisplay 968 is illustrated in FIG. 50. A display 970 has the microdisplay 968 with an active matrix portion 972. The active matrix portion 972 has a pixel 978 spaced from a counterelectrode 974 by an interposed liquid crystal material 976 Each pixel 978 has a transistor 980 and a pixel electrode 982. The pixel electrodes 982 overlie the transistor (TFT) 980 which is located in an epoxy layer 984 The pixel electrode protects or shields the TFT 980 from light. The pixel electrodes 982 are spaced from the channel lines 988 by a layer of oxide 990. The counterelectrode 974 is connected to the rest of the circuit by solder bumps 992 The active matrix 972 has a layer of glass 994 above the counterelectrode 974 The microdisplay 968 is carried within a case 996.

The display 970 has a polarizing prism 1028 located between the active matrix 972 of the microdisplay 970 and a lens 1040 for viewing the microdisplay 970 The lens 1040, the prism 1028 and the microdisplay 970 are carried in a display housing 1042. The display housing 1042 also has a plurality of light emitting diodes (LEDs) 1044. The LEDs 1044 in red 1044r, blue 1044b and green 1044g are mounted to a circuit board 1046 which is connected to a timing circuit. A polarizer 1048 is interposed between the LEDs 1044 and the prism 1028. The light from the LEDs 1044 is directed by the prism 1028 towards the liquid crystal 976 of the active matrix 972. The light is reflected back by the pixel electrodes 982 passes through the prism 1028. Light which has passed through liquid crystal 926 which was activated by a pixel electrode 982 has a partial or full polarization change; light existing the display 970 with a different polarization is transmitted through the prism 1028 towards the lens 1040. Unaltered light is reflected away from lens 1040 by prism 1028. As in the transmissive displays, the LEDs are flashed sequentially.

While this invention has been particularly shown and described with references to preferred embodiments thereof, it will be understood by those skilled in the art that various changes in form and details may be made therein without departing from the spirit and scope of the invention as defined by the appended claims.

What is claimed is:

1. A microdisplay system comprising:
an active matrix liquid crystal display including an array of pixel electrodes;
a display circuit having a pair of memory elements and at least one controller that controls writing and reading from the memory elements such that a first memory element is being written while the data from a second memory element is sent to the display;
a light source that illuminates the array of pixel electrodes; and
a lens that magnifies an image formed on the active matrix liquid crystal display.

2. The microdisplay system of claim 1, further comprising a multeplixer for directing the signal and output process for inverting selected video signals.

3. The microdisplay system of claim 1, further comprising at least one scaling circuit for interpolating image data from a certain number of pixel data to a preferred number of pixel data for the display.

4. The microdisplay system of claim 3, wherein the scaling is of horizontal lines of video data.

5. The microdisplay system of claim 3, wherein the scaling if of vertical columns of video data and further comprising a buffer for storing data.

6. The microdisplay system of claim 3, further comprising a gamma correction circuit for converting an input signal to an output signal which results in proper intensity on the display.

7. The microdisplay system of claim 6, wherein the gamma correction circuit has

8. The microdisplay system of claim 6, wherein the gamma correction circuit has a look up table for converting an input signal to an output signal which results in proper intensity on the display

9. The microdisplay system of claim 8, further comprising circuitry for setting voltage of the pixel electrodes to the voltage of the counterelectrode to initialize the display at each subframe and a circuit for switching the voltage of the counterelectrode.

10. The microdisplay system of claim 8, further comprising reordering the values of the data for increase efficient use of memory.

11. The microdisplay system of claim 1, further comprising circuitry for setting voltage of the pixel electrodes to the voltage of the counterelectrode to initialize the display at each subframe.

12. The microdisplay system of claim 11, further comprising a circuit for switching the voltage of the counterelectrode.

13. The microdisplay system of claim 12, further comprising a gamma correction circuit having a look up table for converting an input signal to an output signal which results in proper intensity on the display.

14. The microdisplay system of claim 13, further comprising reordering the values of the data for increase efficient use of memory.

15. The microdisplay system of claim 1, further comprising at least one scaling circuit for interpolating image data from a certain number of pixel data to a preferred number of pixel data for the display.

16. The microdisplay system of claim 11, further comprising a digital table for converting an input video signal to a corrected output value to achieve proper twist of the liquid crystal to have proper intensity.

17. The microdisplay system of claim 11, further comprising a pair of switching circuits for pseudo-random one of a plurality of signals through one of a plurality of amplifiers and to the display to balance the relative strength of the plurality of signals.

18. A microdisplay system comprising:
an active matrix liquid crystal display including an array of pixel electrodes and having an active area of less than 200 mm²;
a display circuit having a pair of memory elements and at least one controller that controls writing and reading from the memory elements such that a first memory element is being written while the data from a second memory element is sent to the display;
a light source that illuminates the array of pixel electrodes; and
a lens that magnifies an image formed on the active matrix liquid crystal display.

19. The microdisplay system of claim 18, further comprising a multeplixer for directing the signal and output process for inverting selected video signals.

20. The microdisplay system of claim 18, further comprising at least one scaling circuit for interpolating image data from a certain number of pixel data to a preferred number of pixel data for the display.
